(19) United States
(12) Patent Application Publication
(10) Pub. No.: US 2024/0392044 A1
(43) Pub. Date: Nov. 28, 2024

(54) OLEFIN POLYMERIZATION CATALYST SYSTEM AND POLYMERIZATION PROCESS

(71) Applicant: NOVA CHEMICALS (INTERNATIONAL) S.A., Fribourg (CH)

(72) Inventors: Darryl MORRISON, Calgary (CA); Frederick CHIU, Calgary (CA); James GOETTEL, Calgary (CA); Xiaoliang GAO, Calgary (CA); Janelle SMILEY, Calgary (CA)

(73) Assignee: NOVA CHEMICALS (INTERNATIONAL) S.A., Fribourg (CH)

(21) Appl. No.: 18/690,315

(22) PCT Filed: Sep. 16, 2022
(86) PCT No.: PCT/IB2022/058783

§ 371 Date: Mar. 8, 2024

Related U.S. Application Data
(60) Provisional application No. 63/246,249, filed on Sep. 20, 2021.
(60) Provisional application No. 63/246,490, filed on Sep. 21, 2021.

(51) Int. Cl. C08F 4/6592; C08F 2/00; C08F 2/06; C08F 2/44; C08F 4/659; C08F 210/16

(52) U.S. Cl. CPC C08F 4/6592; C08F 2/001; C08F 2/06; C08F 2/44; C08F 4/65908; C08F 4/65912; C08F 210/16; C08F 2410/07

(57) ABSTRACT

An olefin polymerization process is carried out in the presence of a catalyst system comprising a pre-polymerization catalyst, a boron-based catalyst activator, an alkylaluminoxane co-catalyst, and a hindered phenol compound. The pre-polymerization catalyst is a titanium complex and has an indenoindolyl ligand bridged to a phenoxy ligand via a silyl group. The catalyst system is effective at polymerizing ethylene with alpha-olefins in a solution phase polymerization process at high temperatures and produces ethylene copolymers with high molecular weight and high degrees of alpha-olefin incorporation.

### TECHNICAL FIELD

An olefin polymerization catalyst system polymerizes ethylene with an alpha-olefin to produce ethylene copolymers having high molecular weight and high degrees of short chain branching.

### BACKGROUND ART

A wide variety of single site catalysts have been developed to carry out the polymerization of olefins. For example, metallocene polymerization catalysts which are supported by indenoindolyl ligands are known. Polymerization catalysts having a cyclopentadienyl type ligand, including indenoindolyl ligands, bonded to a phenoxy type ligand, which are so called “half sandwich” complexes, are also known.

There is a continuing desire to enhance the performance of single site catalysts for use in high temperature olefin polymerization processes, such as solution phase olefin polymerization.

### SUMMARY OF INVENTION

We now report an olefin polymerization catalyst system which combines ligand derivatization with a specific activation strategy to improve catalyst activity for the polymerization of ethylene, optionally with alpha-olefins, at high temperatures in the solution phase.

An embodiment is an olefin polymerization catalyst system comprising:
i) a pre-polymerization catalyst having structure I or II:

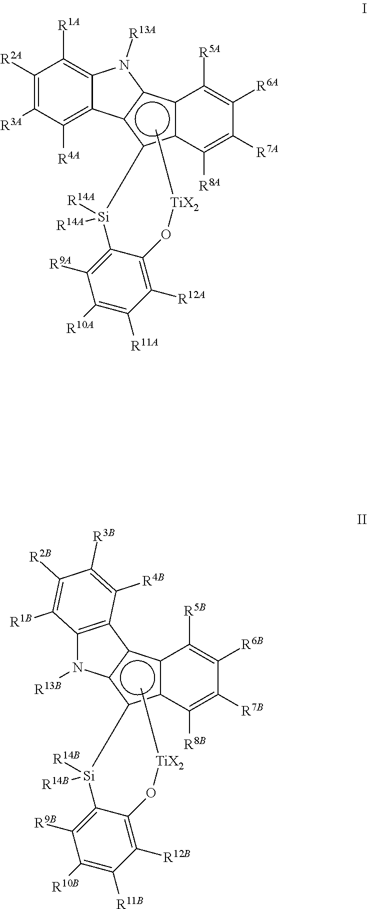

wherein
R^{1A}, R^{2A}, R^{3A}, R^{4A}, R^{5A}, R^{6A}, R^{7A}, R^{8A}, R^{9A}, R^{10A}, R^{11A}, and R^{12A} are each independently a hydrocarbyl group, a heteroatom containing hydrocarbyl group, a halogen, or hydrogen; and adjacent groups within the group consisting of R^{1A}, R^{2A}, R^{3A} and R^{4A}, or the group consisting of R^{5A}, R^{6A}, R^{7A}, and R^{8A}, or the group consisting of R^{9A}, R^{10A}, R^{11A}, and R^{12A}, may optionally form a cyclic hydrocarbyl group or cyclic heteroatom containing hydrocarbyl group;
R^{1B}, R^{2B}, R^{3B}, R^{4B}, R^{5B}, R^{6B}, R^{7B}, R^{8B}, R^{9B}, R^{10B}, R^{11B}, and R^{12B} are each independently a hydrocarbyl group, a heteroatom containing hydrocarbyl group, a halogen, or hydrogen; and adjacent groups within the group consisting of R^{1B}, R^{2B}, R^{3B}, and R^{4B}, or the group consisting of R^{5B}, R^{6B}, R^{7B}, and R^{8B}, or the group consisting of R^{9B}, R^{10B}, R^{11B}, and R^{12B}, may optionally form a cyclic hydrocarbyl group or cyclic heteroatom containing hydrocarbyl group;
R^{13A} is a hydrocarbyl group, or a heteroatom containing hydrocarbyl group;
R^{13B} is a hydrocarbyl group, or a heteroatom containing hydrocarbyl group; each R^{14A} is independently a hydrocarbyl group, a heteroatom containing hydrocarbyl group, or hydrogen; and two R^{14A} groups may optionally be bonded to form a ring;
each R^{14B} is independently a hydrocarbyl group, a heteroatom containing hydrocarbyl group, or hydrogen; and two R^{14B} groups may optionally be bonded to form a ring; and
each X is an activatable ligand;
ii) a boron-based catalyst activator
iii) an alkylaluminoxane co-catalyst; and
iv) a hindered phenol compound.

An embodiment is a polymerization process comprising polymerizing ethylene optionally with one or more than one C₃-C₁₂ alpha-olefin in the presence of a polymerization catalyst system comprising:
i) a pre-polymerization catalyst having structure I or II:

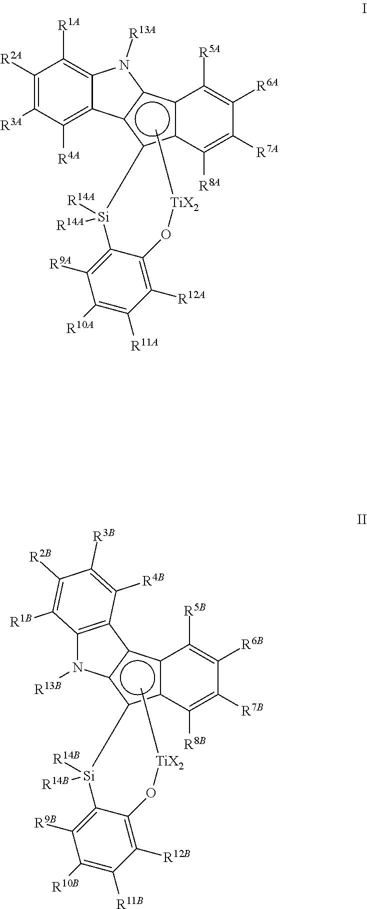

wherein
R^{1A}, R^{2A}, R^{3A}, R^{4A}, R^{5A}, R^{6A}, R^{7A}, R^{8A}, R^{9A}, R^{10A}, R^{11A}, and R^{12A} are each independently a hydrocarbyl group, a heteroatom containing hydrocarbyl group, a halogen, or hydrogen; and adjacent groups within the group consisting of R^{1A}, R^{2A}, R^{3A}, and R^{4A}, or the group consisting of R^{5A}, R^{6A}, R^{7A}, and R^{8A}, or the group consisting of R^{9A}, R^{10A}, R^{11A}, and R^{12A}, may optionally form a cyclic hydrocarbyl group or cyclic heteroatom containing hydrocarbyl group;
R^{1B}, R^{2B}, R^{3B}, R^{4B}, R^{5B}, R^{6B}, R^{7B}, R^{8B}, R^{9B}, R^{10B}, R^{11B}, and R^{12B} are each independently a hydrocarbyl group, a heteroatom containing hydrocarbyl group, a halogen, or hydrogen; and adjacent groups within the group consisting of R^{1B}, R^{2B}, R^{3B} and R^{4B}, or the group consisting of R^{5B}, R^{6B}, R^{7B}, and R^{8B}, or the group consisting of R^{9B}, R^{10B}, R^{11B}, and R^{12B}, may optionally form a cyclic hydrocarbyl group or cyclic heteroatom containing hydrocarbyl group;
R^{13A} is a hydrocarbyl group, or a heteroatom containing hydrocarbyl group;
R^{13B} is a hydrocarbyl group, or a heteroatom containing hydrocarbyl group;
each R^{14A} is independently a hydrocarbyl group, a heteroatom containing hydrocarbyl group, or hydrogen; and two R^{14A} groups may optionally be bonded to form a ring;
each R^{14B} is independently a hydrocarbyl group, a heteroatom containing hydrocarbyl group, or hydrogen; and two R^{14B} groups may optionally be bonded to form a ring; and
each X is an activatable ligand;
ii) a boron-based catalyst activator
iii) an alkylaluminoxane co-catalyst; and
iv) a hindered phenol compound.

In an embodiment a polymerization process comprises polymerizing ethylene with an alpha-olefin selected from the group consisting of 1-butene, 1-hexene, 1-octene and mixtures thereof.

In an embodiment a polymerization process comprises polymerizing ethylene with 1-octene.

In an embodiment a polymerization process is a solution phase polymerization process carried out in a solvent.

In an embodiment a polymerization process is a continuous solution phase polymerization process carried out in a solvent.

In an embodiment a continuous solution phase polymerization process is carried out in at least one continuously stirred tank reactor.

In an embodiment a continuous solution phase polymerization process is carried out at a temperature of at least 160° C.

In an embodiment R^{1A}, R^{2A}, R^{4A}, R^{5A}, R^{6A}, R^{7A}, R^{8A}, R^{9A}, R^{11A}, R^{1B}, R^{2B}, R^{4B}, R^{5B}, R^{6B}, R^{7B}, R^{8B}, R^{9B}, and R^{11B} are hydrogen.

In an embodiment R^{3A} and R^{3B} are hydrocarbyl groups.

In an embodiment R^{3A} and R^{3B} are alkyl groups.

In an embodiment R^{10A} and R^{10B} are hydrocarbyl groups.

In an embodiment R^{10A} and R^{10B} are alkyl groups.

In an embodiment R^{10A} and R^{10B} are heteroatom containing hydrocarbyl groups.

In an embodiment R^{10A} and R^{10B} are alkoxy groups.

In an embodiment R^{12A} and R^{12B} are hydrocarbyl groups.

In an embodiment R^{12A} and R^{12B} are alkyl groups.

In an embodiment R^{13A} and R^{13B} are hydrocarbyl groups.

In an embodiment R^{13A} and R^{13B} are alkyl groups.

In an embodiment R^{13A} and R^{13B} are arylalkyl groups.

In an embodiment each R^{14A} and each R^{14B} is a hydrocarbyl group.

In an embodiment each R^{14A} and each R^{14B} is an alkyl group.

In an embodiment each R^{14A} and each R^{14B} is an aryl group.

In an embodiment each X is methyl or chloride.

In an embodiment the boron-based catalyst activator is selected from the group consisting of N,N-dimethylaniliniumtetrakispentafluorophenyl borate (“[Me₂NHPh][B(C₆F₅)₄]”), and triphenylmethylium tetrakispentafluorophenyl borate (“[Ph₃C][B(C₆F₅)₄]”).

In an embodiment the boron-based catalyst activator is triphenylmethylium tetrakispentafluorophenyl borate (“[Ph₃C][B(C₆F₅)₄]”).

In an embodiment the hindered phenol compound is 2,6-di-tertiarybutyl-4-ethylphenol.

An embodiment is a process to make an organometallic complex having the formula VI:

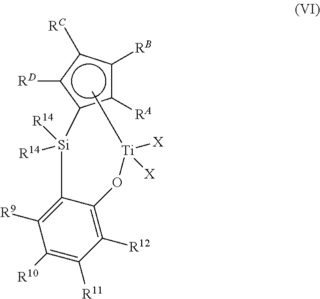

wherein the process comprises carrying out the following reactions sequentially in a single reaction vessel:
(i) combining a cyclopentadienyl-containing compound having the formula V:

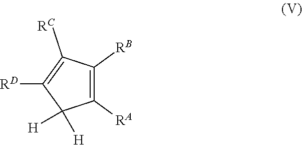

or double bond isomers of the cyclopentadienyl-containing compound having the formula V; with a base, followed by addition of a compound represented by formula VII:

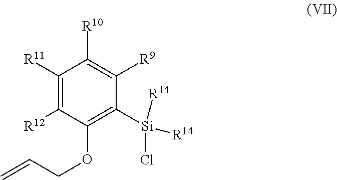

(ii) addition of at least two molar equivalents of an alkyllithium reagent, (R^{E})Li, optionally in the presence of an excess of a trialkylamine compound, (R^{F})₃N;
(iii) addition of a group IV transition metal compound having the formula TiCl₂ (X^{€})₂(D)ₙ;
(iv) optionally adding a silane compound having the formula ClₓSi(R^{€})₄₋ₓ wherein each R^{€} group is independently a C₁₋₂₀ alkyl group;
(v) optionally adding an alkylating agent having the formula (R^{G})M, (R^{G})(R^{H})Mg, or (R^{G})₂Zn;
(vi) optionally switching the reaction solvent between any of the previous steps;
wherein R^{A}, R^{B}, R^{C}, and R^{D} are each independently a hydrocarbyl group, a heteroatom containing hydrocarbyl group, a halogen, or hydrogen; and adjacent groups within the group consisting of R^{A}, R^{B}, R^{C}, and R^{D} may optionally form a cyclic hydrocarbyl group or a cyclic heteroatom containing hydrocarbyl group;
wherein R⁹, R¹⁰, R¹¹, and R¹² are each independently a hydrocarbyl group, a heteroatom containing hydrocarbyl group, a halogen, or hydrogen; and adjacent groups within the group consisting of R⁹, R¹⁰, R¹¹, and R¹² may optionally form a cyclic hydrocarbyl group or a cyclic heteroatom containing hydrocarbyl group;
wherein each R¹⁴ is independently a hydrocarbyl group, a heteroatom containing hydrocarbyl group, or hydrogen; and two R¹⁴ groups may optionally be bonded to form a ring;
each X is an activatable ligand;
X^{€} is a halide, a C₁₋₂₀ alkoxy group, or an amido group having the formula —NR′₂, wherein the R′ groups are independently a C₁₋₃₀ alkyl group or a C₆₋₁₀ aryl group;
R^{E} is a C₁₋₂₀ hydrocarbyl group;
R^{F} is a C₁₋₁₀ alkyl group;
R^{G} is a C₁₋₂₀ hydrocarbyl group;
R^{H} is a C₁₋₂₀ hydrocarbyl group, a halide, or C₁₋₂₀ alkoxy group;
M is Li, Na, or K;
D is an electron donor compound; and
n=1 or 2.

### BRIEF DESCRIPTION OF THE FIGURES

FIG. 1 shows the Oak Ridge Thermal Ellipsoid Plot (ORTEP) of an organometallic complex, Inventive Example 28, of the present disclosure. The ORTEP is a representation of the molecular structure of an organometallic complex of the present disclosure as determined by x-ray diffraction.

### DESCRIPTION OF EMBODIMENTS

As used herein, the term “monomer” refers to a small molecule that may chemically react and become chemically bonded with itself or other monomers to form a polymer.

As used herein, the term “α-olefin” or “alpha-olefin” is used to describe a monomer having a linear hydrocarbon chain containing from 3 to 20 carbon atoms having a double bond at one end of the chain; an equivalent term is “linear α-olefin”. As used herein, the term “polyethylene” or “ethylene polymer”, refers to macromolecules produced from ethylene monomers and optionally one or more additional monomers; regardless of the specific catalyst or specific process used to make the ethylene polymer. In the polyethylene art, the one or more additional monomers are called “comonomer(s)” and often include α-olefins. The term “homopolymer” refers to a polymer that contains only one type of monomer. An “ethylene homopolymer” is made using only ethylene as a polymerizable monomer. The term “copolymer” refers to a polymer that contains two or more types of monomer. An “ethylene copolymer” is made using ethylene and one or more other types of polymerizable monomer. Common polyethylenes include high density polyethylene (HDPE), medium density polyethylene (MDPE), linear low density polyethylene (LLDPE), very low density polyethylene (VLDPE), ultralow density polyethylene (ULDPE), plastomer and elastomers. The term polyethylene also includes polyethylene terpolymers which may include two or more comonomers in addition to ethylene. The term polyethylene also includes combinations of, or blends of, the polyethylenes described above.

As used herein, the terms “hydrocarbyl”, “hydrocarbyl radical” or “hydrocarbyl group” refers to linear or branched, aliphatic, olefinic, acetylenic and aryl (aromatic) radicals comprising hydrogen and carbon that are deficient by one hydrogen. The term “cyclic hydrocarbyl group” connotes hydrocarbyl groups that comprise cyclic moieties and which may have one or more than one cyclic aromatic ring, and/or one or more than one non-aromatic ring. The term “acyclic hydrocarbyl group” connotes hydrocarbyl groups that do not have cyclic moieties such as aromatic or non-aromatic ring structures present within them.

As used herein, the phrase “heteroatom” includes any atom other than carbon and hydrogen that can be bound to carbon. The term “heteroatom containing” or “heteroatom containing hydrocarbyl group” means that one or more than one non carbon atom(s) may be present in the hydrocarbyl groups. Some non-limiting examples of non-carbon atoms that may be present is a heteroatom containing hydrocarbyl group are N, O, S, P and Si as well as halides such as for example Br and metals such as Sn. Some non-limiting examples of heteroatom containing hydrocarbyl groups include for example aryloxy groups, alkoxy groups, alkylaryloxy groups, and arylalkoxy groups. Further non-limiting examples of heteroatom containing hydrocarbyl groups generally include for example imines, amine moieties, oxide moieties, phosphine moieties, ethers, ketones, heterocyclics, oxazolines, thioethers, and the like.

In an embodiment of the disclosure, a heteroatom containing hydrocarbyl group is a hydrocarbyl group containing from 1 to 3 atoms selected from the group consisting of boron, aluminum, silicon, germanium, nitrogen, phosphorous, oxygen and sulfur.

The terms “cyclic heteroatom containing hydrocarbyl” or “heterocyclic” refer to ring systems having a carbon backbone that further comprises at least one heteroatom selected from the group consisting of for example boron, aluminum, silicon, germanium, nitrogen, phosphorous, oxygen and sulfur.

In an embodiment of the disclosure, a cyclic heteroatom containing hydrocarbyl group is a cyclic hydrocarbyl group containing from 1 to 3 atoms selected from the group consisting of boron, aluminum, silicon, germanium, nitrogen, phosphorous, oxygen and sulfur.

As used herein, an “alkyl radical” or “alkyl group” includes linear, branched and cyclic paraffin radicals that are deficient by one hydrogen radical; non-limiting examples include methyl (—CH₃) and ethyl (—CH₂CH₃) radicals. The term “alkenyl radical” or “alkenyl group” refers to linear, branched and cyclic hydrocarbons containing at least one carbon-carbon double bond that is deficient by one hydrogen radical. The term “alkynyl radical” or “alkynyl group” refers to linear, branched and cyclic hydrocarbons containing at least one carbon-carbon triple bond that is deficient by one hydrogen radical.

As used herein, the term “aryl radical” or “aryl group” includes phenyl, naphthyl, pyridyl and other radicals whose molecules have an aromatic ring structure; non-limiting examples include naphthalene, phenanthrene and anthracene. An “alkylaryl” group is an alkyl group having an aryl group pendant there from; non-limiting examples include benzyl, phenethyl and tolylmethyl. An “arylalkyl” is an aryl group having one or more alkyl groups pendant there from; non-limiting examples include tolyl, xylyl, mesityl and cumyl.

An “alkoxy group” is an oxy group having an alkyl group pendant there from; and includes for example a methoxy group, an ethoxy group, an iso-propoxy group, and the like. An “alkylaryloxy group” is an oxy group having an alkylaryl group pendent there from (for clarity, the alkyl moiety is bonded to the oxy moiety and the aryl group is bonded to the alkyl moiety).

An “aryloxy” group is an oxy group having an aryl group pendant there from; and includes for example a phenoxy group and the like. An “arylalkyloxy group” is an oxy group having an arylalkyl group pendent there from (for clarity, the aryl moiety is bonded to the oxy moiety and the alkyl group is bonded to the aryl moiety).

In the present disclosure, a hydrocarbyl group or a heteroatom containing hydrocarbyl group may be further specifically defined as being unsubstituted or substituted. As used herein the term “unsubstituted” means that hydrogen radicals are bounded to the molecular group that is referred to by the term unsubstituted. The term “substituted” means that the group referred to by this term possesses one or more moieties that have replaced one or more hydrogen radicals in any position within the group; non-limiting examples of moieties include halogen radicals (F, Cl, Br), an alkyl group, an alkylaryl group, an arylalkyl group, an alkoxy group, an aryl group, an aryloxy group, an amido group, a silyl group or a germanyl group, hydroxyl groups, carbonyl groups, carboxyl groups, amine groups, phosphine groups, phenyl groups, naphthyl groups, C₁ to C₁₀ alkyl groups, C₂ to C₁₀ alkenyl groups, and combinations thereof.

In embodiments of the disclosure, any hydrocarbyl group and/or any heteroatom containing hydrocarbyl group may be unsubstituted or substituted.

The polymerization catalyst or complex described herein, requires activation by one or more co-catalytic or catalyst activator species in order to provide polymer from olefins. Hence, an un-activated polymerization catalyst or complex may be described as a “pre-polymerization catalyst”.

In embodiments, the pre-polymerization catalysts described and used in the present disclosure have improved activity when combined with a boron-based catalyst activator, an alkylaluminoxane co-catalyst and a hindered phenol compound.

Accordingly, an embodiment of the disclosure is an olefin polymerization catalyst system comprising: i) a pre-polymerization catalyst; ii) a boron-based catalyst activator; iii) an alkyaluminoxane co-catalyst; and iv) a hindered phenol compound.

Another embodiment of the disclosure is a polymerization process comprising polymerizing ethylene optionally with one or more than one C₃-C₁₂ alpha-olefin in the presence of an olefin polymerization catalyst system comprising: i) a pre-polymerization catalyst; ii) a boron-based catalyst activator; iii) an alkyaluminoxane co-catalyst; and iv) a hindered phenol compound.

### The Pre-Polymerization Catalyst

Although the pre-polymerization catalysts employed in the present disclosure may generally be considered a so called “single site catalyst”, the term “single site catalyst” is used herein to distinguish the polymerization catalysts from polymerization catalysts which are considered traditional multisite polymerization catalysts such as Ziegler-Natta catalysts or chromium based catalysts. Persons skilled in the art will understand, for example, that metallocene catalysts, constrained geometry catalysts, and phosphinimine catalysts, are all generally considered “single site catalysts”, but that each of these “single site catalysts”, may also, under certain conditions exhibit what may be considered multisite catalyst behavior. Such is also the case with the pre-polymerization catalysts employed in the present disclosure, and so the term “single site catalyst” is not meant to preclude a pre-polymerization catalyst which may also demonstrate aspects of multi-site behavior.

In an embodiment of the present disclosure, a pre-polymerization catalyst has the structure I or II:

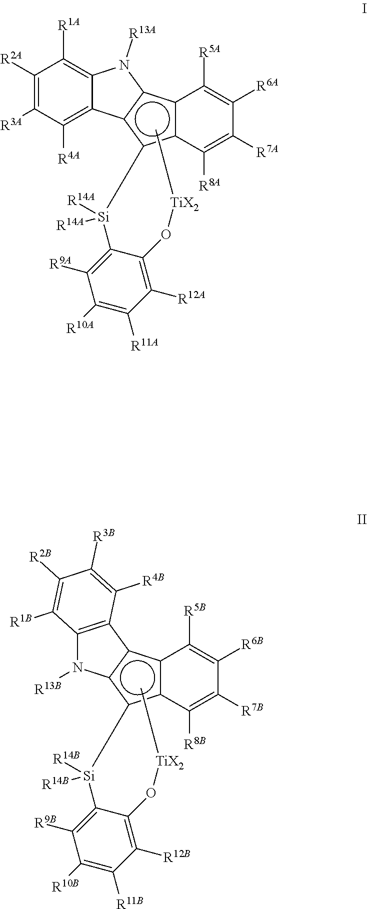

wherein
R^{1A}, R^{2A}, R^{3A}, R^{4A}, R^{5A}, R^{9A}, R^{1A}, R^{8A}, R^{9A}, R^{10A}, R^{11A}, and R^{12A} are each independently a hydrocarbyl group, a heteroatom containing hydrocarbyl group, a halogen, or hydrogen; and adjacent groups within the group consisting of R^{1A}, R^{2A}, R^{3A}, and R^{4A}, or the group consisting of R^{5A}, R^{6A}, R^{7A}, and R^{8A}, or the group consisting of R^{9A}, R^{10A}, R^{11A}, and R^{12A}, may optionally form a cyclic hydrocarbyl group or cyclic heteroatom containing hydrocarbyl group;
R^{1B}, R^{2B}, R^{3B}, R^{4B}, R^{5B}, R^{6B}, R^{7B}, R^{8B}, R^{9B}, R^{10B}, R^{11B}, and R^{12B} are each independently a hydrocarbyl group, a heteroatom containing hydrocarbyl group, a halogen, or hydrogen; and adjacent groups within the group consisting of R^{1B}, R^{2B}, R^{3B}, and R^{4B}, or the group consisting of R^{5B}, R^{6B}, R^{7B}, and R^{8B}, or the group consisting of R^{9B}, R^{10B}, R^{11B}, and R^{12B}, may optionally form a cyclic hydrocarbyl group or cyclic heteroatom containing hydrocarbyl group;
R^{13A} is a hydrocarbyl group, or a heteroatom containing hydrocarbyl group;
R^{13B} is a hydrocarbyl group, or a heteroatom containing hydrocarbyl group;
each R^{14A} is independently a hydrocarbyl group, a heteroatom containing hydrocarbyl group, or hydrogen; and two R^{14A} groups may optionally be bonded to form a ring (i.e., two R^{14A} groups may optionally form a cyclic hydrocarbyl group or cyclic heteroatom containing hydrocarbyl group);
each R^{14B} is independently a hydrocarbyl group, a heteroatom containing hydrocarbyl group, or hydrogen; and two R^{14B} groups may optionally be bonded to form a ring (i.e., two R^{14B} groups may optionally form a cyclic hydrocarbyl group or cyclic heteroatom containing hydrocarbyl group); and
each X is an activatable ligand.

In an embodiment, R^{1A} and R^{1B} are hydrogen.

In an embodiment, R^{2A} and R^{2B} are hydrogen.

In an embodiment, R^{3A} and R^{3B} are hydrogen.

In an embodiment, R^{4A} and R^{4B} are hydrogen.

In an embodiment, R^{5A} and R^{5B} are hydrogen.

In an embodiment, R^{6A} and R^{6B} are hydrogen.

In an embodiment, R^{7A} and R^{7B} are hydrogen.

In an embodiment, R^{8A} and R^{8B} are hydrogen.

In an embodiment, R^{9A} and R^{9B} are hydrogen.

In an embodiment, R^{10A} and R^{10B} are hydrogen.

In an embodiment, R^{11A} and R^{11B} are hydrogen.

In an embodiment, R^{12A} and R^{12B} are hydrogen.

In an embodiment, R^{1A}, R^{2A}, R^{3A}, R^{4A}, R^{5A}, R^{6A}, R^{7A}, R^{8A}, R^{9A}, R^{10A}, R^{11A}, R^{1B}, R^{2B}, R^{3B}, R^{4B}, R^{5B}, R^{6B}, R^{7B}, R^{8B}, R^{9B}, R^{10B}, and R^{11B} are hydrogen.

In an embodiment, R^{1A}, R^{2A}, R^{3A}, R^{4A}, R^{5A}, R^{6A}, R^{7A}, R^{8A}, R^{9A}, R^{11A}, R^{1B}, R^{2B}, R^{3B}, R^{4B}, R^{5B}, R^{6B}, R^{7B}, R^{8B}, R^{9B}, and R^{11B} are hydrogen.

In an embodiment, R^{1A}, R^{2A}, R^{4A}, R^{5A}, R^{6A}, R^{7A}, RBA, R^{9A}, R^{10A}, R^{11A}, R^{1B}, R^{2B}, R^{4B}, R^{5B}, R^{6B}, R^{7B}, R^{8B}, R^{9B}, R^{10B}, and R^{11B} are hydrogen.

In an embodiment, R^{1A}, R^{2A}, R^{4A}, R^{5A}, R^{6A}, R^{7A}, RBA, R^{9A}, R^{11A}, R^{1B}, R^{2B}, R^{4B}, R^{5B}, R^{6B}, R^{7B}, R^{8B}, R^{9B}, and R^{11B} are hydrogen.

In an embodiment of the present disclosure, a pre-polymerization catalyst has the structure III or IV:

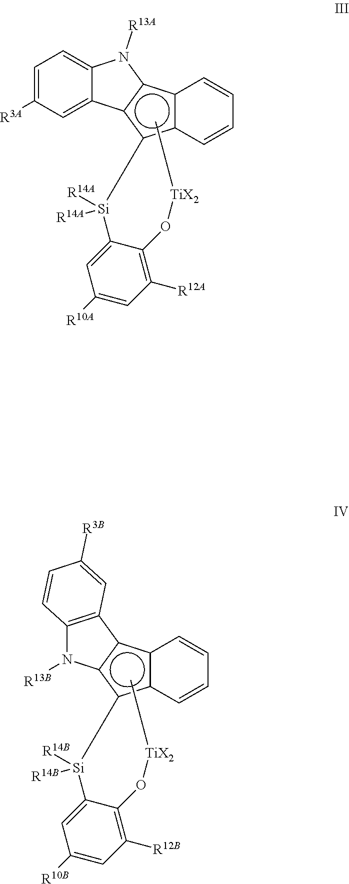

wherein
R^{3A}, R^{10A}, and R^{12A} are each independently a hydrocarbyl group, or a heteroatom containing hydrocarbyl group;
R^{3B}, R^{10B}, and R^{12B} are each independently a hydrocarbyl group, or a heteroatom containing hydrocarbyl group;
R^{13A} is a hydrocarbyl group, or a heteroatom containing hydrocarbyl group;
R^{13B} is a hydrocarbyl group, or a heteroatom containing hydrocarbyl group;
each R^{14A} is independently a hydrocarbyl group, a heteroatom containing hydrocarbyl group, or hydrogen; and two R^{14A} groups may optionally be bonded to form a ring (i.e., two R^{14A} groups may optionally form a cyclic hydrocarbyl group or cyclic heteroatom containing hydrocarbyl group);
each R^{14B} is independently a hydrocarbyl group, a heteroatom containing hydrocarbyl group, or hydrogen; and two R^{14B} groups may optionally be bonded to form a ring (i.e., two R^{14B} groups may optionally form a cyclic hydrocarbyl group or cyclic heteroatom containing hydrocarbyl group); and
each X is an activatable ligand.

In an embodiment, R^{3A} and R^{3B} are hydrocarbyl groups.

In an embodiment, R^{3A} and R^{3B} are alkyl groups.

In an embodiment, R^{3A} and R^{3B} are aryl groups.

In an embodiment, R^{3A} and R^{3B} are straight chain alkyl group having from 2 to 12 carbon atoms.

In an embodiment, R^{3A} and R^{3B} are a branched alkyl group having from 3 to 20 carbon atoms.

In an embodiment, R^{3A} and R^{3B} are selected from the group consisting of methyl, ethyl, n-propyl, isopropyl, n-butyl, sec-butyl, isobutyl, tert-butyl, n-pentyl, isopentyl, neopentyl, n-hexyl, and n-octyl.

In an embodiment, R^{3A} and R^{3B} are methyl groups.

In an embodiment, R^{3A} and R^{3B} are alkylaryl groups.

In an embodiment, R^{3A} and R^{3B} are arylalkyl groups.

In an embodiment, R^{3A} and R^{3B} are heteroatom containing hydrocarbyl groups.

In an embodiment, R^{3A} and R^{3B} are alkoxy groups.

In an embodiment, R^{3A} and R^{3B} are aryloxy groups.

In an embodiment, R^{3A} and R^{3B} are methoxy groups.

In an embodiment, R^{10A} and R^{10B} are hydrocarbyl groups.

In an embodiment, R^{10A} and R^{10B} are alkyl groups.

In an embodiment, R^{10A} and R^{10B} are aryl groups.

In an embodiment, R^{10A} and R^{10B} are a straight chain alkyl group having from 2 to 12 carbon atoms.

In an embodiment, R^{10A} and R^{10B} are a branched alkyl group having from 3 to 20 carbon atoms.

In an embodiment, R^{10A} and R^{10B} are selected from the group consisting of methyl, ethyl, n-propyl, isopropyl, n-butyl, sec-butyl, isobutyl, tert-butyl, n-pentyl, isopentyl, neopentyl, n-hexyl, and n-octyl.

In an embodiment, R^{10A} and R^{10B} are methyl groups.

In an embodiment, R^{10A} and R^{10B} are alkylaryl groups.

In an embodiment, R^{10A} and R^{10B} are arylalkyl groups.

In an embodiment, R^{10A} and R^{10B} are heteroatom containing hydrocarbyl groups.

In an embodiment, R^{10A} and R^{10B} are alkoxy groups.

In an embodiment, R^{10A} and R^{10B} are aryloxy groups.

In an embodiment, R^{10A} and R^{10B} are methoxy groups.

In an embodiment, R^{12A} and R^{12B} are hydrocarbyl groups.

In an embodiment, R^{12A} and R^{12B} are alkyl groups.

In an embodiment, R^{12A} and R^{12B} are aryl groups.

In an embodiment, R^{12A} and R^{12B} are a straight chain alkyl group having from 2 to 12 carbon atoms.

In an embodiment, R^{12A} and R^{12B} are a branched alkyl group having from 3 to 20 carbon atoms.

In an embodiment, R^{12A} and R^{12B} are a selected from the group consisting of methyl, ethyl, n-propyl, isopropyl, n-butyl, sec-butyl, isobutyl, tert-butyl, n-pentyl, isopentyl, neopentyl, n-hexyl, and n-octyl.

In an embodiment, R^{12A} and R^{12B} are methyl groups.

In an embodiment, R^{12A} and R^{12B} are tert-butyl groups.

In an embodiment, R^{12A} and R^{12B} are 1-adamantyl groups.

In an embodiment, R^{12A} and R^{12B} are alkylaryl groups.

In an embodiment, R^{12A} and R^{12B} are arylalkyl groups.

In an embodiment, R^{12A} and R^{12B} are heteroatom containing hydrocarbyl groups.

In an embodiment, R^{12A} and R^{12B} are alkoxy groups.

In an embodiment, R^{12A} and R^{12B} are aryloxy groups.

In an embodiment, R^{13A} and R^{13B} are hydrocarbyl groups.

In an embodiment, R^{13A} and R^{13B} are alkyl groups.

In an embodiment, R^{13A} and R^{13B} are aryl groups.

In an embodiment, R^{13A} and R^{13B} are a straight chain alkyl group having from 2 to 12 carbon atoms.

In an embodiment, R^{13A} and R^{13B} are a branched alkyl group having from 3 to 20 carbon atoms.

In an embodiment, R^{13A} and R^{13B} are a selected from the group consisting of methyl, ethyl, n-propyl, isopropyl, n-butyl, sec-butyl, isobutyl, tert-butyl, n-pentyl, isopentyl, neopentyl, n-hexyl, and n-octyl.

In an embodiment, R^{13A} and R^{13B} are methyl groups.

In an embodiment, R^{13A} and R^{13B} are alkenyl groups.

In an embodiment, R^{13A} and R^{13B} are alkylaryl groups.

In an embodiment, R^{13A} and R^{13B} are arylalkyl groups.

In an embodiment, R^{13A} and R^{13B} are 3,5-di-tert-butyl-phenyl groups.

In an embodiment, R^{13A} and R^{13B} are n-pentyl groups.

In an embodiment, R^{13A} and R^{13B} are n-pentenyl groups (—CH₂CH₂CH₂CH═CH₂).

In an embodiment, R^{13A} and R^{13B} are heteroatom containing hydrocarbyl groups.

In an embodiment, each R^{14A} and each R^{14B} is a hydrocarbyl group.

In an embodiment, each R^{14A} and each R^{14B} is an alkyl group.

In an embodiment, each R^{14A} and each R^{14B} is a straight chain alkyl group having from 2 to 12 carbon atoms.

In an embodiment, R^{14A} and R^{14B} are a branched alkyl group having from 3 to 20 carbon atoms.

In an embodiment, each R^{14A} and each R^{14B} is a selected from the group consisting of methyl, ethyl, n-propyl, isopropyl, n-butyl, sec-butyl, isobutyl, tert-butyl, n-pentyl, isopentyl, neopentyl, n-hexyl, and n-octyl.

In an embodiment, each R^{14A} and each R^{14B} is ethyl.

In an embodiment, each R^{14A} and each R^{14B} is an alkylaryl group.

In an embodiment, each R^{14A} and each R^{14B} is a substituted or unsubstituted benzyl group.

In an embodiment, each R^{14A} and each R^{14B} is an arylalkyl group.

In an embodiment, each R^{14A} and each R^{14B} is an aryl group.

In an embodiment, each R^{14A} and each R^{14B} is a substituted or unsubstituted phenyl group.

In an embodiment, one R^{14A} and one R^{14B} is hydrogen, and the other R^{14A} and the other R^{14B} is a hydrocarbyl group. In an embodiment, one R^{14A} and one R^{14B} is hydrogen, and the other R^{14A} and the other R^{14B} is an alkyl group. In an embodiment, one R^{14A} and one R^{14B} is hydrogen, and the other R^{14A} and the other R^{14B} is an aryl group. In an embodiment, one R^{14A} and one R^{14B} is hydrogen, and the other R^{14A} and the other R^{14B} is an alkylaryl group. In an embodiment, one R^{14A} and one R^{14B} is hydrogen, and the other R^{14A} and the other R^{14B} is an arylalkyl group.

In an embodiment, each R^{14A} and each R^{14B} are heteroatom containing hydrocarbyl groups.

In an embodiment, two R^{14A} groups and are bonded to each other to form a ring and two R^{14B} groups are bonded to each other to form a ring (i.e., two R^{14A} groups form a cyclic hydrocarbyl group or cyclic heteroatom containing hydrocarbyl group and two R^{14B} groups form a cyclic hydrocarbyl group or cyclic heteroatom containing hydrocarbyl group).

A person skilled in the art will know, that where there is no plane of symmetry which includes the metal center, there may be two enantiomeric forms (enantiomeric isomers), or two diastereomeric forms (diastereomeric isomers) available, depending on which face of the cyclopentadienyl moiety is coordinated to the metal center. Where the two isomeric forms are non-superimposable mirror images of each other, they are enantiomers of one another. When the two isomeric forms are non-superimposable and not mirror images of each other, they are diastereomers of one another.

In the present disclosure, because the cyclopentadienyl moiety is not mirror plane symmetric with respect to the metal center, a person skilled in the art will recognize that depending on the nature of the R^{1A}, R^{2A}, R^{3A}, R^{4A}, R^{5A}, R^{9A}, R^{7A}, R^{8A}, R^{9A}, R^{10A}, R^{11A}, R^{12A}, R^{13A}, R^{14A}, R^{1B}, R^{2B}, R^{3B}, R^{4B}, R^{5B}, R^{6B}, R^{7B}, R^{8B}, R^{9B}, R^{10B}, R^{11B}, R^{12B}, R^{13B}, R^{14B} groups, the catalyst shown in Structure I or Structure II may exist in two enantiomer forms, or two diastereomeric forms.

For example, where dissimilar substituents are present on the silyl bridging moiety, or where there is one or more than one chiral group located somewhere on the ligand frame (e.g. at one or more of the R^{1A}, R^{2A}, R^{3A}, R^{4A}, R^{5A}, R^{6A}, R^{7A}, R^{8A}, R^{9A}, R^{10A}, R^{11A}, R^{12A}, R^{13A}, R^{14A}, R^{1B}, R^{2B}, R^{3B}, R^{4B}, R^{5B}, R^{6B}, R^{7B}, R^{8B}, R^{9B}, R^{10B}, R^{11B}, R^{12B}, R^{13B}, R^{14B} group locations), two diastereomeric forms (two diastereomeric isomers) of the catalyst will be available depending on which face of the cyclopentadienyl moiety is coordinated to the metal center.

In the present disclosure, although only one enantiomeric form, or only one diastereomeric form may be represented by the structure I or II (or by the structure III or IV) as illustrated, the present disclosure is nevertheless meant to be inclusive of either of the two possible enantiomeric or diastereomeric forms. For example, if the R^{14A} groups are dissimilar in structure I, or if the R^{14B} groups are dissimilar in structure II, or if taken together two R^{14A} groups form a ring without mirror symmetry including the metal center, or if taken together two R^{14B} groups form a ring without mirror symmetry including the metal center, or if a chiral group is located somewhere on the ligand frame (e.g. at one or more of the R^{1A}, R^{2A}, R^{3A}, R^{4A}, R^{5A}, R^{6A}, R^{7A}, R^{8A}, R^{9A}, R^{10A}, R^{11A}, R^{12A}, R^{13A}, R^{14A}, R^{1B}, R^{2B}, R^{3B}, R^{4B}, R^{5B}, R^{6B}, R^{7B}, R^{8B}, R^{9B}, R^{10B}, R^{11B}, R^{12B}, R^{13B}, R^{14B} group locations) disturbs a mirror symmetry including the metal center, then two diastereomeric forms (two diastereomeric isomers) will be available. For the sake of clarity, the two possible enantiomeric forms (enantiomeric isomers) or diastereomeric forms (diastereomeric isomers) of structure I, may be represented by structures IA, and IB, where different faces of the cyclopentadienyl moiety are coordinated to the metal center:

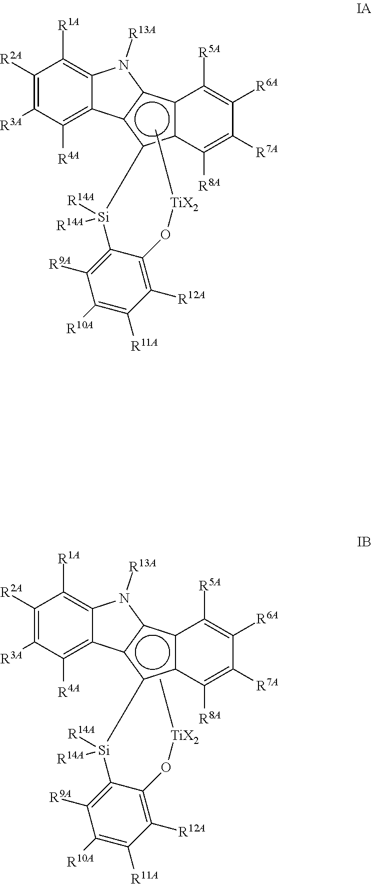

Similarly, the two possible enantiomeric forms (enantiomeric isomers) or diastereomeric forms (diastereomeric isomers) of structure II, may be represented by structures IIA, and IIB, where different faces of the cyclopentadienyl moiety are coordinated to the metal center:

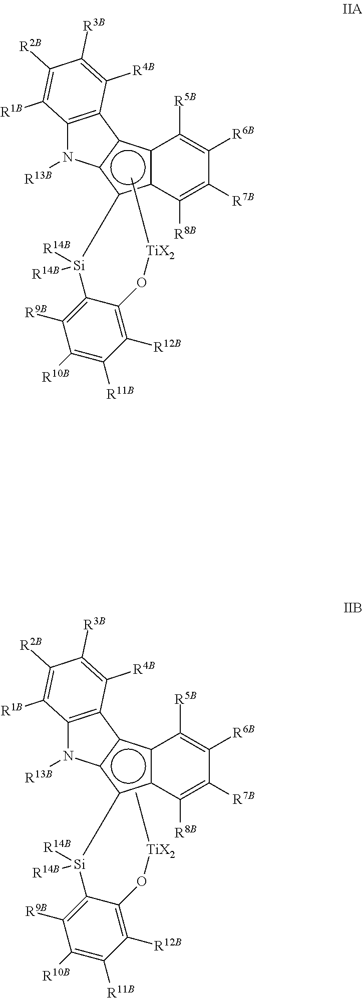

In the current disclosure, the term “activatable ligand”, means that the ligand, X may be cleaved from the metal center (titanium, Ti) via a protonolysis reaction or abstracted from the metal center by suitable acidic or electrophilic catalyst activator compounds (also known as “co-catalyst” compounds) respectively, examples of which are described below. The activatable ligand X may also be transformed into another ligand which is cleaved or abstracted from the metal center (e.g., a halide may be converted to an alkyl group). Without wishing to be bound by any single theory, protonolysis or abstraction reactions generate an active “cationic” metal center which can polymerize olefins.

In embodiments of the present disclosure, the activatable ligand, X is independently selected from the group consisting of a hydrogen atom, a halogen atom, a C₁₋₂₀ hydrocarbyl group, a C₁₋₂₀ alkoxy group, and a C₆₋₂₀ aryl or aryloxy group; where each of the hydrocarbyl, alkoxy, aryl, or aryl oxide groups may be un-substituted or further substituted. Two X ligands may also be joined to one another and form for example, a substituted or unsubstituted diene ligand (i.e., 1,3-butadiene), or a delocalized heteroatom containing group such as an acetate group.

In an embodiment of the disclosure, each X is independently selected from the group consisting of a halide atom, a C₁₋₄ alkyl radical and a benzyl radical.

In an embodiment, each X is a halogen atom (e.g., chloride) or a hydrocarbyl group (e.g., methyl group, benzyl group).

In an embodiment, each X is chloride or methide.

In an embodiment, each X is chloride.

In an embodiment, each X is a benzyl group.

In an embodiment, each X is methide.

### Process to Make an Organometallic Complex (a Pre-Polymerization Catalyst)

An embodiment of the disclosure is a process to make an organometallic complex (a pre-polymerization catalyst), using a single reaction vessel.

An embodiment of the disclosure is a process to make an organometallic complex (a pre-polymerization catalyst), having the formula VI:

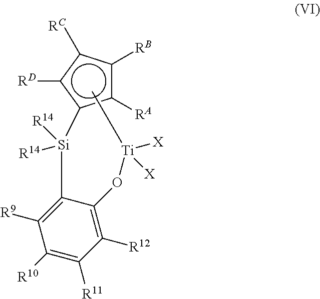

wherein the process comprises carrying out the following reactions sequentially in a single reaction vessel:
(i) combining a cyclopentadienyl-containing compound having the formula V:

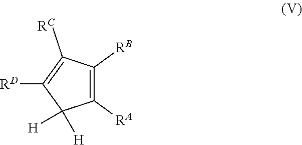

or double bond isomers of the cyclopentadienyl-containing compound having the formula V; with a base, followed by addition of a compound represented by formula VII:

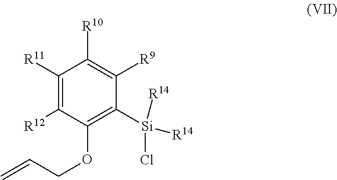

(ii) addition of at least two molar equivalents of an alkyllithium reagent, (R^{E})Li, optionally in the presence of an excess of a trialkylamine compound, (R^{F})₃N;
(iii) addition of a group IV transition metal compound having the formula TiCl₂ (X^{€})₂(D)ₙ;
(iv) optionally adding a silane compound having the formula ClₓSi(R^{€})₄₋ₓ wherein each R^{€} group is independently a C₁₋₂₀ alkyl group;
(v) optionally adding an alkylating agent having the formula (R^{G})M, (R^{G})(R^{H})Mg, or (R^{G})₂Zn;
(vi) optionally switching the reaction solvent between any of the previous steps;
wherein R^{A}, R^{B}, R^{C}, and R^{D} are each independently a hydrocarbyl group, a heteroatom containing hydrocarbyl group, a halogen, or hydrogen; and adjacent groups within the group consisting of R^{A}, R^{B}, R^{C}, and R^{D} may optionally form a cyclic hydrocarbyl group or a cyclic heteroatom containing hydrocarbyl group;
wherein R⁹, R¹⁰, R¹¹, and R¹² are each independently a hydrocarbyl group, a heteroatom containing hydrocarbyl group, a halogen, or hydrogen; and adjacent groups within the group consisting of R⁹, R¹⁰, R¹¹, and R¹² may optionally form a cyclic hydrocarbyl group or a cyclic heteroatom containing hydrocarbyl group;
where each R¹⁴ is independently a hydrocarbyl group, a heteroatom containing hydrocarbyl group, or hydrogen; and two R¹⁴ groups may optionally be bonded to form a ring (i.e., two R^{14A} groups may optionally form a cyclic hydrocarbyl group or a cyclic heteroatom containing hydrocarbyl group);
each X is an activatable ligand;
X^{€} is a halide, a C₁₋₂₀ alkoxy group, or an amido group having the formula —NR′₂, wherein the R groups are independently a C₁₋₃₀ alkyl group or a C₆₋₁₀ aryl group;
R^{E} is a C₁₋₂₀ hydrocarbyl group;
R^{F} is a C₁₋₁₀ alkyl group;
R^{G} is a C₁₋₂₀ hydrocarbyl group;
R^{H} is a C₁₋₂₀ hydrocarbyl group that is the same or different to R^{G}, a halide, or C₁₋₂₀ alkoxy group;
M is Li, Na, or K;
D is an electron donor compound; and
n=1 or 2.

Electron donor compounds are well known to persons skilled in the art and in an embodiment of the disclosure, D may be an ether compound, such as for example tetrahydrofuran, or diethyl ether.

In embodiments, the base that may be used for production of the organometallic complex include organic alkali metal compounds, such as for example, organolithium compounds such as methyl lithium, ethyl lithium, n-butyl lithium, sec-butyl lithium, tert-butyl lithium, lithium trimethylsilylacetylide, lithium acetylide, trimethylsilylmethyl lithium, vinyl lithium, phenyl lithium and allyl lithium.

In embodiments, the amount of the base used can be a range of 0.5 to 5 moles of base per 1 mole of the cyclopentadienyl-containing compound having formula V or its double bond isomers. In further embodiments, the amount of the base used can be a range of 1.0 to 3.0 moles of base per 1 mole of the cyclopentadienyl-containing compound having formula V or its double bond isomers; or can be a range of 1.5 to 2.5 moles of base per 1 mole of the cyclopentadienyl-containing compound having formula V or its double bond isomers; or can be a range of 1.8 to 2.3 moles of base per 1 mole of the cyclopentadienyl-containing compound having formula V or its double bond isomers; or about 2 moles of base per 1 mole of the cyclopentadienyl-containing compound having formula V or its double bond isomers.

In some embodiments, the base may be used in combination with an amine compound. Such an amine compound includes primary amine compounds such as methylamine, ethylamine, n-propylamine, isopropylamine, n-butylamine, tert-butylamine, n-octylamine, n-decylamine, aniline and ethylenediamine, secondary amine compounds such as dimethylamine, diethylamine, di-n-propylamine, di-n-butylamine, di-tert-butylamine, di-n-octylamine, di-n-decylamine, pyrrolidine, hexamethyldisilazane and diphenylamine, and tertiary amine compounds such as trimethylamine, triethylamine, tri-n-propylamine, tri-n-butylamine, diisopropylethylamine, tri-n-octylamine, tri-n-decylamine, triphenylamine, N,N-dimethylaniline, N,N,N′,N′-tetramethylethylenediamine, N-methylpyrrolidine and 4-dimethylaminopyridine.

The used amount of such an amine compound is in embodiments of the disclosure in a range of 10 moles or fewer, from 0.5 to 10 moles, or from 1 to 3 moles of amine compound per 1 mole of the base.

The metalation reaction, step (iii) is generally carried out in an inert solvent. In embodiments, such a solvent includes aprotic solvents, for example, aromatic hydrocarbon solvents such as benzene or toluene, aliphatic hydrocarbon solvents such as hexane or heptane, ether solvents such as diethyl ether, tetrahydrofuran or 1,4-dioxane, amide solvents such as hexamethylphosphoric amide or dimethylformamide, polar solvents such as acetonitrile, propionitrile, acetone, diethyl ketone, methyl isobutyl ketone and cyclohexanone, and halogenated solvents such as chlorobenzene or dichlorobenzene. In embodiments, these solvents may be used alone or as a mixture of two or more of them.

In embodiments, the organometallic complex may be obtained from the reaction mixture using conventional methods, such as, filtrating off a produced precipitate or removing solvents under vacuum to give the organometallic complex as a product, which can be optionally washed with solvent.

In embodiments, the activatable ligand, X is independently selected from the group consisting of a hydrogen atom, a halogen atom, a C₁₋₂₀ hydrocarbyl group, a C₁₋₂₀ alkoxy group, and a C₆₋₂₀ aryl or aryloxy group; where each of the hydrocarbyl, alkoxy, aryl, or aryl oxide groups may be un-substituted or further substituted. Two X ligands may also be joined to one another and form for example, a substituted or unsubstituted diene ligand (i.e., 1,3-butadiene), or a delocalized heteroatom containing group such as an acetate group.

In an embodiment, each X is independently selected from the group consisting of a halide atom, a C₁₋₄ alkyl radical and a benzyl radical.

In an embodiment, each X is a halogen atom (e.g., chloride) or a hydrocarbyl group (e.g., methyl group, benzyl group).

In an embodiment, each X is chloride or methide.

In an embodiment, each X is chloride.

In an embodiment, each X is a benzyl group.

In an embodiment, each X is methide.

### The Catalyst Activator and Co-Catalyst

In an embodiment of the present disclosure, the pre-polymerization catalyst is used in combination with a boron-based catalyst activator and an alkylaluminoxane co-catalyst in order to form an active polymerization catalyst system for olefin polymerization. Boron-based catalyst activators, also known as “ionic activators”, are well known to persons skilled in the art. Alkylaluminoxanes are likewise well known to persons skilled in the art.

In an embodiment of the disclosure, in addition to a pre-polymerization catalyst, a polymerization catalyst system comprises at least one boron-based catalyst activator and at least one alkylaluminoxane co-catalyst.

In an embodiment of the disclosure, in addition to a pre-polymerization catalyst, a polymerization catalyst system comprises a boron-based catalyst activator and an alkylaluminoxane co-catalyst.

In some embodiments of the disclosure, a polymerization catalyst system may additionally include organoaluminum compounds as co-catalysts.

Without wishing to be bound by theory, aluminum based co-catalyst species such as alkylaluminoxanes, and organoaluminum compounds may act as catalyst activators per se (and so may also be considered “catalyst activators”), and/or as alkylating agents and/or as scavenging compounds (e.g., they react with species which adversely affect the polymerization activity of the titanium based catalyst complex, and which may be present in a polymerization reactor).

### Alkylaluminoxanes

Without wishing to be bound by theory, the alkylaluminoxanes used in the present disclosure are complex aluminum compounds of the formula: R₂A1¹O(RA1¹O)ₘA1¹R², wherein each R is independently selected from the group consisting of C₁₋₂₀ hydrocarbyl radicals and m is from 3 to 50.

In an embodiment of the disclosure, R of the alkylaluminoxane, is a methyl radical and m is from 10 to 40.

The alkylaluminoxanes are typically used in substantial molar excess compared to the amount of group 4 transition metal in the single site catalyst (e.g., the pre-polymerization catalyst). In embodiments, the A1¹: group 4 transition metal molar ratios may be from about 5:1 to about 10,000:1, or from about 10:1 to about 1000:1, or from about 30:1 to about 500:1.

In an embodiment of the disclosure, the alkylaluminoxane co-catalyst is methylaluminoxane (MAO).

In an embodiment of the disclosure, the alkylaluminoxane co-catalyst is modified methylaluminoxane (MMAO).

It is well known in the art, that alkylaluminoxanes can serve multiple roles as a catalyst alkylator, a catalyst activator, and a scavenger. Hence, an alkylaluminoxane activator is often used in combination with activatable ligands such as halogens.

### Boron-Based Catalyst Activator

The boron-based catalyst activator (which in some embodiments is also known as an “ionic activator”) may be selected from the group consisting of: (i) compounds of the formula [R¹]⁺ [B(R²)₄]⁻ wherein B is a boron atom, R¹ is a cyclic C₅₋₇ aromatic cation or a triphenyl methyl cation and each R² is independently selected from the group consisting of phenyl radicals which are unsubstituted or substituted with from 3 to 5 substituents selected from the group consisting of a fluorine atom, a C₁₋₄ alkyl or alkoxy radical which is unsubstituted or substituted by a fluorine atom; and a silyl radical of the formula —Si—(R*)₃; wherein each R* is independently selected from the group consisting of a hydrogen atom and a C₁₋₄ alkyl radical; and (ii) compounds of the formula [(R³)ₜZH]⁺ [B(R²)₄]⁻ wherein B is a boron atom, H is a hydrogen atom, Z is a nitrogen atom or phosphorus atom, t is 2 or 3 and R³ is selected from the group consisting of C₁₋₃₀ alkyl radicals, a phenyl radical which is unsubstituted or substituted by up to three C₁₋₄ alkyl radicals, or one R³ taken together with a nitrogen atom may form an anilinium radical and R² is as defined above; and (iii) compounds of the formula B(R²)₃ wherein R² is as defined above.

In some embodiments, in the above compounds, preferably R² is a pentafluorophenyl radical, and R¹ is a triphenylmethyl cation, Z is a nitrogen atom and R³ is a C₁₋₄ alkyl radical or one R³ taken together with a nitrogen atom forms an anilinium radical (e.g., PhR³₂NH⁺, which is substituted by two R³ radicals such as for example two C₁₋₄ alkyl radicals).

Examples of boron-based catalyst activator compounds capable of ionizing a single site catalyst (e.g. the pre-polymerization catalyst) and which may be used in embodiments of the disclosure include the following: triethylammonium tetra(phenyl) boron, tripropylammonium tetra(phenyl) boron, tri (n-butyl) ammonium tetra(phenyl) boron, trimethylammonium tetra(p-tolyl) boron, trimethylammonium tetra(o-tolyl) boron, tributylammonium tetra(pentafluorophenyl) boron, tripropylammonium tetra (o,p-dimethylphenyl) boron, tributylammonium tetra(m,m-dimethylphenyl) boron, tributylammonium tetra(p-trifluoromethylphenyl) boron, tributylammonium tetra(pentafluorophenyl) boron, tri (n-butyl) ammonium tetra(o-tolyl) boron, N,N-dimethylanilinium tetra(phenyl) boron, N,N-diethylanilinium tetra(phenyl) boron. N,N-diethylanilinium tetra(phenyl) n-butylboron, N,N-2,4,6-pentamethylanilinium tetra(phenyl) boron, di-(isopropyl) ammonium tetra(pentafluorophenyl) boron, dicyclohexylammonium tetra(phenyl) boron, triphenylphosphonium tetra) phenyl) boron, tri(methylphenyl) phosphonium tetra(phenyl) boron, tri (dimethylphenyl) phosphonium tetra(phenyl) boron, tropylium tetrakispentafluorophenyl borate, triphenylmethylium tetrakispentafluorophenyl borate, benzene (diazonium) tetrakispentafluorophenyl borate, tropylium phenyltris-pentafluorophenyl borate, triphenylmethylium phenyl-trispentafluorophenyl borate, benzene (diazonium) phenyltrispentafluorophenyl borate, tropylium tetrakis (2,3,5,6-tetrafluorophenyl) borate, triphenylmethylium tetrakis (2,3,5,6-tetrafluorophenyl) borate, benzene (diazonium) tetrakis (3,4,5-trifluorophenyl) borate, tropylium tetrakis (3,4,5-trifluorophenyl) borate, benzene (diazonium) tetrakis (3,4,5-trifluorophenyl) borate, tropylium tetrakis (1,2,2-trifluoroethenyl) borate, trophenylmethylium tetrakis (1,2,2-trifluoroethenyl) borate, benzene (diazonium) tetrakis (1,2,2-trifluoroethenyl) borate, tropylium tetrakis (2,3,4,5-tetrafluorophenyl) borate, triphenylmethylium tetrakis (2,3,4,5-tetrafluorophenyl) borate, and benzene (diazonium) tetrakis (2,3,4,5-tetrafluorophenyl) borate.

Further specific examples of boron-based catalyst activator compounds capable of ionizing a single site catalyst (e.g. the pre-polymerization catalyst) and which may be used in embodiments of the present disclosure are disclosed in U.S. Pat. Nos. 5,919,983, 6,121,185, 10,730,964 and 11,041,031.

In an embodiment of the disclosure, the boron-based catalyst activator comprises N,N-dimethylaniliniumtetrakispentafluorophenyl borate (“[Me₂NHPh][B(C₆F₅)₄]”), or triphenylmethylium tetrakispentafluorophenyl borate (“[Ph₃C][B(C₆F₅)₄]”), and/or trispentafluorophenyl boron.

In an embodiment of the disclosure, the boron-based catalyst activator comprises N,N-dimethylaniliniumtetrakispentafluorophenyl borate (“[Me₂NHPh][B(C₆F₅)₄]”), or triphenylmethylium tetrakispentafluorophenyl borate (“[Ph₃C][B(C₆F₅)₄]”), or trispentafluorophenyl boron.

In an embodiment of the disclosure, the boron-based catalyst activator comprises an ionic activator selected from the group consisting of N,N-dimethylaniliniumtetrakispentafluorophenyl borate (“[Me₂NHPh][B(C₆F₅)₄]”), and triphenylmethylium tetrakispentafluorophenyl borate (“[Ph₃C][B(C₆F₅)₄]”).

In an embodiment of the disclosure, the boron-based catalyst activator is N,N-dimethylaniliniumtetrakispentafluorophenyl borate (“[Me₂NHPh][B(C₆F₅)₄]”).

In an embodiment of the disclosure, the boron-based catalyst activator is triphenylmethylium tetrakispentafluorophenyl borate (“[Ph₃C][B(C₆F₅)₄]”).

In embodiments, the boron-based catalyst activator may be used in amounts which provide a molar ratio of group 4 transition metal (i.e., titanium in the pre-polymerization catalyst) to boron that will be from about 1:0.5 to about 1:10, or from about 1:1 to about 1:6.

### Organoaluminum Compounds

Optionally, in embodiments of the disclosure, the polymerization catalyst system may further include an organoaluminum compound defined by the formula:

A1²(R⁴)ₘ(OR⁵)ₙ(X*)ₚ
wherein R⁴ and R⁵ are each independently C₁ to C₂₀ hydrocarbyl groups; X* is a halide; m+n+p=3; and m≥1.

In an embodiment of the disclosure, the organoaluminum compound used is defined by the formula:

A1³R⁶ₓ(OR⁷)_{y}
wherein x is from 1 to 3, x+y=3, R⁶ is a C₁ to C₁₀ hydrocarbyl group, and R⁷ is an alkyl or an aryl group.

In particular embodiments, organoaluminum compounds include triethylaluminum, triisobutyl aluminum, tri-n-octylaluminum and diethyl aluminum ethoxide.

### The Hindered Phenol Compound

In embodiments of the present disclosure, a hindered phenol compound is used in combination with a pre-polymerization catalyst, a boron-based catalyst activator and an alkylaluminoxane co-catalyst to provide an olefin polymerization catalyst system.

Generally, hindered phenol compounds (or “sterically hindered” phenol compounds) are phenols having one or more bulky substituent, such as a sterically bulky hydrocarbyl group, non-limited examples of which include a tert-butyl group and a 1-adamantyl group.

In embodiments of the disclosure, a hindered phenol compound, will have a sterically bulky hydrocarbyl group on at least one or both of the carbon atoms adjacent to the carbon atom bonded to a hydroxy group (e.g., a bulky hydrocarbyl group is located at one or both of the 2 and 6 locations of a hindered phenol moiety).

In embodiments of the disclosure, a hindered phenol compound, comprises a 2,6-dihydrocarbyl group substituted hindered phenol moiety.

In embodiments of the disclosure, a hindered phenol compound comprises a 2,6-dihydrocarbyl group substituted hindered phenol moiety, which moiety is further optionally substituted at one or more of the 3, 4 and 5 locations with a hydrocarbyl group or a heteroatom containing hydrocarbyl group.

Non-limiting examples of hindered phenol compounds which may be employed in embodiments of the present disclosure include butylated phenolic antioxidants, butylated hydroxytoluene; 2,6-di-tertiarybutyl-4-ethyl phenol; 4,4′-methylenebis (2,6-di-tertiary-butylphenol); 1,3,5-trimethyl-2,4,6-tris (3,5-di-tert-butyl-4-hydroxybenzyl) benzene and octadecyl-3-(3′,5′-di-tert-butyl-4′-hydroxyphenyl) propionate.

In embodiments, a hindered phenol compound is present in an amount which provides a molar ratio of aluminum from an alkylaluminoxane co-catalyst to the hindered phenol compound (i.e., the ratio of A1¹:hindered phenol compound) of from about 1:1 to about 10:1, or from about 2:1 to about 5:1.

Optionally, in embodiments, a hindered phenol compound is added to an alkylaluminoxane co-catalyst prior to contact of the alkylaluminoxane with one or more other components of the olefin polymerization catalyst system (e.g., the pre-polymerization catalyst).

### The Polymerization Process

The olefin polymerization catalyst system of the present disclosure may be used in any conventional olefin polymerization process, such as gas phase polymerization, slurry phase polymerization or solution phase polymerization. The use of a “heterogenized” catalyst system is preferred for use in gas phase and slurry phase polymerization while a homogeneous catalyst is preferred for use in a solution phase polymerization. A heterogenized catalyst system may be formed by supporting a pre-polymerization catalyst, optionally along with a boron-based catalyst activator, an alkyaluminoxane, and a hindered phenol compound on a support, such as for example, a silica support. Silica support materials as well as suitable alternative support materials are well known to persons skilled in the art.

In an embodiment of the disclosure, the polymerization process comprises polymerizing ethylene optionally with one or more than one C₃-C₁₂ alpha-olefin.

In an embodiment of the disclosure, the polymerization process comprises polymerizing ethylene with one or more of an alpha-olefin selected from the group consisting of 1-butene, 1-hexene, 1-octene and mixtures thereof.

In an embodiment of the disclosure, the polymerization process comprises polymerizing ethylene with 1-octene.

When gas phase polymerization is employed, in various embodiments, the pressures employed may be in the range of from 1 to 1000 psi, or from 50 to 400 psi, or from 100 to 300 psi; while in various embodiments, the temperatures employed may be in the range of from 30° C. to 130° C., or from 65° C. to 110° C. Stirred bed or fluidized bed gas phase reactor systems may be used in embodiments of the disclosure for a gas phase polymerization process. Such gas phase processes are widely described in the literature (see for example U.S. Pat. Nos. 4,543,399, 4,588,790, 5,028,670, 5,317,036, 5,352,749, 5,405,922, 5,436,304, 5,453,471, 5,462,999, 5,616,661 and 5,668,228). One or more reactors may be used and may be configured in series with one another.

In general, a fluidized bed gas phase polymerization reactor employs a “bed” of polymer and catalyst which is fluidized by a flow of monomer, comonomer and other optional components which are at least partially gaseous. Heat is generated by the enthalpy of polymerization of the monomer (and comonomers) flowing through the bed. Un-reacted monomer, comonomer and other optional gaseous components exit the fluidized bed and are contacted with a cooling system to remove this heat. The cooled gas stream, including monomer, comonomer and optional other components (such as condensable liquids), is then re-circulated through the polymerization zone, together with “make-up” monomer (and comonomer) to replace that which was polymerized on the previous pass. Simultaneously, polymer product is withdrawn from the reactor. As will be appreciated by those skilled in the art, the “fluidized” nature of the polymerization bed helps to evenly distribute/mix the heat of reaction and thereby minimize the formation of localized temperature gradients.

Polymerization is generally conducted substantially in the absence of catalyst poisons. Organometallic compounds such as organoaluminum compounds may be employed as scavenging agents for poisons to increase the catalyst activity. Some specific non-limiting examples of scavenging agents are metal alkyls, including aluminum alkyls, such as triisobutylaluminum. Conventional adjuvants may be included in the process, provided they do not interfere with the operation of the polymerization catalyst in forming the desired polyolefin. For example, hydrogen or a metal or non-metal hydride (e.g., a silyl hydride) may be used as a chain transfer agent in the process. Hydrogen may be used in amounts up to about 10 moles of hydrogen per mole of total monomer feed.

Detailed descriptions of slurry phase polymerization processes are widely reported in the patent literature. Also known as “particle form polymerization”, a slurry phase polymerization process where the temperature is kept below the temperature at which the polymer goes into solution is described in U.S. Pat. No. 3,248,179. Slurry processes include those employing a loop reactor and those utilizing a single stirred reactor or a plurality of stirred reactors in series, parallel, or combinations thereof. Non-limiting examples of slurry phase polymerization processes include continuous loop or stirred tank processes. Further examples of slurry phase polymerization processes are described in U.S. Pat. No. 4,613,484.

Slurry processes are conducted in the presence of a hydrocarbon diluent such as an alkane (including isoalkanes), an aromatic, or a cycloalkane. The diluent may also be the alpha olefin comonomer used in copolymerizations. Alkane diluents include propane, butanes, (i.e., normal butane and/or isobutane), pentanes, hexanes, heptanes, and octanes. The monomers may be soluble in (or miscible with) the diluent, but the polymer is not (under polymerization conditions). In an embodiment, the polymerization temperature may be from about 5° C. to about 200° C. In further embodiments, the polymerization temperature is less than about 120° C., or from 10° C. to about 100° C. The slurry phase polymerization reaction temperature is selected so that a polymer (e.g., an ethylene copolymer) is produced in the form of solid particles. The reaction pressure is influenced by the choice of diluent and reaction temperature. For example, in embodiments, the pressure may range from 15 to 45 atmospheres (about 220 to 660 psi or about 1500 to about 4600 kPa) when isobutane is used as diluent to approximately twice that, from 30 to 90 atmospheres (about 440 to 1300 psi or about 3000 to 9100 kPa) when propane is used (see, for example, U.S. Pat. No. 5,684,097). The pressure in a slurry phase polymerization process is generally kept high enough to keep at least part of the polymerizable monomer (e.g., ethylene) in the liquid phase.

In an embodiment, the slurry phase polymerization reaction takes place in a jacketed closed loop reactor having an internal stirrer (e.g., an impeller) and which further contains at least one settling leg. Polymerization catalyst components (suspended or not), monomers and diluents may be fed to the slurry phase polymerization reactor as liquids or suspensions. The slurry circulates through the loop reactor and the jacket is used to control the temperature of the reactor. Through a series of let-down valves the slurry enters a settling leg and then is let down in pressure to flash the diluent and unreacted monomers and to recover the product polymer generally in a cyclone. The diluent and unreacted monomers are recovered and recycled back to the reactor.

In an embodiment of the disclosure, the polymerization process is a solution phase polymerization process carried out in a solvent.

In an embodiment of the disclosure, the polymerization process is a continuous solution phase polymerization process carried out in a solvent.

Solution polymerization processes for the homopolymerization of ethylene or the copolymerization of ethylene with one or more than one alpha-olefin are well known in the art (see for example U.S. Pat. Nos. 6,372,864 and 6,777,509). These processes are conducted in the presence of an inert hydrocarbon solvent, typically, a C₅₋₁₂ hydrocarbon which may be unsubstituted or substituted by C₁₋₄ alkyl group such as pentane, methyl pentane, hexane, heptane, octane, cyclohexane, methylcyclohexane and hydrogenated naphtha. An example of a suitable solvent which is commercially available is “Isopar E” (C₈₋₁₂ aliphatic solvent, Exxon Chemical Co.).

The polymerization temperature in a conventional solution phase process may be from about 80° C. to about 300° C. In an embodiment of the disclosure the polymerization temperature in a solution phase polymerization process is from about 120° C. to about 250° C. In further embodiments, a solution phase polymerization process is carried out at a temperature of at least 140° C., or at least 160° C., or at least 170° C., or at least 180° C., or at least 190° C.

The polymerization pressure in a solution phase polymerization process may be a “medium pressure process”, meaning that the pressure in the reactor is less than about 6,000 psi (about 42,000 kiloPascals or kPa). In embodiments of the disclosure, the polymerization pressure in a solution phase polymerization process may be from about 10,000 to about 40,000 kPa, or from about 14,000 to about 22,000 kPa (i.e. from about 2,000 psi to about 3,000 psi).

Suitable monomers for copolymerization with ethylene include C₃-20 alpha-olefins (including mono- and di-olefins). Some non-limiting examples of comonomers which may be copolymerized with ethylene in embodiments of the disclosure include C₃₋₁₂ alpha-olefins which are unsubstituted or substituted by up to two C₁₋₆ alkyl radicals; C₈₋₁₂ vinyl aromatic monomers which are unsubstituted or substituted by up to two substituents selected from the group consisting of C₁₋₄ alkyl radicals; and C₄₋₁₂ straight chained or cyclic diolefins which are unsubstituted or substituted by a C₁₋₄ alkyl radical. Illustrative non-limiting examples of such alpha-olefins are one or more of propylene, 1-butene, 1-pentene, 1-hexene, 1-octene and 1-decene, styrene, alpha methyl styrene, and the constrained-ring cyclic olefins such as cyclobutene, cyclopentene, dicyclopentadiene norbornene, alkyl-substituted norbornenes, alkenyl-substituted norbornenes and the like (e.g., 5-methylene-2-norbornene, 5-ethylidene-2-norbornene, and bicyclo-(2,2,1)-hepta-2,5-diene).

In solution polymerization, the monomers are dissolved/dispersed in a solvent either prior to being fed to the reactor (or for gaseous monomers the monomer may be fed to a reactor so that it will dissolve in the polymerization reaction mixture). Prior to mixing, the solvent and monomers are generally purified to remove potential catalyst poisons such as water, oxygen or metal impurities. The feedstock purification may employ standard well known practices in the art, such as for example the use of molecular sieves, alumina beds and oxygen removal catalysts, all of which are known to be useful for the purification of polymerizable monomers. The solvent itself, as well, (e.g., methyl pentane, cyclohexane, hexane or toluene) may be treated in a similar manner to remove potential catalyst poisons.

The feedstock monomers or other solution process components (e.g., solvent) may be heated or cooled prior to feeding to a solution phase polymerization reactor.

In embodiments of the disclosure, the olefin polymerization catalyst system components (e.g., a pre-polymerization catalyst, boron-based catalyst activator, an alkylaluminoxane, and a hindered phenol compound) may be premixed in the solvent used for the polymerization reaction or they may be fed as separate streams to a polymerization reactor. In some embodiments, premixing may be desirable to provide a reaction time for the olefin polymerization catalyst system components prior to entering a polymerization reaction zone (e.g., a polymerization reactor). Examples, of such an “in line mixing” technique are described in a number of patents, such as U.S. Pat. No. 5,589,555.

In an embodiment of the disclosure, a solution phase polymerization process is a continuous process. By the term “continuous process” it is meant that the polymerization process flows (e.g., solvent, ethylene, optional alpha-olefin comonomer, olefin polymerization catalyst system components, etc.) are continuously fed to a polymerization zone (e.g., a polymerization reactor) where a polymer (e.g., ethylene homopolymer or ethylene copolymer) is formed and from which the polymer is continuously removed via a process flow effluent steam.

In an embodiment of the disclosure, a solution phase polymerization process is carried out in at least one continuously stirred tank reactor (a “CSTR”).

In an embodiment of the disclosure, a solution phase polymerization process is carried out in at least two sequentially arranged continuously stirred tank reactors (with the process flows being transferred from a first upstream CSTR reactor to a second downstream CSTR).

In some embodiments, a continuous solution phase polymerization process comprises a first stirred tank polymerization reactor having a mean reactor temperature of from about 100° C. to about 140° C., and a second stirred tank polymerization reactor having a mean temperature of at least about 20° C. greater than the mean reactor temperature of the first reactor.

In an embodiment of the disclosure, a solution phase polymerization process is carried out in at least one tubular reactor.

In an embodiment of the disclosure, a solution phase polymerization process is carried out in two sequentially arranged continuously stirred tank reactors and a tubular reactor which receives process flows from the second continuously stirred tank reactor.

In a solution phase polymerization process generally, a reactor is operated under conditions which achieve a thorough mixing of the reactants and the residence time (or alternatively, the “hold up time”) of the olefin polymerization catalyst (e.g., the activated single site catalyst complex) in a reactor will depend on the design and the capacity of the reactor.

In embodiments, the residence time of the olefin polymerization catalyst (e.g., the activated single site catalyst complex) in a given reactor will be from a few seconds to about 20 minutes. In further embodiments, the residence time of an olefin polymerization catalyst (e.g., the activated single site catalyst complex) in a given reactor will be less than about 10 minutes, or less than about 5 minutes, or less than about 3 minutes.

In embodiments of the disclosure, at least 60 weight percent (wt %) of the ethylene fed to a CSTR reactor is polymerized by an olefin polymerization catalyst system into an ethylene homopolymer or an ethylene copolymer. In further embodiments at least 70 wt %, or at least 80 wt %, or at least 85 wt %, or at least 90 wt %, of the ethylene fed to a CSTR reactor is polymerized by an olefin polymerization catalyst system into an ethylene homopolymer or an ethylene copolymer.

If more than one CSTR is employed, olefin polymerization catalyst system components can be added to each of the CSTR(s) in order to maintain a high polymer production rate in each reactor.

If more than one CSTR is employed, the olefin polymerization catalyst used in each CSTR may be based on the same type of polymerization catalyst or it made be based on different types of polymerization catalyst.

In an embodiment of the disclosure, the same type of olefin polymerization catalyst is used in each CSTR of two or more CSTR reactors.

In an embodiment a mixed catalyst system is used in which one olefin polymerization catalyst is a single site catalyst (for example, the olefin polymerization catalyst system described according to the present disclosure) and one olefin polymerization catalyst is a Ziegler-Natta catalyst, where the single site catalyst is employed in a first CSTR and the Ziegler-Natta catalyst is be employed in a second CSTR.

The term “tubular reactor” is meant to convey its conventional meaning: namely a simple tube, which unlike a CSTR is generally not agitated using an impeller, stirrer or the like. In embodiments, a tubular reactor will have a length/diameter (L/D) ratio of at least 10/1. In embodiments, a tubular reactor is operated adiabatically. By way of a general non-limiting description and without wishing to be bound by theory, in a tubular reactor, as a polymerization reaction progresses, the monomer (e.g., ethylene) and/or comonomer (e.g., alpha-olefin) is increasingly consumed and the temperature of the solution increases along the length of the tube (which may improve the efficiency of separating the unreacted comonomer from the polymer solution). In embodiments, the temperature increase along the length of a tubular reactor may be greater than about 3° C. In embodiments, a tubular reactor is located downstream of a CSTR, and the discharge temperature from the tubular reactor may be at least about 3° C. greater than the discharge temperature from the CSTR (and from which process flows are fed to the tubular reactor).

In embodiments, a tubular reactor may have feed ports for the addition of additional polymerization catalyst system components such as single site pre-polymerization catalysts, Zielger-Natta catalyst components, catalyst activators, cocatalysts, and hindered phenol compounds, or for the addition of monomer, comonomer, hydrogen, etc. In an alternative embodiment, no additional polymerization catalyst components are added to a tubular reactor.

In an embodiment, the total volume of a tubular reactor used in combination with at least one CSTR is at least about 10 volume percent (vol %) of the volume of at the least one CSTR, or from about 30 vol % to about 200 vol % of the at least one CSTR (for clarity, if the volume of the at least one CSTR is 1000 liters, then the volume of the tubular reactor is at least about 100 liters, or from about 300 to 2000 liters).

In embodiments, on leaving the reactor system, non-reactive components may be removed (and optionally recovered) and the resulting polymer (e.g. an ethylene copolymer or an ethylene homopolymer) may be finished in a conventional manner (e.g. using a devolatilization process). In an embodiment, a two-stage devolatilization process may be employed to recover a polymer composition from a polymerization process solvent.

The following examples are presented for the purpose of illustrating selected embodiments of this disclosure; it being understood, that the examples presented do not limit the claims presented.

### EXAMPLES

### General

### General Experimental Methods

All reactions involving air and/or moisture sensitive compounds were conducted under nitrogen using standard Schlenk and glovebox techniques. Reaction solvents were purified using a commercial solvent purification system substantially according to the method described by Grubbs et al. (see Pangborn, A. B.; Giardello, M. A.; Grubbs. R. H.; Rosen R. K.; Timmers, F. J. Organometallics 1996, 15, 1518-1520) and then stored over activated molecular sieves in an inert atmosphere glovebox.

Tetrakis (dimethylamido) titanium (IV) was purchased from Strem Chemicals and used as received. MMAO-7 (7 wt % solution in Isopar-E) and TIBAL (25 wt % solution in hexanes) were purchased from Akzo Nobel/Nouryon and used as received. Triphenylcarbenium tetrakis (pentafluorophenyl) borate was purchased from Albemarle Corp, and used as received. 5,5,8,8-Tetramethyl-2,3,5,6,7,8-hexahydro-1H-cyclopenta[b]naphthalen-1-one was purchased from Ambeed, Inc, and used as received. All other materials were purchased from Aldrich and used as received. Deuterated solvents were purchased from Sigma Aldrich (toluene-d₈, CD₂Cl₂, CDCl₃) and were stored over 4 Å molecular sieves prior to use. NMR spectra were recorded on a Bruker 400 MHz spectrometer (¹H NMR at 400.1 MHz).

Bis(dimethylamido) dichlorotitanium (IV), Ti(NMe₂)₂Cl₂, was prepared substantially as described by Benzing, E, and Kornicker, W. in Chem. Ber. 1961, 94, 2263-2267. Accordingly, tetrakis (dimethylamido) titanium (10.19 g, 45.0 mmol) was dissolved in toluene (80 mL) in a 200-mL Schlenk flask and cooled to 0° C. for 15 minutes. A bright orange solution of titanium (IV) chloride (8.54 g, 45.0 mmol) in toluene (20 mL) was added which resulted in a red suspension. The reaction mixture was stirred overnight and then filtered. The filter cake was extracted further with toluene until the filtrate ran colorless. The combined filtrates were removed under reduced pressure. The residue was slurried in pentane (100 mL) for 10 minutes and filtered. The filter cake was dried under reduced pressure to afford the desired product as a brick-red powder (17.56 g, 94% yield). ¹H NMR (400 MHZ, toluene-d₈) δ 3.02 (s, 12H, NMe₂).

Copolymer samples from semi-batch copolymerization experiments were analyzed using a Polymer Char GPC-IR4 instrument equipped with three GPC columns to rapidly determine polymer Mw. Accordingly, a polymer sample (5 to 7 mg) was weighed into the sample vial and loaded onto the auto-sampler. The vial was filled with 6 ml 1,2,4-trichlorobenzene (TCB), heated to 160° C. with shaking for 160 minutes. 2,6-di-Tert-butyl-4-methylphenol (BHT) was added to the TCB in a concentration of 250 ppm to stabilize the polymer against oxidative degradation. Sample solutions were chromatographed at 140° C. on the Polymer Char GPC-IR4 chromatography unit equipped with three GPC columns (e.g., PL Mixed B) using TCB as the mobile phase with a flow rate of 1.0 mL/minute, with an Infrared IR4 as the concentration detector. BHT was added to the mobile phase at a concentration of 250 ppm to protect SEC columns from oxidative degradation. The sample injection volume was 200 μL. The SEC raw data were processed using an Excel spreadsheet. The SEC columns were calibrated with narrow distribution polystyrene standards. The polystyrene molecular weights were converted to polyethylene molecular weights using the Mark-Houwink equation, as described in the ASTM standard test method D6474.

Molecular weight (GPC-RI M_{w}, Mₙ and M_{z} in g/mol) and molecular weight distribution (GPC-RI M_{w}/Mₙ) data for continuous solution copolymerization experiments were obtained using conventional size exclusion (gel permeation) chromatography (SEC, or GPC). Accordingly, polymer sample solutions (1 to 2 mg/mL) were prepared by heating the polymer in 1,2,4-trichlorobenzene (TCB) and rotating on a wheel for 4 hours at 150° C. in an oven. The antioxidant 2,6-di-tert-butyl-4-methylphenol (BHT) was added to the mixture to stabilize the polymer against oxidative degradation. The BHT concentration was 250 ppm. Sample solutions were chromatographed at 140° C. on a PL 220 high-temperature chromatography unit equipped with four SHODEX® columns (HT803, HT804, HT805 and HT806) using TCB as the mobile phase with a flow rate of 1.0 mL/minute, with a differential refractive index (DRI) as the concentration detector. BHT was added to the mobile phase at a concentration of 250 ppm to protect SEC columns from oxidative degradation. The sample injection volume was 200 μL. The SEC raw data were processed with the CIRRUS® GPC software. The SEC columns were calibrated with narrow distribution polystyrene standards. The polystyrene molecular weights were converted to polyethylene molecular weights using the Mark-Houwink equation, as described in the ASTM standard test method D6474.

Polymer melt index was determined using ASTM D1238 (Aug. 1, 2013). Melt indexes, I₂, I₆, I₁₀ and I₂₁ were measured at 190° C., using weights of 2.16 kg, 6.48 kg, 10 kg and a 21.6 kg respectively. In this disclosure, melt index was expressed using the units of gram/10 minutes or g/10 min or dg/minutes or dg/min; these units are equivalent.

FTIR branch frequencies (CH₃/1000C) were determined from a polymer plaque on a Thermo-Nicolet 750 Magna-IR Spectrophotometer using the method as described in the ASTM standard test method D6645. The polymer plaque is prepared using a compression molding device (Wabash-Genesis Series press) based on ASTM standard test method D1928 (currently replaced with D4703).

### Titanium Pre-Polymerization Catalyst Complexes (Inventive)

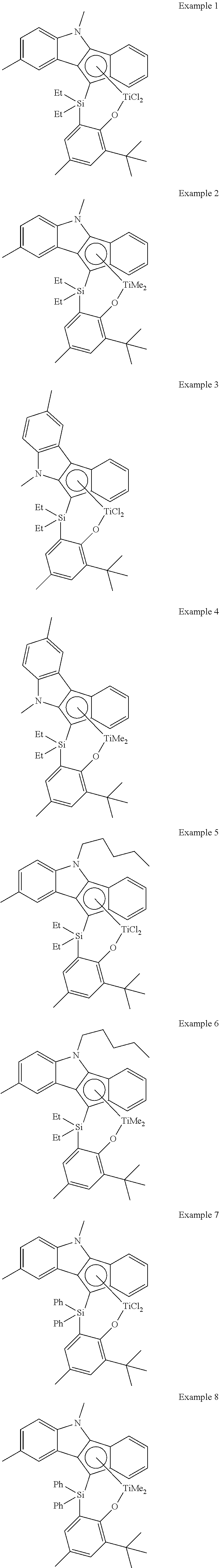

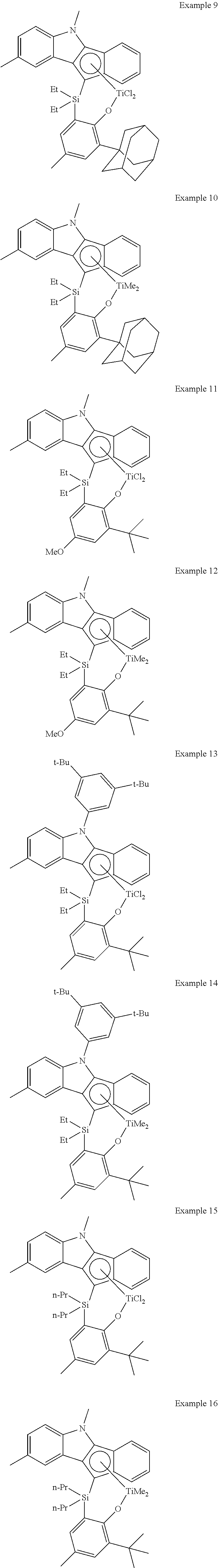

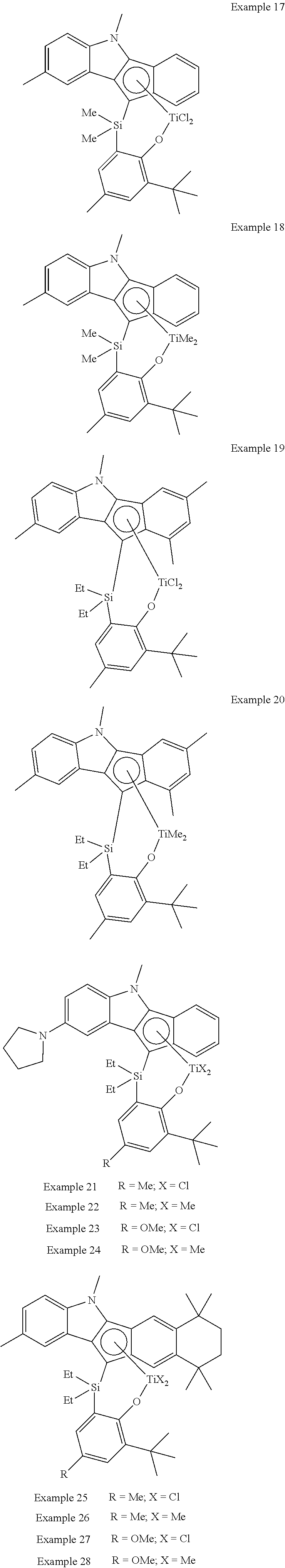

### Titanium Pre-Polymerization Catalyst Complexes (Comparative)

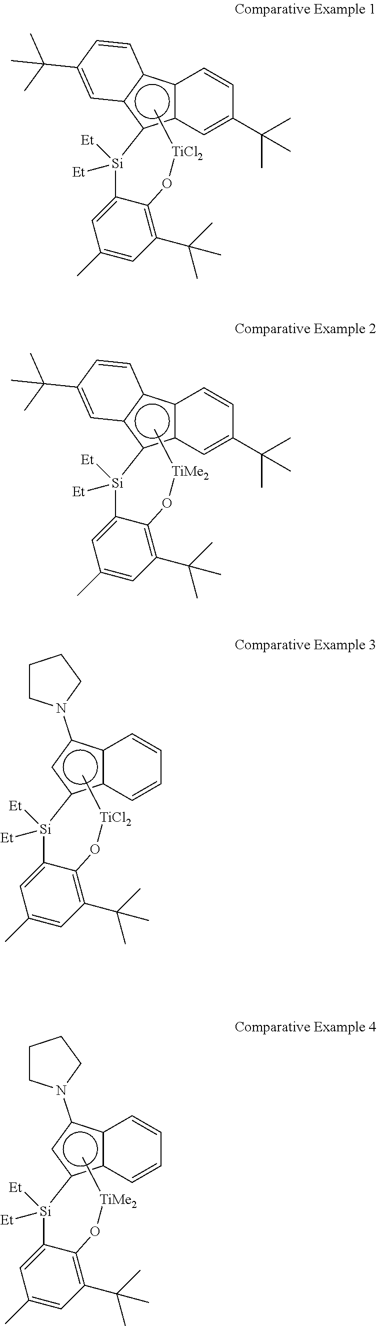

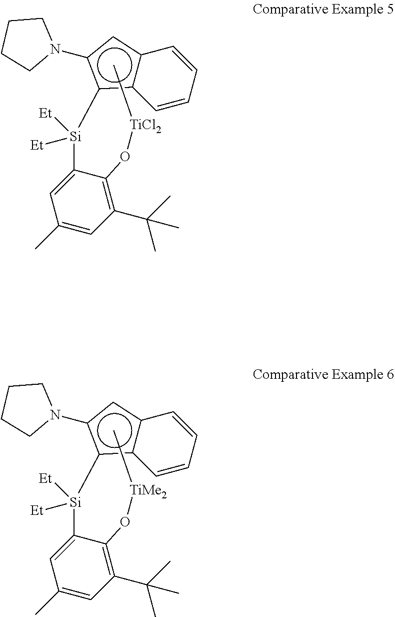

### The Titanium Complexes (the Pre-Polymerization Catalysts)

The titanium pre-polymerization catalysts were prepared using the methods described below.

### Example 1

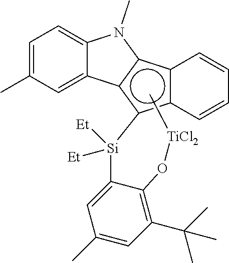

### 8-Methyl-5,10-dihydroindeno[1,2-b]indole

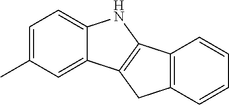 [SMILES: Cc1ccc2[nH]c3c(c2c1)Cc1ccccc1-3]

This material was prepared substantially as described by Grandini, C. et al. in Organometallics, 2004, 23, 344-360. 1-Indanone (5.02 g, 38.0 mmol), p-tolylhydrazine hydrochloride (6.03 g, 38.0 mmol) and p-toluenesulfonic acid monohydrate (0.3 g) were suspended in i-PrOH (150 mol) in a 250-mL round-bottomed flask. A condenser was attached, and the mixture was refluxed for 45 min, during which the reaction mixture became a yellow-orange suspension. The reaction mixture was cooled to 0° C. for 15 minutes and filtered. The filter cake was rinsed with i-PrOH until the filtrate ran colorless. Residual volatiles were removed under reduced pressure, affording the desired product as a white solid (7.45 g, 89% yield). ¹H NMR (400 MHZ, CDCl₃) δ 8.01 (br, 1H, NH), 7.37 (d, 1H, ArH), 7.28 (m, 2H, ArH), 7.20-7.09 (m, 3H, ArH), 7.05 (t, 1H, ArH), 6.85 (d, 1H, ArH), 3.54 (s, 2H, indene-CH₂), 2.31 (s, 3H, ArCH₃).

### 5,8-Dimethyl-5,10-dihydroindeno[1,2-b]indole

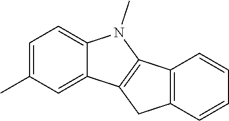 [SMILES: Cc1ccc2c(c1)c1c(n2C)-c2ccccc2C1]

8-Methyl-5,10-dihydroindeno[1,2-b]indole (1.73 g, 7.88 mmol) and potassium tert-butoxide (885 mg, 7.88 mmol) were dissolved in THF (60 mL) in a 100-mL Schlenk flask and the translucent yellow solution was stirred for 1 hour. Iodomethane (0.49 mL, 1.12 g, 7.88 mmol) was added through a syringe which resulted in the instant formation of a white precipitate. After 30 minutes, the reaction mixture was poured into saturated aqueous NH₄Cl (100 mL) and extracted with CH₂Cl₂ (100 mL). The organic extracts were rinsed with water (2×50 mL), brine (50 mL), dried over anhydrous Na₂SO₄, filtered, and removed under reduced pressure to afford a pale-yellow solid. The crude product was purified by recrystallization from hot heptane, affording the desired product as an off-white solid (1.64 g, 89% recrystallized yield). ¹H NMR (400 MHZ, CDCl₃) δ 7.66 (d, 1H, ArH), 7.55 (d, 1H, ArH), 7.45 (s, 1H, ArH), 7.36 (t, 1H, ArH), 7.31-7.20 (m, 1H, ArH), 7.08 (d, 1H, ArH), 4.04 (s, 3H, NCH₃), 3.70 (s, 2H, indene-CH₂), 2.51 (s, 3H, ArCH₃).

### 2-Bromo-6-(tert-butyl)-4-methylphenol

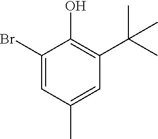

This material was prepared substantially as described by Katayama, H. et al. (Sumitomo) PCT Application WO 97/03992, 1997. 2-(tert-Butyl)-4-methylphenol (26.58 g, 161.8 mmol) was dissolved in acetonitrile (300 mL) in a 500-mL round-bottomed flask affording a pale-yellow solution. The flask was cooled to 0° C. for 15 minutes, after which N-bromosuccinimide (31.68 g, 178.0 mmol) was added in portions. The reaction mixture was stirred overnight. Volatiles were removed under reduced pressure to afford a yellow sticky residue. The residue was extracted with diethyl ether (200 mL), rinsed with H₂O (4×200 mL), brine (20 mL), dried over anhydrous Na₂SO₄ and filtered to afford a golden yellow filtrate. Evaporation of volatiles yields the desired product as a thick yellow oil. (37.89 g, 96% yield). Distillation under reduced pressure gives a colorless oil, but the crude product was spectroscopically pure by NMR and could be used without further purification. ¹H NMR (400 MHZ, CDCl₃) δ 7.29 (s, 1H, ArH), 7.12 (s, 1H, ArH), 5.73 (m, 1H, ArOH), 2.37 (3H, s, ArCH₃), 1.51 (s, 9H, t-Bu). 2-(Allyloxy)-1-bromo-3-(tert-butyl)-5-methylbenzene:

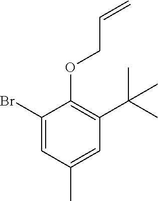 [SMILES: C=CCOc1c(Br)cc(C)cc1C(C)(C)C]

This material was prepared substantially as described by Hanaoka, H. et al. in J. Organomet. Chem. 2007, 692, 4059-4066. 2-Bromo-6-(tert-butyl)-4-methylphenol (9.93 g, 40.83 mmol), potassium carbonate (˜10 g), acetone (100 mL) and allyl bromide (4.24 mL, 49 mmol) were charged to a 250-mL round-bottomed flask equipped with a stir bar. A condenser was attached, and the reaction mixture was refluxed overnight. The reaction mixture, a white suspension, was concentrated under reduced pressure, extracted with pentane and filtered to give a clear colorless filtrate. Evaporation yielded the desired product as a thick colorless oil (11.40 g, 99% yield). ¹H NMR (400 MHZ, CDCl₃) δ 7.28 (m, 1H, ArH), 7.10 (m, 1H, ArH), 6.28 (m, 1H, O-allyl), 5.52 (dq, 1H, O-allyl), 5.32 (dq, 1H, O-allyl), 4.60 (m, 2H, O-allyl), 2.30 (s, 3H, ArCH₃), 1.42 (s, 9H, Ar-t-Bu).

### (2-(Allyloxy)-3-(tert-butyl)-5-methylphenyl) chlorodiethylsilane

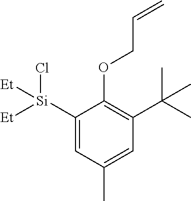 [SMILES: C=CCOc1c(C(C)(C)C)cc(C)cc1[Si](Cl)(CC)CC]

This material was prepared substantially as described by Senda, T. et al. in Macromolecules 2009, 42, 8006-8009. 2-(Allyloxy)-1-bromo-3-(tert-butyl)-5-methylbenzene (0.94 g, 3.3 mmol) was dissolved in toluene (50 mL) in a 100-mL Schlenk flask. The flask was cooled to −78° C., and n-BuLi solution (1.6 M in hexanes, 2.27 mL, 3.63 mmol) was added via a cannula, quantitatively with toluene rinses (3×3 mL). The reaction mixture was let stir and warm gradually, keeping the mixture below-15° C. After 2 hours the reaction mixture, which was a clear pale-yellow solution, was cooled back to −78° C., and Et₂SiCl₂ (1.555 g, 9.9 mmol) was added. The reaction mixture was allowed to warm to ambient temperature over 2 hours and then heated to 50° C. for 1 hour. Volatiles were removed under reduced pressure and the oily residue was extracted with pentane and filtered through Celite to afford a clear colorless filtrate. Volatiles were removed to afford the desired product as a thick colorless oil (0.85 g, 79% yield). ¹H NMR (400 MHZ, toluene-d₈) δ 7.53 (d, 1H, ArH), 7.25 (d, 1H, ArH), 5.85 (m, 1H, O-allyl), 5.50 (dq, 1H, O-allyl), 5.15 (dq, 1H, O-allyl), 4.32 (m, 2H, O-allyl), 2.19 (s, 3H, ArCH₃), 1.42 (s, 9H, Ar-t-Bu), 1.30-1.05 (m, 10H, SiEt₂).

### 10-((2-(Allyloxy)-3-(tert-butyl)-5-methylphenyl) diethylsilyl)-5,8-dimethyl-5,10-dihydroindeno[1,2-b]indole

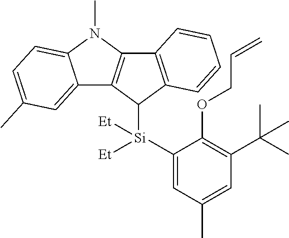 [SMILES: C=CCOc1c(C(C)(C)C)cc(C)cc1[Si](CC)(CC)C1c2ccccc2-c2c1c1cc(C)ccc1n2C]

5,8-Dimethyl-5,10-dihydroindeno[1,2-b]indole (1.64 g, 7.04 mmol) was dissolved in THF (30 mL) in a 100-mL Schlenk flask. With vigorous stirring n-BuLi solution (1.6 M in hexanes, 4.62 mL, 7.39 mmol) was added and the dark red reaction mixture was stirred for 1 hour. A slow effervescence (butane) was observed initially but subsided over time. After 1 hour, (2-(allyloxy)-3-(tert-butyl)-5-methylphenyl) chlorodiethylsilane (2.29 g, 7.04 mmol) was added resulting in a dark orange-red solution. The reaction mixture was stirred for 1 hour and then the volatiles were removed under reduced pressure which resulted in a sticky yellow solid. The crude material was slurried in pentane (20 mL) and cooled to −30° C. The solids were then collected on a sintered glass funnel and dried under reduced pressure (2.20 g, 60% yield). ¹H NMR (400 MHZ, toluene-d₈) δ 7.52 (m, 2H, ArH), 7.35 (m, 1H, ArH), 7.27 (t, 1H, ArH), 7.18-7.00 (m, 4H, ArH), 6.73 (s, 1H, ArH), 5.85 (m, 1H, allyl-H), 5.58 (dq, 1H, allyl-H), 5.18 (dq, 1H, allyl-H), 4.49 (s, 1H, Si—CH), 4.34 (qd, 1H, allyl-H), 3.45 (s, 3H, NCH₃), 2.44 (s, 3H, ArCH₃), 2.20 (s, 3H, ArCH₃), 1.51 (s, 9H, t-Bu), 1.49-0.70 (m, 10H, SiEt₂).

### Example 1

10-((2-(Allyloxy)-3-(tert-butyl)-5-methylphenyl) diethylsilyl)-5,8-dimethyl-5,10-dihydroindeno[1,2-b]indole (2.20 g, 4.216 mmol) was dissolved in toluene (40 mL) in a 100-mL Schlenk flask, and cooled to −78° C. for 15 minutes. NEt₃ (2.64 mL, 1.92 g, 18.97 mmol) and n-BuLi solution (1.6 M in hexanes, 5.93 mL, 9.49 mmol) were added successively. The pale-yellow solution was allowed to warm to ambient temperature and stir for another 2 hours, after which the reaction mixture was cooled once again to −78° C. for 15 minutes. Ti(NMe₂)₂Cl₂ (1.05 g, 5.06 mmol) was added as a slurry in toluene, and the reaction mixture was warmed to ambient temperature over 10 minutes followed by heating to 90° C. for 3 h to give a dark red-brown solution. Volatiles were removed under reduced pressure, the residue extracted with toluene and filtered through Celite to afford a dark brown filtrate. The extraction was continued until the filtrate ran colorless and then the combined extracts were sealed in a 100-mL flask with the headspace evacuated. Chlorotrimethylsilane (1.07 mL, 0.92 g, 8.43 mmol) was added via syringe and the mixture was heated to 85° C. for 5 hours. Volatiles were removed, and the residue was recrystallized from hot heptane to afford the desired product as a dark red-brown solid. (1.96 g. 78% recrystallized yield). ¹H NMR (400 MHZ, toluene-d₈) δ 7.93 (d, 1H, ArH), 7.79 (d, 1H, ArH), 7.48 (s, 1H, ArH), 7.40-7.20 (m. 3H, ArH), 7.05 (m, 1H, ArH), 6.83 (d, 1H, ArH), 6.47 (s, 1H, ArH), 3.62 (s, 3H, NCH₃), 2.44 (s, 3H, ArCH₃), 2.13 (s, 3H, ArCH₃), 1.70-1.30 (m, 4H, SiEt₂), 1.20-1.00 (m, 15H, SiEt₂+t-Bu).

### Example 2

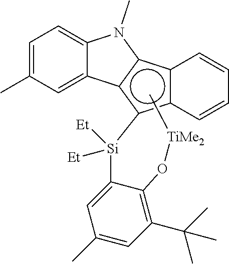

### Example 2

Example 1 (1.05 g, 1.75 mmol) was dissolved in toluene (35 mL) in a 100-mL Schlenk flask. MeMgBr solution (3.0 M in diethyl ether, 1.28 mL, 3.85 mmol) was added and the resulting red-brown solution was stirred for 2 hours. Volatiles were removed under reduced pressure and the residue was extracted with toluene and filtered through Celite. The bright orange filtrate was collected and concentrated under reduced pressure to an amorphous orange residue. This was redissolved in pentane and concentrated under reduced pressure to afford the desired product as a bright orange powder (806 mg, 83% yield). ¹H NMR (400 MHZ, toluene-d₈) δ 7.91 (d, 1H, ArH), 7.79 (d, 1H, ArH), 7.45 (s, 1H, ArH), 7.32 (s, 1H, ArH), 7.30-6.90 (m, 3H, ArH), 6.80 (d, 1H, ArH), 6.55 (s, 1H, ArH), 3.57 (s, 3H, NCH₃), 2.45 (s, 3H, ArCH₃), 2.12 (s, 3H, ArCH₃), 1.31 (s, 9H, t-Bu), 1.30-1.05 (m, 10H, SiEt₂), 0.23 (s, 3H, TiCH₃), 0.03 (s, 3H, TiCH₃).

### Example 3

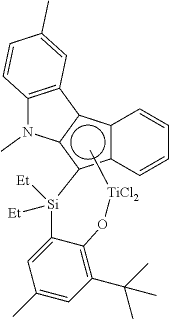

### 2-Methyl-5,6-dihydroindeno[2,1-b]indole

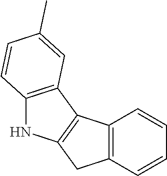 [SMILES: Cc1ccc2[nH]c3c(c2c1)-c1ccccc1C3]

This material was prepared substantially as described by Grandini, C. et al. in Organometallics, 2004, 23, 344-360. 2-Indanone (5.95 g, 45.0 mmol) and p-tolylhydrazine hydrochloride (7.14 g, 45.0 mmol) were slurried in i-PrOH (300 mL) in a 500-mL round-bottomed flask. A Vigreux column was attached, and the reaction mixture was refluxed for 2 hours and then poured into saturated aqueous NaHCO₃ (300 mL). The precipitate was collected on a sintered glass funnel and rinsed with i-PrOH and water. The crude material was dissolved in CH₂Cl₂ (200 mL), shaken with brine (50 mL), dried over anhydrous Na₂SO₄, filtered and concentrated under reduced pressure to give the desired product (7.76 g, 79% yield). ¹H NMR (400 MHZ, CDCl₃) δ 8.20 (br s, 1H, NH), 7.70-7.60 (m, 2H, ArH), 7.43 (d, 1H, ArH), 7.35 (t, 1H, ArH), 7.28 (m, 1H, ArH), 7.09 (t, 1H, ArH), 7.04 (d, 1H, ArH), 3.72 (s, 2H, indene-CH₂), 2.52 (s, 3H, ArCH₃).

### 2,5-Dimethyl-5,6-dihydroindeno[2,1-b]indole

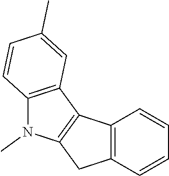 [SMILES: Cc1ccc2c(c1)c1c(n2C)Cc2ccccc2-1]

2-Methyl-5,6-dihydroindeno[2,1-b]indole (7.76 g, 35.4 mmol) was dissolved in THF (150 mL) in a 250-mL round-bottomed flask. Potassium tert-butoxide (3.97 g, 35.4 mmol) was added which resulted in a color change from dark green to dark red. After stirring for 1 hour, the flask was immersed in a water bath and iodomethane (2.20 mL, 5.02 g. 35.4 mmol) was added slowly resulting in a mild exotherm and a brown suspension. The reaction mixture was stirred overnight and then poured into aqueous NH₄Cl (57 g in 300 mL of water) resulting in a suspended precipitate. The slurry was stirred for 30 minutes and then the solids were collected on a sintered glass funnel and rinsed with water. This material was dissolved in CH₂Cl₂ (200 mL), shaken with brine (50 mL), dried over anhydrous Na₂SO₄, filtered and concentrated under reduced pressure to afford a dark greenish-brown solid (7.63 g, 93% yield). ¹H NMR (400 MHZ, CDCl₃) δ 7.70-7.60 (m, 2H, ArH), 7.45 (d, 1H, ArH), 7.35 (t, 1H, ArH), 7.25 (m, 1H, ArH), 7.10-7.02 (m, 2H, ArH), 3.81 (s, 3H, NCH₃), 3.72 (s, 2H, indene-CH₂), 2.53 (s, 3H, ArCH₃).

### 6-((2-(Allyloxy)-3-(tert-butyl)-5-methylphenyl) diethylsilyl)-2,5-dimethyl-5,6-dihydroindeno[2,1-b]indole

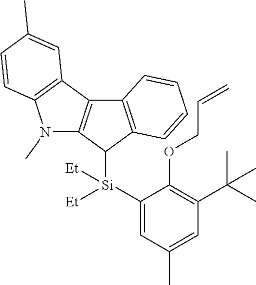 [SMILES: C=CCOc1c(C(C)(C)C)cc(C)cc1[Si](CC)(CC)C1c2ccccc2-c2c1n(C)c1ccc(C)cc21]

2,5-Dimethyl-5,6-dihydroindeno[2,1-b]indole (467 mg, 2.0 mmol) was weighed into a 100-mL Schlenk flask and dissolved in THF (40 mL). n-BuLi solution (1.6 M in hexanes, 1.38 mL, 2.2 mmol) was added via a syringe, and the reaction mixture was stirred for 2 hours. Volatiles were removed under reduced pressure and the residue was redissolved in diethyl ether (40 mL). (2-(Allyloxy)-3-(tert-butyl)-5-methylphenyl) chlorodiethylsilane (650 mg, 2.0 mmol) was weighed into a vial and added quantitatively via diethyl ether rinses (3×3 mL) resulting in a precipitate. The brown suspension was stirred overnight. The volatiles were removed under reduced pressure and the residue was extracted with toluene and filtered to afford a clear, dark-brown filtrate. The filtrate was concentrated under reduced pressure, triturated with pentane, and then concentrated again to afford the product as a brown, glassy residue (1.04 g, 99% yield). ¹H NMR (400 MHZ, toluene-d₈) δ 7.90-6.90 (m, 9H, ArH), 5.85 (m, 1H, allyl-H), 5.55 (d, 1H, allyl-H), 5.19 (d, 1H, allyl-H), 4.28 (m, 2H, allyl-H), 4.19 (s, 1H, Si—CH), 3.00 (s, 3H, NCH₃), 2.55 (s, 3H, ArCH₃), 2.17 (s, 3H, ArCH₃), 1.46 (s, 9H, Ar-1-Bu), 1.10-0.50 (m, 10H, SiEt₂).

### Example 3

6-((2-(Allyloxy)-3-(tert-butyl)-5-methylphenyl) diethylsilyl)-2,5-dimethyl-5,6-dihydroindeno[2,1-b]indole (1.08 g, 1.99 mmol) was dissolved in toluene (20 mL) in a 100-mL Schlenk flask. Triethylamine (1.25 mL, 8.943 mmol, 4.5 eq) was added to the flask, and the reaction mixture was cooled to −78° C. for 15 minutes. n-BuLi solution (1.6 M in hexanes, 2.79 mL, 4.47 mmol, 2.25 eq) was added quantitatively from a hypovial via toluene rinses (3×3 mL) and the reaction mixture was allowed to stir and warm to ambient temperature over 2 hours. The reaction mixture was cooled to −78° C. for 15 minutes and Ti(NMe₂)₂Cl₂ (493 mg, 2.38 mmol, 1.2 eq) was added as a solution in toluene (10 mL). The cold bath was removed after 30 minutes and replaced with an oil bath. The reaction mixture was heated to 90° C. for 3 hours to afford a dark red-brown mixture. Volatiles were removed and the residue was extracted with pentane and filtered to afford a clear dark-brown filtrate. Volatiles were removed from the filtrate, and residue was redissolved in toluene (30 mL). Chlorotrimethylsilane (0.51 mL, 3.974 mmol, 2 eq) was added and the mixture was heated to 80° C. overnight. Volatiles were removed from the dark red-brown solution and the sticky residue was triturated with pentane. The residue was purified via recrystallization from hot heptane to afford the desired product as a red-brown crystalline powder (580 mg, 49% yield). ¹H NMR (400 MHz, toluene-d₈) δ 8.06 (d, 1H, ArH), 7.95 (s, 1H, ArH), 7.59 (d, 1H, ArH), 7.34 (s, 1H, ArH), 7.28 (s, 1H, ArH), 7.20-6.80 (m, 4H, ArH), 3.27 (s, 3H, NCH₃). 2.39 (s, 3H, ArCH₃), 2.36 (s, 3H, ArCH₃), 1.45 (m, 2H, SiCH₂CH₃), 1.33 (s, 9H, Ar-t-Bu), 1.12 (t, 3H, SiCH₂CH₃), 1.05 (t, 3H, SiCH₂CH₃), 0.95 (m, 2H, SiCH₂CH₃).

### Example 4

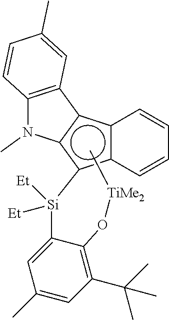

### Example 4

Example 3 (461 mg, 0.770 mmol) was dissolved in toluene (5 mL) in a vial. MeMgBr solution (3.0 M in diethyl ether, 0.54 mL, 1.618 mmol) was added with stirring and resulted in a color change from dark red-brown to a dark yellow-brown. After 2 hours the volatiles were removed and the residue was extracted with toluene and filtered to afford a dark yellow-brown filtrate. Volatiles were removed, the residue was triturated with pentane and concentrated once again to yield the desired product as a yellow-brown powder (355 mg, 83% yield). ¹H NMR (400 MHZ, toluene-d₈) δ 8.06 (d, 1H, ArH), 7.89 (s, 1H, ArH), 7.80 (d, 1H, ArH), 7.30-7.00 (m, 5H, ArH), 6.72 (d, 1H, ArH), 2.91 (s, 3H, NCH₃), 2.48 (s, 3H, ArCH₃), 2.36 (s, 3H, ArCH₃), 1.51 (s, 9H, Ar-t-Bu), 1.40-0.90 (m, 10H, SiEt₂), 0.30 (s, 3H, TiCH₃), 0.21 (s, 3H, TiCH₃).

### Example 5

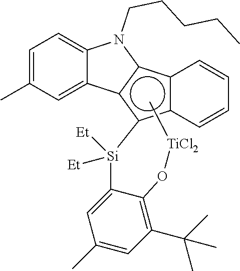

### 5-Pentyl-8-methyl-5,10-dihydroindeno[1,2-b]-indole

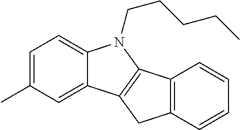 [SMILES: CCCCCn1c2c(c3cc(C)ccc31)Cc1ccccc1-2]

8-Methyl-5,10-dihydroindeno[1,2-b]indole (3.00 g, 13.7 mmol) and potassium tert-butoxide (14.4 g, 13.7 mmol) were dissolved in THF (35 mL) in a 100-mL Schlenk flask and the opaque orange solution was stirred for 1 hour. Degassed 1-bromopentane (1.87 mL, 15.1 mmol) was added via syringe. The reaction was refluxed for 18 hours at 80° C. After cooling to ambient temperature, the reaction mixture was poured into water (100 mL) and extracted with CH₂Cl₂ (100 mL). The organic extracts were rinsed with water (2×50 mL), brine (50 mL), dried over anhydrous Na₂SO₄, filtered, and concentrated under reduced pressure to afford a brown solid (2.66 g, 67% yield). ¹H NMR (400 MHZ, CDCl₃) δ 7.55 (t, 2H, ArH), 7.43 (t, 1H, ArH), 7.35 (s, tH, ArH), 7.24 (t, 1H, ArH), 7.04 (m, 1H, ArH), 4.39 (t, 1H, pent-H), 3.74 (s, 3H, CH₂), 2.48 (s, 3H, CH₃), 1.91 (m, 2H, pent-H), 1.37 (m, 5H, pent-H), 0.90 (t, 3H, pent-H).

### 10-((2-(Allyloxy)-3-(tert-butyl)-5-methylphenyl) diethylsilyl)-5-pentyl-8-dimethyl-5,10-dihydroindeno[1,2-b]indole

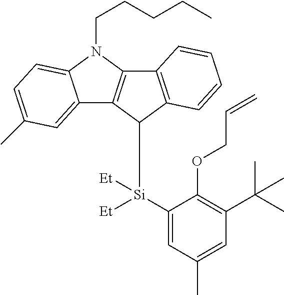 [SMILES: C=CCOc1c(C(C)(C)C)cc(C)cc1[Si](CC)(CC)C1c2ccccc2-c2c1c1cc(C)ccc1n2CCCCC]

5-Pentyl-8-methyl-5,10-dihydroindeno[1,2-b]-indole (0.89 g, 3.06 mmol) was dissolved in THF (30 mL) in a 100-mL Schlenk flask. With stirring, n-BuLi solution (1.6 M in hexanes, 2.3 mL, 3.67 mmol) was added which resulted in effervescence and a bright red colour. After 24 hours (2-(Allyloxy)-3-(tert-butyl)-5-methylphenyl) chlorodiethylsilane (0.994 g, 3.06 mmol) was added. The dark orange solution was stirred overnight and a white precipitate formed. Volatiles were removed under reduced pressure and the brown oil was triturated with toluene, filtered through Celite, and concentrated again down to a brown oil. The resulting crude material was used directly in subsequent steps.

### Example 5

10-((2-(Allyloxy)-3-(tert-butyl)-5-methylphenyl) diethylsilyl)-5-pentyl-8-methyl-5,10-dihydroindeno[1,2-b]indole (0.850 g, 1.47 mmol) was dissolved in toluene (30 mL) in a 100-mL Schlenk flask, and cooled to −78° C. for 15 minutes. Triethylamine (0.92 mL, 6.61 mmol) and n-BuLi solution (1.6 M in hexanes, 2.10 mL, 3.31 mmol) were added successively. The pale-yellow solution was allowed to warm to ambient temperature and stir for another 2 hours after which the reaction mixture was cooled once again to −78° C. for 15 minutes. Ti(NMe₂)₂Cl₂ (0.367 g, 1.76 mmol) was added as a slurry in toluene, and the reaction mixture was warmed to ambient temperature over 10 minutes and then heated to 90° C. for 3 hours to give a dark red-brown solution. Volatiles were removed under reduced pressure and the residue was extracted with toluene and filtered through Celite to afford dark a brown filtrate. Extraction continued until the filtrate ran colorless and the combined filtrate was sealed in a 100-mL flask with the headspace evacuated.

Chlorotrimethylsilane (0.373 mL, 0.319 g, 2.94 mmol) was added via syringe and the mixture was heated to 85° C. overnight. Volatiles were removed and the residue was slurried in cold pentane and filtered. A black solid was collected from the filter. (0.336 g. 35% yield). ¹H NMR (400 MHZ, toluene-d₈) δ 7.93 (t, 2H, ArH), 7.45 (s, 1H, ArH), 7.31 (m, 3H, ArH), 6.49 (s, 1H, ArH), 4.45 (dq, 2H, NCH₂), 2.41 (s, 3H, ArCH₃), 1.59 (m, 4H, SiEt₃), 1.36 (m, 4H, SiEt₂), 1.08 (s, 12H, ArCH₃+tBu), 1.01 (t, 3H, CH₃), 1.50-0.73 (m, 6H, pentyl-CH₂).

### Example 6

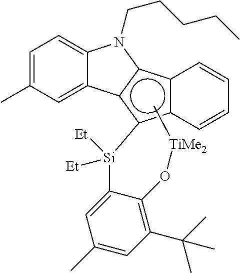

### Example 6

Example 5 (0.336 g, 0.50 mmol) was dissolved in toluene (10 mL) in a 100-mL Schlenk flask and MeMgBr solution (3.0 M in diethyl ether, 0.60 mL, 1.80 mmol) was added. The red-brown solution was stirred for 2 hours. Volatiles were removed under reduced pressure and the residue was extracted with toluene and filtered through Celite. The bright red filtrate was collected and concentrated under reduced pressure to yield a red sticky solid (186 mg. 61% yield). ¹H NMR (400 MHZ, toluene-d₈) δ 7.99 (d, 1H, ArH), 7.97 (d, 1H, ArH), 7.40 (d, 1H, ArH), 7.24 (d, 1H, ArH), 7.18 (dt, 2H, ArH), 6.96 (s, 1H, ArH₂), 6.93 (s, 1H, ArH), 6.59 (s, 1H, ArH) 4.21 (dq, 2H, NCH₂), 2.42 (s, 3H, ArCH₃), 1.68 (m, 2H, pentyl-CH₂), 1.31 (s, 9H, tBuCH), 1.20-1.06 (m, 15H, pentyl-CH₂+SiEt₂), 0.77 (t, 3H, pentyl-CH₃), 0.24 (s, 3H, TiCH₃), 0.07 (s, 3H, TiCH₃).

### Example 7

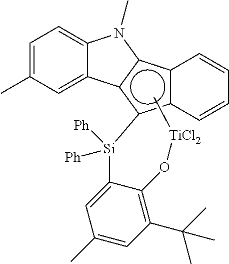

### (2-(Allyloxy)-3-(tert-butyl)-5-methylphenyl) chlorodiphenylsilane

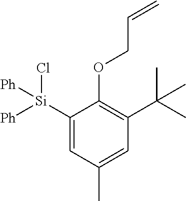 [SMILES: C=CCOc1c(C(C)(C)C)cc(C)cc1[Si](Cl)(c1ccccc1)c1ccccc1]

2-(Allyloxy)-1-bromo-3-(tert-butyl)-5-methylbenzene (5.04 g, 17.8 mmol) was weighed into a 100 mL flask and 50 mL of dry toluene was added. The solution was cooled to −78° C., and a solution of n-BuLi solution (12.2 mL, 19.5 mmol, 1.6 M, hexanes) was added dropwise. The mixture was allowed to warm slowly over 2 hours to −15° C., and kept at that temperature for 30 minutes. The solution was cooled to −78° C., and neat Ph₂SiCl₂ (12.6 mL, 12.37 mmol) was rapidly injected into the mixture. The flask was allowed to warm to ambient temperature overnight. Volatiles were removed under reduced pressure with heating to 40° C. to give a thick slightly orange liquid. Pentane was added and the mixture was filtered through a plug of Celite. Volatiles were removed, and the mixture was distilled at 120° C. under dynamic vacuum. A thick off-white liquid was obtained (4.50 g, 60% yield, ˜90% pure by NMR). ¹H NMR (400 MHZ, toluene-d₈) δ 7.78 (m, 4H, ArH), 7.60 (m, 1H, ArH), 7.48 (m, 2H, ArH), 7.27 (d, 1H, ArH), 7.12 (d, 4H, ArH), 5.36 (m, 1H, allyl-H), 4.97 (dq, 1H, allyl-H), 4.80 (dq, 1H, allyl-H), 4.16 (m, 2H, allyl-H) 1.46 (s, 3H, CH₃), 1.39 (s, 9H, C(CH₃)₃.

### 10-((2-(Allyloxy)-3-(tert-butyl)-5-methylphenyl) diphenylsilyl)-5,8-dimethyl-5,10-dihydroindeno[1,2-b]indole

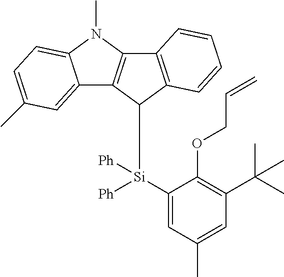 [SMILES: C=CCOc1c(C(C)(C)C)cc(C)cc1[Si](c1ccccc1)(c1ccccc1)C1c2ccccc2-c2c1c1cc(C)ccc1n2C]

5,8-Dimethyl-5,10-dihydroindeno[1,2-b]indole (1.00 g, 4.31 mmol) was dissolved in THF (30 mL) and placed in the freezer to cool to −30° C. After one hour, n-BuLi solution (2.8 mL, 1.6 M, 4.5 mmol, 1.05 eq) was added dropwise, which caused the immediate formation of a dark orange solution. After stirring at ambient temperature for 3 hours, the solution was again placed in the freezer and the (2-(allyloxy)-3-(tert-butyl)-5-methylphenyl) chlorodiphenylsilane (1.85 g, 4.4 mmol) was dissolved in THF (20 mL) and also placed in the freezer. After one hour the chlorosilane solution was added dropwise to the lithiated indenoindolyl precursor and the mixture was stirred at ambient temperature for 48 hours. Volatiles were removed under dynamic vacuum and the product was extracted with heptane and filtered through a plug of Celite, and volatiles were removed leaving 2.4 g of a light-yellow to orange foamy solid material which was used without further purification.

### Example 7

Crude 10-((2-(allyloxy)-3-(tert-butyl)-5-methylphenyl) diphenylsilyl)-5,8-dimethyl-5,10-dihydroindeno[1,2-b]indole (2.40 g, 3.88 mmol) was dissolved in toluene (40 mL) and triethylamine (2.45 mL, 15.5 mmol) was added to the flask. The flask was cooled down to

−78° C., and n-BuLi solution (5.5 mL, 1.6 M hexanes, 8.8 mmol) was slowly added via syringe. The mixture was slowly warmed to ambient temperature over an hour and let stand for an additional hour. The mixture was then cooled back to −78° C., and Ti(NMe₂)₂Cl₂ (964 mg, 4.66 mmol) in toluene (20 mL) was added via cannula and rinsed with 2 additional aliquots of toluene (5 mL each). The mixture was stirred at −78° C. for 10 minutes and then allowed to warm to ambient temperature and then heated to 90° C. for 2 hours affording a black mixture. Volatiles were removed under reduced pressure with heating to 45° C., and 50 mL of toluene was added. After filtering the mixture through Celite, the solution was placed under static vacuum and chlorotrimethylsilane (1.5 mL, 11.6 mmol, 3 eq) was syringed into flask and the mixture was heated to 80° C. overnight. Volatiles were removed under dynamic vacuum and heptane was added and the flask was heated to 90° C., and the solution was transferred to a hypovial which was then placed in the freezer. Filtration resulted in in a green, crystalline compound (1.11 g, 41.3% yield). ¹H NMR (400 MHZ, toluene-d₈) δ 7.98 (m, 2H, ArH), 7.86 (m, 2H, ArH), 7.71 (d, 1H, ArH), 7.52 (s, 1H, ArH), 7.26 (m, ArH, 3H), 7.20 (m, 4H, ArH), 7.05 (d, 1H, ArH), 6.91 (dd, 2H, ArH), 6.84 (d, 2H, ArH), 6.56 (s, 1H, ArH), 3.63 (s, 3H, CH₃), 2.15 (s, 3H, CH₃), 1.94 (s, 3H, CH₃), 1.18 (s, 9H, C(CH₃)₃).

### Example 8

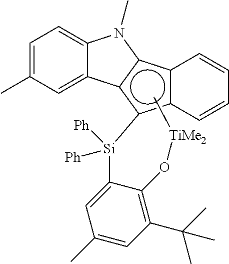

### Example 8

Example 7 (932 mg) was dissolved in toluene (20 mL) and while rapidly stirring, MeMgBr solution (0.95 mL, 3 M in diethyl ether, 2.1 eq) was syringed into the solution. The mixture was allowed to stir at ambient temperature overnight. Volatiles were removed under dynamic vacuum, toluene was added (20 mL), and the volatiles were removed once again under vacuum. Toluene was added and the mixture was warmed and then filtered through Celite. Volatiles were removed and an orange powder was obtained (745 mg). Recrystallization from cold pentane afforded an orange, semi-crystalline powder (430 mg, 0.66 mmol, 49% yield). ¹H NMR (400 MHZ, toluene-d₈) δ 7.98 (m, 2H, ArH), 7.92 (m, 2H, ArH), 7.83 (d, 1H, ArH), 7.45 (d, 1H, ArH), 7.27 (d, 1H, ArH), 7.16 (m, 4H, ArH), 7.12 (m, 2H, ArH), 7.05 (m, 2H, ArH), 6.95 (d, 1H, ArH), 6.82 (d, 1H, ArH), 6.78 (m, 1H, ArH), 6.36 (s, 1H, ArH), 3.58 (s, 3H, CH₃), 2.17 (s, 3H, CH₃), 1.94 (s, 3H, CH₃), 1.39 (s, 9H, C(CH₃)₃), 0.09 (s, 3H. TiCH₃), 0.05 (s, 3H, CH₃).

### Example 9

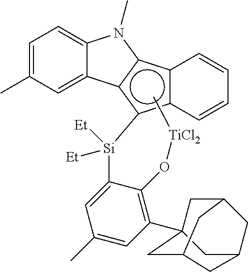

### 2-((3r,5r,7r)-Adamantan-1-yl)-6-bromo-4-methylphenol

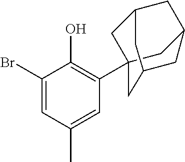 [SMILES: Cc1cc(Br)c(O)c(C23CC4CC(CC(C4)C2)C3)c1]

2-((3r,5r,7r)-Adamantan-1-yl)-4-methylphenol (2.0 g, 8.25 mmol) was slurried in acetonitrile (100 mL) in a 250-mL round-bottomed flask and cooled to 0° C. for 15 minutes. N-Bromosuccinimide (1.62 g, 9.08 mmol) was added. The pale-yellow reaction mixture was stirred and allowed to warm to ambient temperature overnight which resulted in a pale-yellow suspension. Volatiles were removed under reduced pressure and the residue was partitioned between CH₂Cl₂ and water (150 mL of each). The organic layer was collected, combined with further CH₂Cl₂ extracts of the aqueous layer (2×100 mL), rinsed with water (2×100 mL), brine (50 mL), dried over anhydrous Na₂SO₄, and filtered. The filtrate was concentrated under reduced pressure to give a pale-yellow solid (2.63 g, 8.20 mmol, 99% yield). ¹H NMR (400 MHZ, CDCl₃) δ 7.15 (d, 1H, ArH), 6.95 (d, 1H, ArH), 5.63 (s, 1H, ArOH), 2.25 (s, 3H, ArCH₃), 2.15-2.01 (br, 9H, AdH), 1.77 (br s, 6H, AdH).

### (3r,5r,7r)-1-(2-(Allyloxy)-3-bromo-5-methylphenyl) adamantane

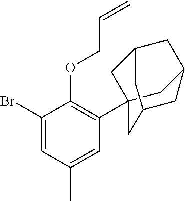 [SMILES: C=CCOc1c(Br)cc(C)cc1C12CC3CC(CC(C3)C1)C2]

2-((3r,5r,7r)-Adamantan-1-yl)-6-bromo-4-methylphenol (2.63 g, 8.20 mmol), potassium carbonate (4.53 g, 16.39 mmol) and acetone (70 mL) were combined in a 100-mL round-bottomed flask and attached to a condenser. The mixture was stirred for 10 minutes and then allyl bromide (2.84 mL, 16.39 mmol) was added. The reaction mixture was refluxed for 5 hours, cooled to ambient temperature, and filtered through Celite. The clear yellow filtrate was concentrated to dryness, triturated with pentane, and concentrated once again to afford an off-white powder (2.80 g, 95% yield). ¹H NMR (400 MHZ, CDCl₃) δ 7.25 (m, 1H, ArH), 7.03 (d, 1H, ArH), 6.14 (m, 1H, allyl-H), 5.54 (dq, 1H, allyl-H), 5.32 (dq, 1H, allyl-H), 4.59 (m, 1H, allyl-H), 2.28 (3H, ArCH₃), 2.07 (br, 9H, AdH), 1.76 (br, 6H, AdH).

### (3-((3r,5r,7r)-Adamantan-1-yl)-2-(allyloxy)-5-methylphenyl) chlorodiethylsilane

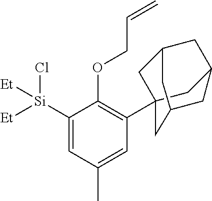 [SMILES: C=CCOc1c(C23CC4CC(CC(C4)C2)C3)cc(C)cc1[Si](Cl)(CC)CC]

(3r,5r,7r)-1-(2-(Allyloxy)-3-bromo-5-methylphenyl) adamantane (1.40 g, 3.88 mmol) was dissolved in dry diethyl ether (80 mL). The reaction mixture was cooled to −78° C. for 15 minutes and n-BuLi solution (1.6 M in hexanes, 2.54 mL, 4.07 mmol) was added. The reaction mixture was stirred for 3 hours at −78° C. after which dichlorodiethylsilane (1.52 g, 9.69 mmol) was added. The reaction mixture was warmed to ambient temperature overnight which resulted in a yellow-brown suspension. Volatiles were removed and the residue was extracted with pentane and filtered through Celite to give a brown solution. Volatiles were removed to afford the crude product as a thick oil which was used without further purification (1.28 g, 82% yield, ˜90% pure by NMR). ¹H NMR (400 MHZ, toluene-d₈) δ 7.50 (d, 1H, ArH), 7.18 (d, 1H, ArH), 5.80 (m, 1H, allyl-H), 5.53 (dq, 1H, allyl-H), 5.13 (dq, 1H, allyl-H), 4.31 (m, 2H, allyl-H), 2.19 (s, 3H, ArCH₃), 2.07 (br m, 6H, AdH), 2.01 (br, 3H, AdH), 1.74 (br, 6H, AdH), 1.23-1.03 (m, 10H, SiEt₂).

### 10-((3-((3r,5r,7r)-Adamantan-1-yl)-2-(allyloxy)-5-methylphenyl) diethylsilyl)-5,8-dimethyl-5,10-dihydroindeno[1,2-b]indole

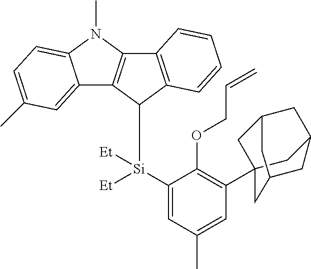 [SMILES: C=CCOc1c(C23CC4CC(CC(C4)C2)C3)cc(C)cc1[Si](CC)(CC)C1c2ccccc2-c2c1c1cc(C)ccc1n2C]

5,8-Dimethyl-5,10-dihydroindeno[1,2-b]indole (0.74 g, 3.18 mmol) was dissolved in THF (30 mL) in a 100-mL Schlenk flask. With stirring, n-BuLi solution (1.6 M in hexanes, 2.09 mL, 3.34 mmol) was added which resulted in effervescence and a bright red colour. After 30 minutes a THF solution (10 mL) of (3-((3r,5r,7r)-adamantan-1-yl)-2-(allyloxy)-5-methylphenyl) chlorodiethylsilane (1.28 g, 3.18 mmol) was added via cannula. After stirring the dark orange solution overnight, the volatiles were removed under reduced pressure and the foamy residue was triturated with pentane and concentrated under reduced pressure to an off-white powder. This was extracted with toluene, filtered, and concentrated under reduced pressure. Purification via column chromatography (silica gel, 9:1 heptane:ethyl acetate) afforded a sticky pale yellow solid (1.39 g, 73% yield. The material thus isolated was used without further purification.

### Example 9

10-((3-((3r,5r,7r)-Adamantan-1-yl)-2-(allyloxy)-5-methylphenyl) diethylsilyl)-5,8-dimethyl-5,10-dihydroindeno[1,2-b]indole (1.39 g, 2.32 mmol) was dissolved in toluene (30 mL) and treated with triethylamine (1.46 mL, 10.46 mmol), resulting in a yellow suspension. The flask was cooled to −78° C. for 15 minutes and then n-BuLi solution (1.6 M in hexanes, 3.27 mL, 5.23 mmol) was added. The reaction mixture was warmed to ambient temperature and stirred for 1 hour resulting in a clear orange solution. The flask was cooled once again to −78° C. for 15 minutes. Ti(NMe₂)₂Cl₂ (577 mg, 2.79 mmol) was added as a toluene solution and the reaction mixture was a dark brown color. The cold bath was removed, and the mixture was heated to 90° C. for 3 hours. The mixture was cooled, concentrated under reduced pressure, and the residue was extracted with toluene and filtered through Celite to remove a dark solid from the dark red-brown solution. The filtrate was heated with chlorotrimethylsilane (0.59 mL, 4.65 mmol) in a sealed flask under static vacuum overnight. Volatiles were removed under reduced pressure. The residue was stirred with hot heptane (20 mL) and the resulting slurry was cooled in the glovebox freezer. The cold mixture was decanted and the resulting solid was isolated and dried under reduced pressure to afford a dark green powder (768 mg, 49% yield). ¹H NMR (400 MHZ, toluene-d₈) δ 7.88 (d, 1H, ArH), 7.73 (d, 1H, ArH), 7.45 (m, 1H, ArH), 7.31 (m, 1H, ArH), 7.24 (m, 1H, ArH), 7.19 (m, 1H, ArH), 6.81 (d, 1H, ArH), 6.44 (s, 1H, ArH), 3.59 (s, 3H, NCH₃), 2.46 (s, 3H, ArCH₃), 2.11 (s, 3H, ArCH₃), 1.76 (m, 12H, AdH+ArCH₃), 1.54 (m, 3H, AdH), 1.40-0.83 (m, 10H, SiEt₂).

### Example 10

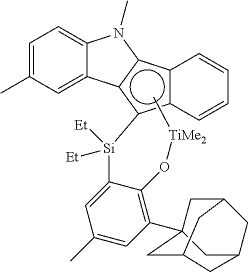

### Example 10

Example 9 (768 mg, 1.135 mmol) was dissolved in toluene (30 mL) in a 100-mL Schlenk flask and MeMgBr solution (3.0 M in diethyl ether, 0.83 mL, 2.50 mmol) was added. No initial colour change was observed. The mixture was stirred overnight affording a dark greenish-brown suspension. The volatiles were removed under reduced pressure and the residue was extracted with heptane, filtered through Celite to remove a dark solid from the dull orange-green filtrate, and the filtrate was concentrated under reduced pressure to afford a dark green-black solid. Trituration with pentane afforded the desired product as a red-brown powder (533 mg, 0.838 mmol, 74%). ¹H NMR (400 MHz, toluene-d₈) δ 7.86 (d, 1H, ArH), 7.74 (d, 1H, ArH), 7.39 (m, 1H, ArH), 7.23-7.11 (m, 3H, ArH), 6.94 (d, 1H, ArH), 6.78 (d, 1H, ArH), 6.57 (s, 1H, ArH), 3.54 (s, 3H, NCH₃), 2.45 (s, 3H, ArCH₃), 2.15-2.09 (m, 6H, ArCH₃+AdH), 2.00-1.86 (m, 6H, AdH), 1.79-1.59 (m, 6H, AdH), 1.30-1.01 (m, 10H, SiEt₂), 0.20 (s, 3H, TiCH₃), 0.01 (s, 3H, TiCH₃).

### Example 11

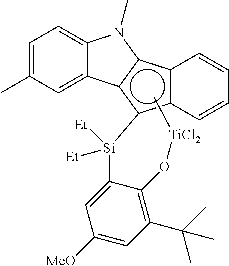

### 2-Bromo-6-(tert-butyl)-4-methoxyphenol

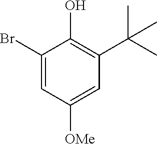

2-(tert-Butyl)-4-methoxyphenol (1.80 g, 10 mmol) was dissolved in CH₂Cl₂ (100 mL) in a 250-mL round-bottomed flask, affording a clear, colorless solution. The solution was immersed in an ice-water bath for 15 minutes. On vigorous stirring, a slurry of N-bromosuccinimide (1.87 g, 10.5 mmol) in CH₂Cl₂ (˜50 mL) was added dropwise to control the Br₂ concentration. Once the entirety of the NBS was added (with CH₂Cl₂ rinses), the pale-yellow solution was allowed to warm to ambient temperature. After 2 hours, the reaction mixture was rinsed with saturated aqueous Na₂S₂O₃ (50 mL), water (3×50 mL), brine (50 mL), and dried over anhydrous sodium sulfate. The dried organic phase was filtered. The clear pale-yellow filtrate was concentrated under reduced pressure affording the product as a thick amber oil (2.23 g, 8.59 mmol, 86% yield, ˜95% pure by NMR). ¹H NMR (400 MHz, CDCl₃) δ 6.91 (m, 2H, ArH), 5.51 (s, 1H, ArOH), 3.77 (s, 3H, ArOMe), 1.43 (s, 9H, t-Bu).

### 2-(Allyloxy)-1-bromo-3-(tert-butyl)-5-methoxybenzene

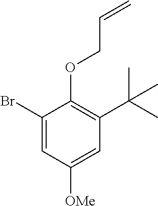 [SMILES: C=CCOc1c(Br)cc(OC)cc1C(C)(C)C]

NaH (144 mg, 6.0 mmol) was slurried in THF (50 mL) in a Schlenk flask. On vigorous stirring, 2-bromo-6-(tert-butyl)-4-methoxyphenol (1.04 g, 4.0 mmol) was added as a solution in THF (5 mL), dropwise, resulting in effervescence and a dark yellow-green suspension. The reaction mixture was stirred for 1 hour after which allyl bromide (0.52 mL, 6 mmol) was added via a syringe. The dark yellow-green reaction mixture was stirred for 3 days. The reaction mixture was concentrated under reduced pressure, slurried in pentane (50 mL), neutralized by the dropwise addition of saturated aqueous NH₄Cl (50 mL), and the organic layer rinsed with brine (10 mL) and dried over anhydrous Na₂SO₄. The dried extract was filtered and concentrated under reduced pressure to an amber oil (787 mg, 2.63 mmol, 66% yield). ¹H NMR (400 MHZ, CDCl₃) δ 6.96 (d, 1H, ArH), 6.86 (d, 1H, ArH), 6.13 (m, 1H, allyl-H), 5.49 (dq, 1H, allyl-H), 5.30 (dq, 1H, allyl-H), 4.55 (dt, 2H, allyl-H), 3.76 (s, 3H, OMe), 1.38 (s, 9H, t-Bu).

### (2-(Allyloxy)-3-(tert-butyl)-5-methoxyphenyl) chlorodiethylsilane

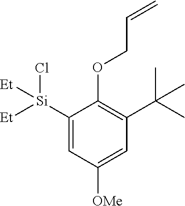 [SMILES: C=CCOc1c(C(C)(C)C)cc(OC)cc1[Si](Cl)(CC)CC]

2-(Allyloxy)-1-bromo-3-(tert-butyl)-5-methoxybenzene (5.39 g, 18 mmol) was diluted with Et₂O (50 mL) in a Schlenk flask. The flask was cooled to −78° C. for 15 minutes, after which n-BuLi solution (1.6 M in hexanes, 11.8 mL, 18.9) was added resulting initially in a dark green coloration and subsequently a yellow suspension as addition is complete. The reaction mixture was stirred for 1 hour, after which Et₂SiCl₂ (7.07 g, 45 mmol) was added, resulting in a dull yellow suspension. This was allowed to stir and warm to ambient temperature over 2 hours. Volatiles were removed under reduced pressure. The yellow residue was extracted with pentane and filtered through a Celite to remove a white solid from the clear yellow filtrate. The filtrate was evaporated to afford the product as a thick amber oil (5.77 g, 16.92 mmol, 94% yield). ¹H NMR (400 MHZ, toluene-d₈) δ 7.23 (d, 1H, ArH), 7.06 (d, 1H, ArH), 5.79 (m, 1H, allyl-H), 5.47 (dq, 1H, allyl-H), 5.11 (dq, 1H, allyl-H), 4.26 (m, 2H, allyl-H), 3.43 (s, 3H, OMe), 1.35 (s, 9H, t-Bu), 1.20-0.98 (m, 10H, SiEt₂).

### 10-((2-(Allyloxy)-3-(tert-butyl)-5-methoxyphenyl) diethylsilyl)-5,8-dimethyl-5,10-dihydroindeno[1,2-b]indole

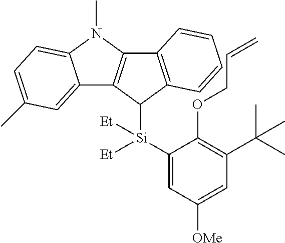 [SMILES: C=CCOc1c(C(C)(C)C)cc(OC)cc1[Si](CC)(CC)C1c2ccccc2-c2c1c1cc(C)ccc1n2C]

5,8-Dimethyl-5,10-dihydroindeno[1,2-b]indole (5.87 g, 25.17 mmol) was dissolved in THF (100 mL). n-BuLi solution (1.6 M in hexanes, 16.5 mL, 26.43 mmol) was added and the dark red mixture was stirred for 1 hour. (2-(Allyloxy)-3-(tert-butyl)-5-methoxyphenyl) chlorodiethylsilane (8.58 g, 25.17 mmol) was added affording an orange-brown suspension. Volatiles were evaporated after 1.5 hours. The residue was triturated with pentane and evaporated once again. The material was extracted with toluene and filtered through Celite to afford a dark amber filtrate. After concentrating the filtrate under reduced pressure, the residue was dispersed in heptane and then concentrated again to a yellow cake. Recrystallization from hot heptane afforded the pure product as a pale-yellow powder (4.80 g, 8.92 mmol, 35% recrystallized yield). ¹H NMR (400 MHZ, toluene-d₈) δ 7.51 (d, 1H, ArH), 7.46 (d, 1H, ArH), 7.22 (t, 1H, ArH), 7.12 (m, 1H, ArH), 7.09 (td, 1H, ArH), 7.02 (m, 2H, ArH), 6.91 (s, 1H, ArH), 6.64 (d, 1H, ArH), 5.78 (m, 1H, allyl-H), 5.56 (dq, 1H, allyl-H), 5.15 (dq, 1H, allyl-H), 4.40 (s, 1H, SiCH), 4.23 (m, 2H, allyl-H), 3.38 (s, 3H, OMe), 3.29 (s, 3H, NMe). 2.44 (s, 3H, ArMe), 1.42 (s, 9H, t-Bu), 1.22-0.70 (m, 10H, SiEt₂).

### Example 11

10-((2-(Allyloxy)-3-(tert-butyl)-5-methoxyphenyl) diethylsilyl)-5,8-dimethyl-5,10-dihydroindeno[1,2-b]indole (965 mg, 1.79 mmol) was dissolved in toluene (30 mL) to a yellow solution. NEt₃ (1.13 mL, 8.07 mmol) was added via a syringe, resulting in no observable change. n-BuLi solution (1.6 M in hexanes, 2.52 mL, 4.04 mmol) was added via syringe resulting in initial darkening of the solution to a yellow-orange color followed by formation of a precipitate. The bright yellow suspension was stirred for 1 hour. Ti(NMe₂)₂Cl₂ (445 mg, 2.15 mmol) was dissolved in toluene to a red-brown solution and added to the yellow reaction mixture resulting in a dark brown suspension. This was heated to 90° C. for 3 hours after which chlorotrimethylsilane (0.57 mL, 4.49 mmol) was added and the reaction mixture was kept at 80° C. overnight. Volatiles were removed under reduced pressure. The brown residue was dispersed with hot heptane and the solution was concentrated again. The residue was then extracted with toluene and filtered through Celite to remove a dark solid from the brown filtrate. The filtrate was concentrated under reduced pressure. The residue was slurried in minimal hot heptane at 90° C. for 15 minutes after which the slurry was chilled to −35° C. for 2 hours. The solids were collected on a medium porosity frit, rinsed with minimal pentane, and dried under reduced pressure to afford the product as a dark red-brown solid (874 mg, 1.42 mmol, 79% recrystallized yield). ¹H NMR (400 MHZ, toluene-d₈) δ 7.90 (d, 1H, ArH), 7.76 (d, 1H, ArH), 7.32 (t, 1H, ArH), 7.22 (m, 2H, ArH), 7.08 (d, 1H, ArH), 7.00 (m, 1H, ArH), 6.80 (d, 1H, ArH), 6.50 (s, 1H, ArH), 3.60 (s, 3H, OMe), 3.59 (s, 3H, NMe), 2.12 (m, 3H, ArMe), 1.64-1.05 (m, 10H, SiEt₂), 1.04 (s, 9H, t-Bu).

### Example 12

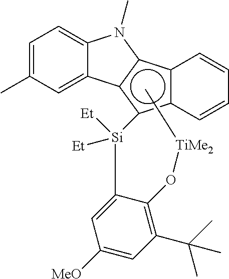

Example 11 (1.82 g, 2.96 mmol) was dissolved in toluene (80 mL) to give a dark brown solution. On vigorous stirring. MeMgBr solution (3.0 M in Et₂O, 2.17 mL, 6.52 mmol) was added via syringe resulting in an instant orange-brown coloration. This was stirred for 30 minutes after which the reaction mixture was evaporated under reduced pressure. The residue was extracted with toluene, filtered through Celite and concentrated once again. The residue was slurried in heptane and evaporated once again, affording the product as an orange powder (1.47 g, 2.65 mmol, 87% yield). ¹H NMR (400 MHZ, toluene-d₈) δ 7.87 (m, 1H, ArH), 7.73 (m, 1H, ArH), 7.22-7.10 (m, 4H, ArH), 6.94 (d, 1H, ArH), 6.76 (d, 1H, ArH), 6.55 (s, 1H, ArH), 3.62 (s, 3H, OMe), 3.52 (s, 3H, NMe), 2.09 (s, 3H, ArMe), 12.5 (s, 9H, t-Bu), 1.24-1.00 (m, 10H, SiEt₂), 0.17 (s, 3H, TiMe), −0.03 (s, 3H, TiMe₂).

### Example 13

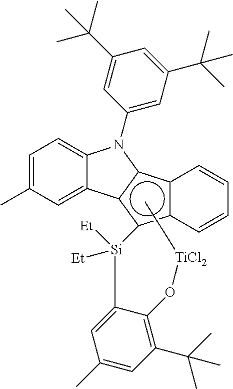

### 3,5-di-tert-Butyliodobenzene

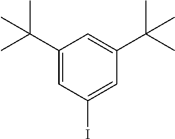

To a THF solution (50 mL) of 1-bromo-3,5-di-tert-butylbenzene (5.39 g, 20 mmol) at 78° C. was added a solution of n-BuLi (1.6 M in hexanes, 13.12 mL, 21 mmol) dropwise via cannula over 10 minutes. A white precipitate formed, and the reaction mixture was stirred vigorously at −78° C. for 1 hour. To the resulting slurry at −78° C. was added a THF solution (50 mL) of iodine (5.33 g, 20 mmol) slowly over 20 minutes. Near the end of the addition, the color of iodine persisted. The cold bath was removed, and the solution was stirred at ambient temperature overnight. Volatiles were removed under reduced pressure then distilled water (˜50 mL) was added to the flask. Saturated aqueous Na₂S₂O₃ (50 mL) was dropwise added to the flask until the color of iodine disappeared. The combined aqueous mixture was extracted with diethyl ether, the organic layer dried over anhydrous MgSO₄, filtered, and then concentrated under reduced pressure. The crude product was dissolved in pentane and passed through a column of activated neutral alumina with flushing with addition portions of pentane. The pentane solution was evaporated to dryness to give a colourless crystalline solid (6.124 g). ¹H NMR (400 MHZ, CDCl₃) δ 7.49 (s, 1H, ArH), 7.28 (s, 2H, ArH), 1.56 (s, 18H, tBu).

### 5-(3,5-di-tert-Butylphenyl)-8-methyl-5,10-dihydroindeno[1,2-b]indole

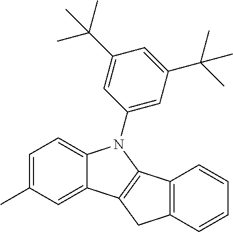 [SMILES: Cc1ccc2c(c1)c1c(n2-c2cc(C(C)(C)C)cc(C(C)(C)C)c2)-c2ccccc2C1]

3,5-di-tert-Butyliodobenzene (2.0 g, 6.32 mmol), 8-Methyl-5,10-dihydroindeno[1,2-b]indole (1.39 g, 6.32 mmol), potassium phosphate (4.0 g, 18.96 mmol, copper (I) iodide (1.58 g, 1.58 mmol), N,N′-dimethylethylenediamine (500 mg), and toluene (50 mL) were charged into a thick-walled long Kontes flask in a glove box. The flask was sealed and the stirred mixture was heated at 130° C. for 48 hours. After the reaction was cooled to ambient temperature, the product mixture was filtered, and the filter cake was rinsed with toluene (3×10 mL). The combined filtrates were washed with saturated aqueous ammonium chloride solution (50 mL) then dried over anhydrous MgSO₄, filtered, and concentrated under reduced pressure. The solid was redissolved in diethyl ether and the solution was passed through a column of activated neutral alumina and washed with additional diethyl ether. The diethyl ether solution was concentrated under reduced pressure down to about 20 mL whereupon the product began to crystallize. After cooling the mixture to −20° C. overnight a crystalline solid was isolated by decantation and dried under reduced pressure to yield 1.68 g of material. The mother liquor was evaporated to dryness to give an additional 120 mg of pure product. The combined yield was 1.80 g (70%). ¹H NMR (400 MHZ, CD₂Cl₂) δ: 7.55-7.51 (m, 2H, ArH), 7.48-7.45 (m, 1H, ArH), 7.41 (d, J=2 Hz, 2H, ArH), 7.30 (d, J=8.4 Hz, 1H, ArH), 7.19-7.14 (m, 2H, ArH), 7.19-7.09 (m, 1H, ArH), 7.00 (dd, J=8.5 Hz, J=2 Hz, 1H, ArH), 3.78 (s, 2H, indeno-H), 2.47 (s, 3H, ArCH₃), 1.40 (s, 18H, tBu).

### 10-((2-(Allyloxy)-3-(tert-butyl)-5-methylphenyl) diethylsilyl)-5-(3,5-di-tert-butylphenyl)-8-methyl-5,10-dihydroindeno[1,2-b]indole

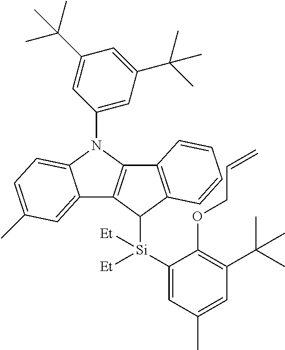 [SMILES: C=CCOc1c(C(C)(C)C)cc(C)cc1[Si](CC)(CC)C1c2ccccc2-c2c1c1cc(C)ccc1n2-c1cc(C(C)(C)C)cc(C(C)(C)C)c1]

To a THF solution (30 mL) of 5-(3,5-di-tert-butylphenyl)-8-methyl-5,10-dihydroindeno[1,2-b]indole (1.32 g, 3.24 mol) at −35° C. was added n-BuLi solution (1.6 M in hexanes, 2.10 mL, 3.36 mmol). The color of the solution turned to bright orange-red. The solution was stirred at ambient temperature for 3 hours and then a THF solution (5 mL) of (2-(Allyloxy)-3-(tert-butyl)-5-methylphenyl) chlorodiethylsilane (1.052 g, 3.24 mmol) was added. The mixture was stirred at ambient temperature overnight and further stirred at 60° C. for 6 hours. The reaction mixture was concentrated under reduced pressure and the residue was re-dissolved into pentane (40 mL) and passed through a column of activated neutral alumina while rinsing with further portions of pentane. The combined pentane eluent was reduced in volume to ˜5 mL and the solution was cooled to −35° C. overnight. A colourless solid was isolated by filtration, washed with cold pentane, and then dried under reduced pressure to yield 1.67 g of material (74%). ¹H NMR (400 MHz, CD₂Cl₂) δ: 7.50 (t, J=2 Hz, 1H, ArH), 7.40-7.35 (m, 1H, ArH), 7.33 (d, J=2 Hz, 2H, ArH), 7.25 (d, J=8 Hz, 1H, ArH), 7.12-7.04 (m, 2H, ArH), 6.94-6.87 (m, 2H, ArH), 6.45 (s, 1H, ArH), 6.08-6.97 (m, 1H, allylH), 5.55 (dq, 1H, allylH), 5.28 (dq, 1H, allylH), 4.48 (s, 1H), 4.29 (qm, 2H, allylH), 2.29 (s, 3H, ArCH₃), 2.22 (s, 3H, ArCH₃), 1.42 (s, 9H, tBu), 1.38 (s, 18H, tBu), 1.34-0.50 (m, 10H, SiEt₂).

### Example 13

10-((2-(Allyloxy)-3-(tert-butyl)-5-methylphenyl) diethylsilyl)-5-(3,5-di-tert-butylphenyl)-8-methyl-5,10-dihydroindeno[1,2-b]indole (0.81 g, 1.16 mmol) and triethylamine (0.6 g, >4.5× excess) were dissolved in toluene (30 mL) and the resulting solution was cooled to −35° C. for 0.5 hours. A solution of n-BuLi (1.6 M in hexanes, 2.52 mL, 2.41 mmol) was added to the solution with stirring and the mixture was allowed to warm to ambient temperature and stirred for 2.5 hours. The reaction mixture was cooled back to −35° C., and then solid Ti(NMe₂)₂Cl₂ (240 mg, 1.16 mmol) was added followed by small amounts of toluene to ensure quantitative addition. The reaction mixture was stirred at ambient temperature overnight and then heated at 90° C. for a further 3 hours. The red orange solution was filtered and the filtrate was collected into a separate flask. Chlorotrimethylsilane (350 mg) was added and the sealed flask was heated at 80° C. overnight. Volatiles were removed under reduced pressure and the residue was taken up into pentane (30 mL). A green-brown solid began to crystallize, and the flask was cooled to −35° C. for 4 hours. The precipitate was isolated by filtration and the collected solid was washed with portions of cold (−35° C.) pentane. The solid was collected and dried under reduced pressure to give the product as a green-brown solid (0.574 g, 64%). ¹H NMR (400 MHZ, CD₂Cl₂) δ: 8.14 (br. s, 1H, ArH), 7.93 (d, J=8.7 Hz, 1H, ArH), 7.67 (d, J=8 Hz, 1H, ArH), 7.60 (s, 1H, ArH), 7.55 (t, J=7.7 Hz, 1H, ArH), 7.50-7.40 (m, 2H, ArH), 7.30 (s, 1H, ArH), 7.24 (s, 1H, ArH), 7.22 (s, 1H, ArH), 7.12 (d, 1H, ArH), 6.34 (s, 1H, ArH), 2.53 (s, 3H, ArCH₃), 2.08 (s, 3H, ArCH₃), 1.41 (br.s, 18H, tBu), 1.35-1.01 (m, 10H, SiEt₂), 0.79 (s, 9H, tBu).

### Example 14

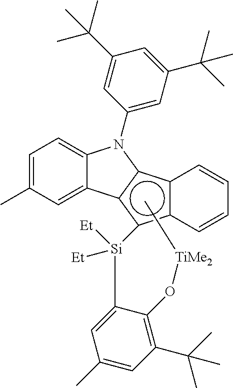

### Example 14

Example 13 (0.574 g, 0.743 mol) was dissolved in toluene (30 mL) and MeMgBr solution (3.0 M in diethyl ether, 0.75 ml, 2.25 mmol) was added. The mixture was stirred overnight and then evaporated to dryness under reduced pressure. The residue was taken up into pentane, filtered, and the filtrate was evaporated to dryness to yield an orange solid. The solid was dissolved in pentane again and the solution was filtered to remove very small amount of solid. The filtrate was evaporated to dryness to give a pure orange crystalline solid (489 mg, 90%). ¹H NMR (400 MHZ, toluene-d₈) δ 7.83 (d, J=8.5 Hz, 1H, ArH), 7.78 (d, J=8.5 Hz, 1H, ArH), 7.75-7.61 (br.s, 1H, ArH), 7.59 (m, 1H, ArH), 7.44 (m, 1H, ArH), 7.40 (d, J=8.5 Hz, 1H, ArH), 7.32 (s, 1H, ArH), 7.13-7.06 (m, 1H, ArH), 6.96-7.03 (m, 1H, ArH), 6.91 (d, J=8 Hz, 1H, ArH), 6.76 (s, 1H, ArH), 2.43 (s, 3H, ArCH₃), 2.09 (s, 3H, ArCH₃), 1.37 (s, 9H, tBu), 1.30 (s, 18H, tBu), 1.28-1.04 (m, 10H, SiEt₂), 0.37 (s, 3H, TiMe), 0.24 (s, 3H, TiMe).

### Example 15

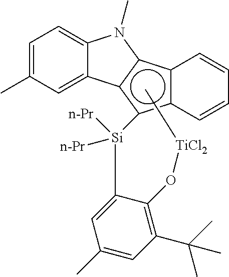

### Dichlorodipropylsilane

Crushed magnesium turnings (1.58 g, 65 mmol) were weighed into a 250 mL flask in the glovebox and THF (5 mL) was added. A small portion of 1-bromopropane (˜0.5 mL from a total of 5.534 g, 45 mmol) was added dropwise with stirring and a reaction initiated within several minutes. The reaction mixture was diluted further with additional THF while continually adding the remainder of the 1-bromopropane to maintain a gentle reflux over a period of approximately 1 hour. After stirring for an additional 1 hour, the flask was sealed with a septum and stirred overnight. The resulting mixture was filtered, and the excess magnesium turnings were washed with small portions of THF. The combined filtrate was added dropwise to a THF solution (100 mL) of silicon tetrachloride (3.822 g, 22.5 mmol) at −78° C. over a period of 1 hour. The resulting slurry was stirred overnight while allowing the cold bath (CO₂/EtOH) to warm slowly to ambient temperature. The reaction mixture was heated to 45° C. for 1 hour and then the volatiles were removed under reduced pressure. The residue was taken up into pentane, 1,4-dioxane (˜1.5 mL) was added, and the resulting mixture was stirred for 1 hour to precipitate residual magnesium halide salts. The mixture was filtered, and the resulting solution was carefully concentrated under reduced pressure and then fractionally distilled under static vacuum (head temperature: 32° C., bath temperature: 45-50° C.) to give the product as a clear oil (3.1 g, 74%). ¹H NMR (400 MHZ, toluene-d₈) δ 1.43-1.30 (m, 2H), 0.83 (t, J=7 Hz, 3H), 0.79-0.73 (m, 2H).

### (2-(Allyloxy)-3-(tert-butyl)-5-methylphenyl)chlorodipropylsilane

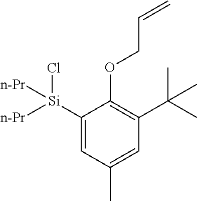

To a solution of 2-(allyloxy)-1-bromo-3-(tert-butyl)-5-methylbenzene (1.415 g, 5 mmol) in Et₂O (40 mL) cooled to −78° C. was added a solution of n-BuLi (1.6 M in hexanes, 3.27 mL, 5.2 mmol) dropwise via cannula over 5 minutes. After several minutes, the reaction solution became turbid, and a white slurry formed. The mixture was stirred for 2 hours at −78° C., and then a solution of dichlorodipropylsilane (2.31 g, 12.5 mmol) in Et₂O (5 mL) was added dropwise over 5 minutes while maintaining the temperature at −78° C. The reaction was stirred overnight while allowing the cold bath (CO₂/EtOH) to warm slowly to ambient temperature. Volatiles were removed under reduced pressure and the residue was taken up into pentane. The mixture was filtered through a pad of Celite, and the filtrate was concentrated to give the product as a pale orange oil (1.79 g, ˜100%). ¹H NMR (400 MHZ, toluene-d₈) δ 7.53 (dd, J=2 Hz and 1 Hz, 1H), 7.22 (dd, J=2 Hz and 1 Hz, 1H), 5.87-5.76 (m, 1H), 5.50 (dq, 1H), 5.29 (dq, 1H), 4.30 (m, 2H), 2.166 (s, 3H), 1.60-1.48 (m, 4H), 1.387 (s, 9H), 1.25-1.10 (m, 4H), 0.97 (t, 6H).

### 10-((2-(Allyloxy)-3-(tert-butyl)-5-methylphenyl)dipropylsilyl)-5,8-dimethyl-5,10-dihydroindeno[1,2-b]indole

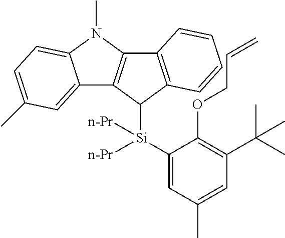

To a THF solution (35 mL) of 5,8-dimethyl-5,10-dihydroindeno[1,2-b]indole (1.157 g. 4.96 mmol) cooled to −35° C. was added a solution of n-BuLi (1.6 M in hexanes, 3.10 mL, 4.96 mmol) in hexane. The resulting solution was stirred for 1 hour while allowing to warm to ambient temperature. A THF solution (10 mL) of (2-(Allyloxy)-3-(tert-butyl)-5-methylphenyl) chlorodipropylsilane (1.75 g, 4.96 mmol) was added dropwise over several minutes and the reaction mixture was stirred overnight. The resulting light brown mixture was heated to 55° C. for 1 hour and then the volatiles were removed under reduced pressure. The residue was taken up into pentane (˜30 mL) and then passed through a plug of calcined neutral alumina (calcined at 500° C. overnight and stored under inert atmosphere) which was then rinsed with additional 15-20 mL of pentane. The pentane solution was concentrated to a volume of approximately 5-6 mL whereupon a yellow solid began to crystallize. After cooling to −35° C. overnight, the solid material was isolated by filtration, rinsed with a small portion of cold pentane, and then dried under vacuum to yield the product as a yellow crystalline solid (1.85 g, 67% yield). ¹H NMR (400 MHZ, toluene-d₈) δ 7.52 (d, J=7 Hz, 1H), 7.47 (d, J=7 Hz, 1H), 7.30 (d. J=2 Hz, 1H), 7.22 (t, J=7 Hz, 1H), 7.09 (td, J=7 Hz and 1 Hz, 1H), 7.06 (d, J=2 Hz, 1H), 7.00 (d, J=1 Hz, 2H), 6.71 (s, 1H), 5.87-5.76 (m, 1H). 5.55 (dq, 1H), 5.15 (dq, 1H), 4.45 (s, 1H), 4.30 (qq, 2H), 3.42 (s, 3H), 2.41 (s, 3H), 2.17 (s, 3H), 1.47 (s. 9H), 1.35-1.13 (m, 6H), 1.05-0.85 (m, 8H).

### Example 15

10-((2-(Allyloxy)-3-(tert-butyl)-5-methylphenyl) dipropylsilyl)-5,8-dimethyl-5,10-dihydroindeno[1,2-b]indole (1.850 g, 3.364 mmol), triethylamine (2.12 mL, 1.53 g, 15.1 mmol), and toluene (30 mL) were combined into a 200 mL Kontes flask. A solution of n-BuLi (1.6 M in hexanes, 4.33 mL, 6.93 mmol) was added dropwise with stirring at ambient temperature. The resulting orange solution was stirred for 2 hours after which time a slurry had formed. To this slurry, a toluene solution (˜50 mL) of Ti(NMe₂)₂Cl₂ (0.696 g, 3.364 mmol) was added. The mixture was stirred overnight at 60° C., and then at 90° C. for an additionally 3 hours. The dark orange solution was filtered through a pad of Celite and to the filtrate was added chlorotrimethylsilane (2.60 g, 23.9 mmol). After briefly evacuating the headspace of the mixture, the flask was sealed, and the reaction was stirred overnight at 80° C. The resulting green-brown solution was evaporated to dryness under reduced pressure and the solid was washed with several portions of pentane. The solid was dried under vacuum to give the product as a green-brown solid (1.53 g. 72%). ¹H NMR (400 MHZ, toluene-d₈) δ 7.97 (d, J=8 Hz, 1H), 7.77 (d, J=8 Hz, 1H), 7.51 (s, 1H), 7.33-7.27 (m, 2H), 6.99 (d, J=7 Hz, 1H), 7.01 (d, J=7 Hz, 1H), 6.79 (d, J=7 Hz, 1H), 6.46 (s, 1H), 3.60 (s, 3H), 2.41 (s, 3H), 2.07 (t, 3H), 1.75-1.18 (m, 8H), 0.96 (t, J=7 Hz, 3H), 0.87 (t, J=7 Hz, 3H).

### Example 16

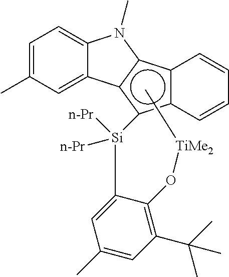

### Example 16

To a solution of Example 15 (1.534 g, 2.38 mmol) in toluene (25 mL) at ambient temperature was added a solution of MeMgBr (3.0 M in Et₂O, 4.0 mL, 12 mmol). The resulting mixture was stirred overnight and then concentrated under reduced pressure. The residue was slurried into pentane (60 mL), stirred for 2 hours, filtered, and the solid cake was washed with further portions of pentane (5×10 mL). The combined filtrate was reduced in volume down to ˜10 mL under reduced pressure and a bright orange crystalline solid was deposited, isolated by decantation, washed with cold pentane, and dried under vacuum. The mother liquor was concentrated under reduced pressure and put in a freezer at −35° C. overnight in the glove box whereupon a second crop of solid was deposited, isolated, washed with cold pentane, and dried under vacuum. Analysis of both crops of material by ¹H NMR showed >95% purity. The combined product was isolated as a bright orange solid (0.90 g, 63%). ¹H NMR (400 MHZ, toluene-d₈) δ 7.88 (dd, J=7 Hz and 1 Hz, 1H), 7.83 (dd, J=7 Hz and 1 Hz, 1H), 7.46 (d, J=2 Hz, 1H), 7.29 (d, J=2 Hz, 1H), 7.21-7.12 (m, 2H), 6.95 (d, J=8 Hz, 1H), 6.77 (d. J=8 Hz, 1H), 6.54 (s, 1H), 3.54 (s, 3H), 2.43 (s, 3H), 2.08 (s, 3H), 1.68-1.42 (m, 4H), 1.40-1.29 (m, 4H), 1.28 (s, 9H), 0.94 (t, J=7 Hz, 3H), 0.92 (t, J=7 Hz, 3H), 0.22 (s, 3H), 0.002 (s, 3H).

### Example 17

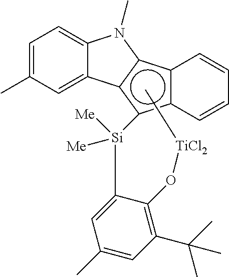

### (2-(Allyloxy)-3-(tert-butyl)-5-methylphenyl) chlorodimethylsilane

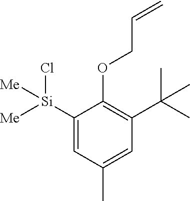 [SMILES: C=CCOc1c(C(C)(C)C)cc(C)cc1[Si](C)(C)Cl]

This material was prepared substantially as described by Senda, T. et al. in Macromolecules 2009, 42, 8006-8009. 2-(Allyloxy)-1-bromo-3-(tert-butyl)-5-methylbenzene (17.706 g, 60 mmol) was dissolved in diethyl ether (400 mL) in a 2 L, 2-neck round bottom flask equipped with a nitrogen inlet and a rubber septum. The flask was cooled to −78° C., and n-BuLi solution (1.6 M in hexanes, 40 mL, 64 mmol) was slowly added via cannula. The reaction mixture was stirred for 2 hours at −78° C., during which a fine white solid precipitated. Using a syringe, Me₂SiCl₂ (25.7 g, 180 mmol) was added rapidly. The reaction mixture was allowed to warm to ambient temperature overnight. Volatiles were removed under reduced pressure and the oily residue was extracted with pentane and filtered through Celite to afford a clear colorless filtrate. Volatiles were removed to afford the desired product as a waxy crystalline solid (17.71 g, 99% yield). ¹H NMR (400 MHZ, toluene-d₈) δ 7.40 (d, 1H, ArH), 7.22 (d, 1H, ArH), 5.80 (m, 1H, O-allyl), 5.48 (dq, 1H, O-allyl), 5.11 (dq, 1H, O-allyl), 4.34 (m, 2H, O-allyl), 2.14 (s, 3H, ArCH₃), 1.38 (s, 9H, Ar-t-Bu), 0.66 (s, 6H, SiMe₂).

### 10-((2-(Allyloxy)-3-(tert-butyl)-5-methylphenyl) dimethylsilyl)-5,8-dimethyl-5,10-dihydroindeno[1,2-b]indole

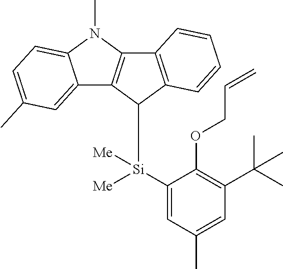 [SMILES: C=CCOc1c(C(C)(C)C)cc(C)cc1[Si](C)(C)C1c2ccccc2-c2c1c1cc(C)ccc1n2C]

5,8-Dimethyl-5,10-dihydroindeno[1,2-b]indole (2.510 g, 10.76 mmol) was dissolved in THF (60 mL) in a 100-mL Schlenk flask. With vigorous stirring n-BuLi solution (1.6 M in hexanes, 7.0 mL, 11 mmol) was added and the dark red reaction mixture was stirred for 1 hour. A slow effervescence (butane) was observed initially but subsided over time. After 4 hours, the solution was cooled to −78° C., and a solution of (2-(allyloxy)-3-(tert-butyl)-5-methylphenyl) chlorodimethylsilane (3.401 g, 11.45 mmol) in toluene (50 mL) was added resulting in a dark orange-red solution. The reaction mixture was allowed to warm overnight and then the volatiles were removed under reduced pressure which resulted in a sticky brown oil. The crude material was dissolved in toluene and passed through a plug of Celite. Volatiles were removed under reduced pressure and the solid was dissolved in hot heptane. Upon cooling, a yellow crystalline solid precipitated, then collected on a sintered glass funnel, and dried under reduced pressure (3.727 g. 67% yield). ¹H NMR (400 MHZ, CDCl₃) δ 7.71 (d, 1H, ArH), 7.36 (d, 1H, ArH), 7.30 (m, 1H, ArH), 7.30 (t, 1H, ArH), 7.10 (dt, 1H, ArH) 7.05 (d, 1H, ArH), 6.98 (dd, 1H, ArH), 6.46 (s, 1H, ArH) 6.08 (m, 1H, allyl-H), 5.58 (dq, 1H, allyl-H), 5.32 (dq, 1H, allyl-H), 4.45 (qd, 1H, allyl-H), 4.34 (s, 1H, Si—CH), 4.06 (s, 3H, NCH₃), 2.33 (s, 3H, ArCH₃), 2.31 (s, 3H, ArCH₃), 1.49 (s, 9H, t-Bu), 0.13 (s, 3H, SiMe), 0.02 (s, 3H, SiMe).

### Example 17

10-((2-(Allyloxy)-3-(tert-butyl)-5-methylphenyl) dimethylsilyl)-5,8-dimethyl-5,10-dihydroindeno[1,2-b]indole (3.727 g, 7.14 mmol) was dissolved in toluene (60 mL) in a 100-mL Schlenk flask, and cooled to −78° C. for 15 minutes. Triethylamine (3.2 mL, 2.3 g, 23 mmol) and n-BuLi solution (1.6 M in hexanes, 9.2 mL, 14.7 mmol) were added successively. The pale-yellow solution was allowed to warm to ambient temperature and stir for 2 hours, after which the reaction mixture was cooled once again to −78° C. for 15 minutes. Ti(NMe₂)₂Cl₂ (1.700 g, 8.21 mmol) was added as a slurry in toluene, and the reaction mixture was warmed to ambient temperature over 30 minutes followed by heating to 90° C. for 30 minutes to give a dark red-brown slurry. The mixture was cooled to 80° C., and chlorotrimethylsilane (2.3 mL, 2.0 g, 18 mmol) was added via syringe and the mixture was heated to 80° C. overnight. Approximately one fifths of the volatiles were removed under reduced pressure and the mixture was filtered through a pad of Celite. Volatiles from the filtrate were removed under reduced pressure and the residue recrystallized from hot heptane to yield a small crop of pure product. Further pure product was obtained by washing the filter cake further with portions of hot toluene (total ˜500 mL) and then dichloromethane (60 mL) followed by combining the filtrates, concentrating under reduced pressure, recrystallizing/triturating the resulting solid with hot heptane, isolating the solid by filtration, and then drying under reduced pressure to give the pure product as a green crystalline solid (total 1.57 g, 37% recrystallized yield). ¹H NMR (400 MHZ, toluene-d₈) δ 7.82 (d, 1H, ArH), 7.73 (d, 1H, ArH), 7.41 (d, 1H, ArH), 7.29-7.15 (m, 3H, ArH), 6.99 (d, 1H, ArH), 6.78 (d, 1H, ArH), 6.46 (s, 1H, ArH), 3.58 (s, 3H, NCH₃), 2.38 (s, 3H, ArCH₃), 2.05 (s, 3H, ArCH₃), 1.03 (s, 9H, t-Bu), 0.81 (s. 3H, SiMe), 0.65 (s, 3H, SiMe).

### Example 18

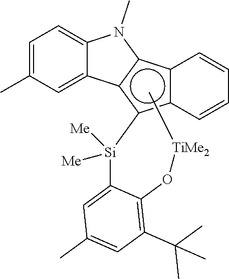

### Example 18

To a toluene solution (20 mL) of Example 17 (1.234 g, 2.16 mmol) was added a solution of MeMgBr (3.0 M in diethyl ether, 1.50 mL, 4.5 mmol) which immediately resulted in a bright orange solution. Volatiles were removed under reduced pressure and the residue was extracted with toluene and filtered through a pad of Celite. The bright orange filtrate was collected and concentrated under reduced pressure to give an amorphous orange residue. The residue was dissolved in pentane and concentrated under reduced pressure to afford the desired product as a bright orange powder (1.05 g, 92% yield). ¹H NMR (400 MHZ, toluene-d₈) δ 7.85 (d, 1H, ArH), 7.69 (d, 1H, ArH), 7.39 (s, 1H, ArH), 7.25 (s, 1H, ArH), 7.19-7.10 (m, 2H, ArH). 6.95 (d, 1H, ArH), 6.77 (d, 1H, ArH), 6.59 (s, 1H, ArH), 3.53 (s, 3H, NCH₃), 2.39 (s, 3H, ArCH₃), 2.07 (s, 3H, ArCH₃), 1.28 (s, 9H, t-Bu), 0.70 (s, 1H, SiMe), 0.63 (s, 1H, SiMe), 0.17 (s, 3H, TiCH₃), 0.01 (s, 3H, TiCH₃).

### Example 19

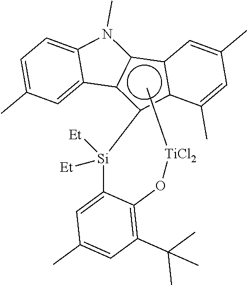

### 1,3,8-Trimethyl-5,10-dihydroindeno[1,2-b]indole

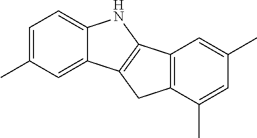

4,6-Dimethyl-2,3-dihydro-1H-inden-1-one (2.288 g, 14.28 mmol) was dissolved in isopropanol (200 mL) in a round-bottomed flask to a give clear yellow solution. Para-toluenesulfonic acid monohydrate (82 mg, 0.428 mmol) and p-tolylhydrazine hydrochloride (2.265 g, 14.28 mmol) were added, and a condenser was attached to the flask. The reaction mixture was heated to 85° C. for 2 h, then concentrated under reduced pressure and cooled to −33° C. The precipitate was collected on a sintered glass frit, rinsed with a minimal amount of cold isopropanol, and residual volatiles were removed under reduced pressure to afford the desired product as a white solid (1.82 g, 7.36 mmol, 52% recrystallized yield). ¹H NMR (400 MHZ, CDCl₃) δ 8.25 (br, 1H, NH), 7.43 (s, 1H, ArH), 7.36 (d, 1H, ArH), 7.21 (s, 1H, ArH), 7.00 (m, 1H, ArH), 6.95 (s, 1H, ArH), 3.67 (s, 2H, CH₂), 2.63 (s, 3H, ArMe), 2.49 (s, 3H, ArMe), 2.41 (s, 3H, ArMe).

### 1,3,5,8-Tetramethyl-5,10-dihydroindeno[1,2-b]indole

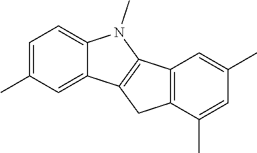

1,3,8-Trimethyl-5,10-dihydroindeno[1,2-b]indole (1.820 g, 7.358 mmol) was slurried in THF (100 mL) to a give a pale yellow turbid mixture. Sodium tert-butoxide (743 mg, 7.726 mmol) in THF (20 mL) was added, and the mixture was stirred for 1 hour. Iodomethane (0.48 mL, 7.726 mmol) was added dropwise via syringe, and the mixture was stirred overnight. Volatiles were removed from the yellow suspension under reduced pressure. The residue was dissolved in CH₂Cl₂ (100 mL) and washed with water (100 mL). The aqueous layer was extracted with additional CH₂Cl₂ (2× 50 mL) and the combined organic layer was rinsed with brine (50 mL), dried over anhydrous Na₂SO₄, filtered, and the clear yellow filtrate evaporated to dryness. Recrystallization from hot heptane afforded the desired product as a white solid (1.013 g, 3.876 mmol, 53% recrystallized yield). ¹H NMR (400 MHz, CDCl₃) δ 7.40 (s, 1H, ArH), 7.27 (d, 1H, ArH), 7.21 (s, 1H, ArH), 7.04 (d, 1H, ArH), 6.96 (s, 1H, ArH), 4.09 (s, 3H, NMe), 3.64 (s, 2H, CH₂), 2.77 (s, 3H, ArMe), 2.49 (s, 3H, ArMe), 2.39 (s, 3H, ArMe).

### 10-((2-(Allyloxy)-3-(tert-butyl)-5-methylphenyl) diethylsilyl)-1,2,5,8-tetramethyl-5,10-dihydroindeno[1,2-b]indole

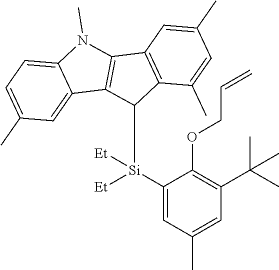 [SMILES: C=CCOc1c(C(C)(C)C)cc(C)cc1[Si](CC)(CC)C1c2c(C)cc(C)cc2-c2c1c1cc(C)ccc1n2C]

1,3,5,8-Tetramethyl-5,10-dihydroindeno[1,2-b]indole (1.013 g, 3.876 mmol) was dissolved in THF (50 mL). On vigorous stirring, n-BuLi (1.6 M in hexanes, 2.54 mL, 4.070 mmol) was added, resulting in a dark red solution. After 1 hour, (2-(allyloxy)-3-(tert-butyl)-5-methylphenyl) chlorodiethylsilane (1.260 g, 3.876 mmol) was added, and the mixture was stirred for 1 hour. Volatiles were removed under reduced pressure and the residue extracted with pentane and filtered through a pad of Celite. The clear amber yellow filtrate was evaporated to afford the desired product as a yellow sticky solid (1.942 g, 3.532 mmol). ¹H NMR (400 MHZ, toluene-d₈) δ 7.30 (d, 1H, ArH), 7.17 (s, 1H, ArH), 7.04 (m, 2H, ArH), 6.97 (d, 1H, ArH), 6.83 (m, 2H, ArH), 5.83 (m, 1H, allyl-H), 5.59 (dq, 1H, allyl-H), 5.16 (dq, 1H, allyl-H), 4.43 (s, SiCH), 4.32 (m, 2H, allyl-H), 3.51 (s, 3H, NMe), 2.51 (s, 3H, ArMe), 2.42 (s, 3H, ArMe), 2.31 (s, 3H, ArMe), 2.16 (s, 3H, ArMe), 1.48 (s, 9H, t-Bu), 1.16-0.68 (m, 10H, SiEt₂).

### Example 19

10-((2-(Allyloxy)-3-(tert-butyl)-5-methylphenyl) diethylsilyl)-1,3,5,8-tetramethyl-5,10-dihydroindeno[1,2-b]indole (1.942 g, 3.532 mmol) was dissolved in toluene (80 mL) in a 200-mL Schlenk flask to give a clear yellow solution. On vigorous stirring, NEt₃ (2.22 mL, 15.89 mmol) and n-BuLi (1.6 M in hexanes, 4.97 mL, 7.947 mmol) were added successively. After 2 hours, Ti(NMe₂)₂Cl₂ (877 mg, 4.238 mmol) was added as a red-brown solution in toluene (20 mL). The dark brown solution was sealed in the flask, the headspace evacuated briefly, and the reaction mixture heated to 90° C. for 3 hours. Chlorotrimethylsilane (0.90 mL, 7.064 mmol) was injected into the dark brown solution, and the reaction mixture was heated to 80° C. overnight. Volatiles were removed under reduced pressure and the dark green solid residue was extracted with toluene and filtered through a pad of Celite and washed with further portions of toluene until filtrates ran colorless. The combined dark greenish-brown extract was evaporated to dryness, slurried in hot heptane, and stored in a freezer at −33° C. overnight. Solids were collected on a medium porosity frit, rinsed with minimal cold pentane, and dried under vacuum to afford the desired product as a dark green solid (1.271 g, 2.029 mmol, 56% yield). ¹H NMR (400 MHZ, toluene-d₈) δ 7.62 (s, 1H, ArH), 747 (s, 1H, ArH), 7.28 (s, 1H, ArH), 7.00 (m, 1H, ArH), 6.90 (s, 1H, ArH), 6.82 (d, 1H, ArH), 6.55 (m, 1H, ArH), 3.63 (s, 3H, NMe), 2.72 (s, 3H, ArMe), 2.41 (s, 3H, ArMe), 2.36 (s, 3H, ArMe), 2.08 (s, 3H, ArMe), 1.71-1.05 (m, 10H, SiEt₂), 1.04 (s, 9H, t-Bu).

### Example 20

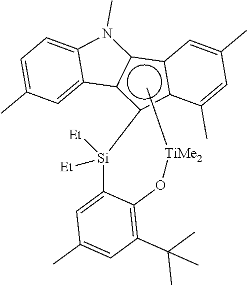

### Example 20

Example 19 (850 mg, 1.357 mmol) was dissolved in toluene (50 mL) to give a dark greenish-brown solution. MeMgBr solution (3.0 M in Et₂O, 0.97 mL, 2.910 mmol) was added via syringe and the resulting dark orange-brown solution was stirred for 2 hours. Volatiles were evaporated under reduced pressure and the residue was triturated with heptane and evaporated once again to remove residual Et₂O. The dried residue was extracted with toluene and filtered through a pad of Celite. The clear orange filtrate was evaporated to dryness to yield a bright orange powder (677 mg, 1.156 mmol, 85% yield). ¹H NMR (400 MHz, toluene-d₈) δ 7.55 (s, 1H, ArH), 7.41 (m, 1H, ArH), 7.28 (d, 1H, ArH), 6.96 (m, 1H, ArH), 6.86 (s, 1H, ArH), 6.81 (d, 1H, ArH), 6.65 (s, 1H, ArH), 3.58 (s, 3H, NMe), 2.71 (s, 3H, ArMe), 2.42 (s, 3H, ArMe), 2.30 (s, 3H, ArMe), 2.11 (m, 3H, ArMe), 1.45-1.04 (m, 19H, SiEt₂ and t-Bu), 0.21 (s, 3H, TiMe), 0.05 (s, 3H, TiMe).

### Examples 21-28

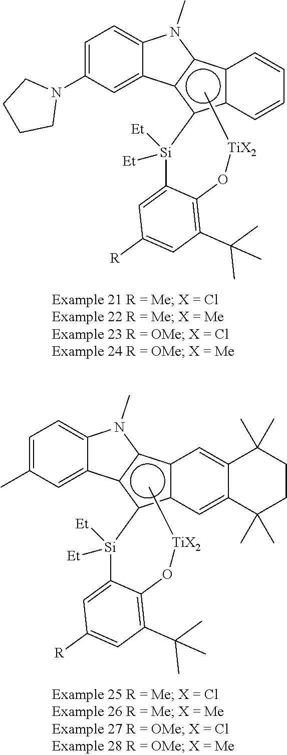

### 8-Bromo-5,10-dihydroindeno[1,2-b]indole

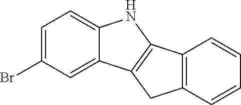 [SMILES: Brc1ccc2[nH]c3c(c2c1)Cc1ccccc1-3]

Para-toluenesulfonic acid monohydrate (522 mg, 3 mmol), p-bromophenylhydrazine hydrochloride (16.92 g, 76 mmol), and 1-indanone (10.01 g, 76 mmol) were charged into a 500 mL flask followed by isopropanol (155 mL). Some mild heat generation was observed as the suspension was mixed, while a bright yellow colour formed. The mixture was heated to 84° C. overnight after which the mixture had turned dark brown, and a suspension of off-white solid had formed. The mixture was cooled to ambient temperature and an aqueous solution of NaOH (˜2 g in 100 mL) was slowly added to the mixture, which caused additional crystalline precipitate to form. The mixture was filtered through a sintered glass frit, and the brownish solid collected on the frit was washed with water (20 mL). This solid was then dissolved in ethyl acetate, filtered through a glass frit, and the filtrate dried over anhydrous MgSO₄. The dried solution was filtered, and the volatiles were removed under dynamic vacuum to give an off-white solid. The solid was dried under vacuum to give 16.5 g of crude product. Recrystallization from hot heptane followed by filtration and drying under vacuum gave the pure product as an off-white free flowing solid (15.48 g, 72% yield). ¹H NMR (400 MHz, CDCl₃) δ 8.39 (s, 1H, NH), 7.77 (s, 1H, ArH), 7.56 (d, 1H, ArH), 7.49 (d, 1H, ArH), 7.35 (t, 1H, ArH), 7.31 (d, 1H, ArH), 7.24 (d, 1H, ArH), 3.71 (s, 2H, CH₂).

### 8-Bromo-5-methyl-5,10-dihydroindeno[1,2-b]indole

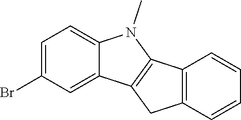 [SMILES: Cn1c2c(c3cc(Br)ccc31)Cc1ccccc1-2]

To a stirred dark brown solution of 8-bromo-5,10-dihydroindeno[1,2-b]indole (12.80 g, 45 mmol) in THF (100 mL) at ambient temperature was added a solution of NaOtBu (4.34 g, 45 mmol) in THF (100 mL) via cannula. After stirring rapidly for 2 hours, iodomethane (2.8 mL 45 mmol) was added dropwise via syringe and the mixture was allowed to stir for an additional 3 hours. Volatiles were removed under dynamic vacuum at 45° C., and the residue was taken up and partitioned between dichloromethane (200 mL), deionized water (150 mL) and saturated aqueous NH₄Cl (50 mL). The organic layer was separated, and the aqueous layer was washed with additional portions (2×50 mL) of dichloromethane. Volatiles were removed using reduced pressure and the resulting solid was dried under vacuum. Recrystallization from a mixture of heptane and ethyl acetate (˜3:1), followed by filtration and drying of the solid under vacuum afforded the pure product as an off-white solid (11.67 g, 87%). ¹H NMR (400 MHZ, CDCl₃) 7.75 (s, 1H, ArH), 7.67 (d, 1H, ArH), 7.55 (d, 1H, ArH), 7.35 (t, 1H, ArH), 7.28 (m, 1H, ArH), 7.25 (m, 2H, ArH), 4.05 (s, 3H, NCH₃), 3.68 (s, 2H, CH₂).

### 5-Methyl-8-(pyrrolidin-1-yl)-5,10-dihydroindeno[1,2-b]indole

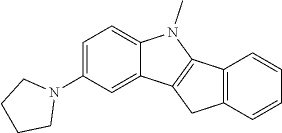 [SMILES: Cn1c2c(c3cc(N4CCCC4)ccc31)Cc1ccccc1-2]

8-Bromo-5-methyl-5,10-dihydroindeno[1,2-b]indole (7.79 g, 26 mmol), sodium tert-butoxide (3.76 g, 39.16 mmol), and pyrrolidine (5 mL, 61 mmol) were combined in a 200 mL Schlenk vessel under inert atmosphere. A solution of palladium acetate (123 mg. 0.5 mmol) and tri-tert-butylphosphine (211 mg, 1 mmol) in 100 mL of toluene was then transferred via cannula into the flask, which was then heated to 80° C. overnight while rapidly stirring. The temperature was increased to 100° C., and the mixture was stirred for 20 hours. Volatiles were removed under dynamic vacuum to afford a brown solid. Additional toluene was added, and the mixture was stirred to partially dissolve the brown solid. The solution was passed through a plug of neutral alumina and the volatiles were removed under dynamic vacuum, leaving 5.61 g of crude product. Additional toluene was passed through the alumina plug and volatiles were removed leaving additional solid. The crude material was recrystallized by dissolving in refluxing heptane followed by cooling to ambient temperature to afford colourless needle crystals which were isolated by decantation and dried under vacuum (4.82 g, 64%). ¹H NMR (400 MHZ, CDCl₃) δ 7.65 (s, 1H, ArH), 7.55 (d, 1H, ArH), 7.35 (t, 2H, ArH), 7.23 (m, 2H, ArH), 6.74 (m, H, ArH), 4.04 (s, 3H, NCH₃), 3.70 (s, 2H, CH₂), 3.39 (s, 4H, N(CH₂)₂), 2.08 (s, 4H, (CH₂)₂).

### 2,7,7,10,10-Pentamethyl-5,7,8,9,10,12-hexahydrobenzo[5,6]indeno[1,2-b]indole

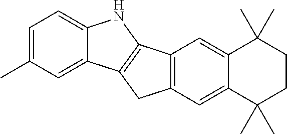 [SMILES: Cc1ccc2[nH]c3c(c2c1)Cc1cc2c(cc1-3)C(C)(C)CCC2(C)C]

Para-tolylhydrazine hydrochloride (793 mg, 5.0 mmol), 5,5,8,8-tetramethyl-2,3,5,6,7,8-hexahydro-1H-cyclopenta[b]naphthalen-1-one (1.212 g, 5.0 mmol), para-toluenesulfonic acid monohydrate (48 mg, 0.25 mmol), and isopropanol (50 mL) were combined into a flask and the mixture was refluxed overnight under an inert atmosphere of nitrogen. The mixture was cooled to ambient temperature and volatiles were removed under reduced pressure. The yellow-brown residue was partitioned between ethyl acetate (100 mL) and water (50 mL). The organic layer was washed with water (2×50 mL), brine (50 mL), dried over anhydrous Na₂SO₄, and then filtered before evaporating to dryness under reduced pressure to afford the product as a yellow/brown crystalline solid (1.53 g. 4.66 mmol, 93%). ¹H NMR (400 MHZ, CDCl₃) δ 8.25 (1H, s, NH), 7.49 (1H, s, ArH), 7.46-7.37 (m, 2H, ArH), 7.31 (d, 1H, ArH), 6.99 (d, 1H, ArH), 3.66 (s, 2H, indeno-CH₂), 2.48 (s, 3H, ArCH₃), 2.06 (s, 4H, CH₂CH₂), 1.37 (s, 6H, CMe₂), 1.36 (s, 6H, CMe₂).

### 2,5,7,7,10,10-Hexamethyl-5,7,8,9,10,12-hexahydrobenzo[5,6]indeno[1,2-b]indole

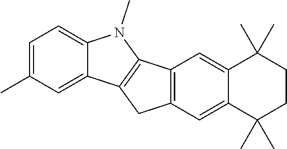 [SMILES: Cc1ccc2c(c1)c1c(n2C)-c2cc3c(cc2C1)C(C)(C)CCC3(C)C]

To a THF solution (40 mL) of 2,7,7,10,10-pentamethyl-5,7,8,9,10,12-hexahydrobenzo[5,6]indeno[1,2-b]indole (1.53 g, 4.66 mmol) with stirring at ambient temperature (water bath) was added a THF solution (20 mL) of sodium tert-butoxide (470 mg, 4.89 mmol) to afford a dark red-brown solution. After 30 min, iodomethane (0.938 g, 4.89 mmol) was added, and the mixture was stirred overnight. Volatiles were removed under reduced pressure. The residue was partitioned between diethyl ether and water (40 mL each). The organic layer was shaken with brine (20 mL), dried over anhydrous Na₂SO₄, filtered, and the filtrate evaporated to dryness to afford the product as a brown solid (1.28 g, 3.74 mmol, 80%). ¹H NMR (400 MHZ, CDCl₃) δ 7.58 (s, 1H, ArH). 7.49 (s, 1H, ArH), 7.42 (br. s, 1H, ArH), 7.26 (d, 1H, ArH), 7.03 (d, 1H, ArH), 4.04 (s, 3H, NMe), 3.64 (s, 2H, indeno-CH₂), 2.49 (s, 3H, ArMe), 1.76 (s, 4H, CH₂CH₂), 1.40 (s, 6H, CMe₂), 1.36 (s, 6H, CMe₂).

### General Procedure for the 1-Pot Preparation of Examples 21, 23, 25, and 27:

The following synthetic steps were carried out in under an inert nitrogen atmosphere using an automated reactor platform supplied by Chemspeed Technologies equipped with 250 mL stainless steel, jacketed reactors with mechanical stirring. A solution of the required indeno[1,2-b]indole precursor (25.2 mL aliquot of a THF solution to deliver 2.9 mmol) was added to the reactor followed by additional THF (20 mL). A solution of n-BuLi (1.6 M in hexanes, 1.91 mL, 3 mmol) was added while stirring and the mixture was stirred at ambient temperature for 3 hours. A solution of the required chlorosilane precursor (17.4 mL aliquot of a THF solution to deliver 3 mmol) was then added to the reactor and the reaction mixture was stirred overnight. Volatiles were removed from the reactor under dynamic vacuum, and then toluene (50 mL) was added. After stirring for 1 hour, triethylamine (2 mL, >4 eq) followed by a solution of n-BuLi (1.6 M in hexanes, 3.82 mL, 6.11 mmol) was added. The mixture was stirred for 2 hours, then cooled to 0° C., and a solution of Ti(NMe₂)Cl₂ (9 mL aliquot of a toluene solution to deliver 3.5 mmol) was added. The mixture was stirred for 1 hour at 0° C., and then heated to 90° C. for 3 hours. It was then cooled to 30° C., and chlorotrimethylsilane (7.3 mmol, 1.5 mL) was added. The reactor was sealed and heated to 85° C. for 14 hours. Volatiles were removed under dynamic vacuum at 50° C. Toluene (50 mL) was added to the reactor and heated to 50° C. while stirring.

The following manipulations were conducted manually under an inert nitrogen atmosphere in a glovebox. The reaction mixtures were filtered through Celite into a 100 mL Schlenk flask. Volatiles were removed under dynamic vacuum and heptane (30 mL) was added and the reaction mixture was heated to 80° C. while stirring and then allowed to cool to room temperature. Solids were collected by filtration, rinsed with pentane, and then dried under dynamic vacuum to give the products as dark green solids.

### Example 21

Yield: 0.56 g, 29%. ¹H NMR (400 MHZ, toluene-d₈) δ 7.88 (d, 1H, ArH), 7.77 (d, 1H, ArH), 7.40 (s, 1H, ArH), 7.30 (m, 1H, ArH), 7.20 (m, 1H, ArH), 7.18 (d, 1H, ArH), 6.87 (d, 1H, ArH), 6.60 (s, 1H, ArH), 6.25 (s, 1H, ArH), 3.64 (s, 3H, NCH₃), 2.75 (m, 4H, N(CH₂)₂), 2.34 (s, 3H, ArCH₃), 1.63 (m, 4H, N(CH₂)₂(CH₂)₂), 1.57-1.20 (m, 6H, SiEt₂), 1.10 (s, 9H, t-Bu), 1.09-1.05 (m, 4H, SiEt₂).

### Example 23

Yield: 1.32 g, 68%. ¹H NMR (400 MHZ, toluene-d₈) δ 7.87 (d, 1H, ArH), 7.78 (d, 1H, ArH), 7.40 (s, 1H, ArH), 7.31 (m, 1H, ArH), 7.21 (m, 1H, ArH), 7.17 (d, 1H, ArH), 6.88 (d, 1H, ArH), 6.62 (dd, 1H, ArH), 6.27 (s, 1H, ArH), 3.64 (s, 3H, NCH₃), 3.57 (s, 3H, ArOCH₃), 2.81 (m, 4H, N(CH₂)₂), 1.64 (m, 4H, N(CH₂)₂(CH₂)₂), 1.59-1.20 (m, 6H, SiEt₂), 1.09 (s, 9H, t-Bu), 1.09-1.05 (m, 4H, SiEt₂).

### Example 25

Yield: 0.93 g, 45%, ¹H NMR (400 MHZ, toluene-d₈) δ 8.08 (d, 2H, ArH), 7.45 (s, 1H, ArH), 7.28 (s, 1H, ArH), 7.00 (d, 1H, ArH), 6.80 (d, 1H, ArH), 6.46 (s, 1H, ArH), 3.73 (s, 3H, NCH₃), 2.40 (s, 3H, ArCH₃), 2.07 (s, 3H, ArCH₃), 1.80-1.60 (m, 6H, SiEt₂), 1.54 (s, 3H, CCH₃), 1.42 (s, 3H, CCH₃), 1.40 (s, 3H, CCH₃), 1.35 (s, 3H, CCH₃), 1.26 (m, 2H, CH₂), 1.18-1.09 (m, 6H, SiEt₂+CH₂), 1.06 (s, 9H, t-Bu).

### Example 27

Yield: 0.66 g, 32%. ¹H NMR (400 MHZ, toluene-d₈) δ 8.07 (d, 2H, ArH), 7.23 (s, 1H, ArH), 7.08 (s, H, ArH), 7.00 (d, 1H, ArH), 6.80 (d, 1H, ArH), 6.53 (s, 1H, ArH), 3.73 (s, 3H, NCH₃), 2.60 (s, 3H, ArOCH₃), 2.11 (s, 3H, ArCH₃), 1.80-1.60 (m, 6H, SiEt₂), 1.54 (s, 3H, CCH₃), 1.42 (s, 3H, CCH₃), 1.41 (s, 3H, CCH₃), 1.35 (s, 3H, CCH₃), 1.26 (m, 2H, CH₂), 1.17-1.08 (m, 6H, SiEt₂+CH₂), 1.05 (s, 9H, t-Bu).

### General Procedure for the Preparation of Examples 22, 24, 26, and 28:

To a toluene solution (˜10 mL) of the appropriate dichloride complex was added a solution of MeMgBr (the required volume of a 3.0 M solution in Et₂O, 2.2 equiv.). After stirring for 30 minutes, volatiles were removed under dynamic vacuum. The residue was extracted using a mixture of toluene and heptane and filtered through a plug of Celite. Volatiles were then removed under dynamic vacuum to give the dimethyl complex as a bright orange to red powders.

### Example 22

Yield: 0.91 g, 82%. ¹H NMR (400 MHZ, toluene-d₈) δ 7.89 (m, 1H, ArH), 7.77 (d, 1H, ArH), 7.35 (d, 1H, ArH), 7.20 (d, 1H, ArH), 7.17 (m, 2H, ArH), 6.86 (d, 1H, ArH), 6.58 (dd, 1H, ArH), 6.25 (s, 1H, ArH), 3.60 (s, 3H, NCH₃), 2.77 (m, 4H, N(CH₂)₂), 2.37 (s, 3H, ArCH₃), 1.63 (m, 4H, N(CH₂)₂(CH₂)₂), 1.32 (s, 9H, t-Bu), 1.29-1.02 (m, 10H, SiEt₂), 0.20 (s, 3H, TiCH₃), 0.03 (s, 3H, TiCH₃).

### Example 24

Yield: 0.40 g. 85%, ¹H NMR (400 MHZ, toluene-d₈) δ 7.90 (m, 1H, ArH), 7.75 (m, 1H, ArH), 7.17 (m, 2H, ArH), 7.12 (d, 1H, ArH), 7.03 (d, 1H, ArH), 6.87 (d, 1H, ArH), 6.59 (dd, 1H, ArH), 6.27 (s, 1H, ArH), 3.61 (s, 3H, NCH₃), 3.60 (s, 3H, ArOCH₃), 2.82 (m, 4H, N(CH₂)₂), 1.64 (m, 4H, N(CH₂)₂(CH₂)₂), 1.31 (s, 9H, t-Bu), 1.30-1.05 (m, 10H, SiEt₂), 0.18 (s, 3H, TiCH₃), 0.02 (s, 3H, TiCH₃).

### Example 26

Yield: 0.67 g. 85%, ¹H NMR (400 MHZ, toluene-d₈) δ 8.12 (s, 1H, ArH), 7.89 (s, 1H, ArH), 7.41 (d, 1H, ArH), 7.28 (d, 1H, ArH), 6.95 (d, 1H, ArH), 6.79 (d, 1H, ArH), 6.57 (s, 1H, ArH), 3.67 (s, 3H, NCH₃), 2.41 (s, 3H, ArCH₃), 2.09 (s, 3H, ArCH₃), 1.80-1.60 (m, 4H, SiEt₂), 1.48 (s, 3H, CCH₃), 1.42-1.31 (m, 2H, CH₂), 1.37 (s, 3H, CCH₃), 1.35 (s, 3H, CCH₃), 1.32 (s, 3H, CCH₃), 1.31-1.28 (m, 2H, CH₂), 1.29 (s, 9H, 1-Bu), 1.18-1.09 (m, 6H, SiEt₂+CH₂), 0.13 (s, 3H, TiCH₃), 0.01 (s, 3H, TiCH₃).

### Example 28

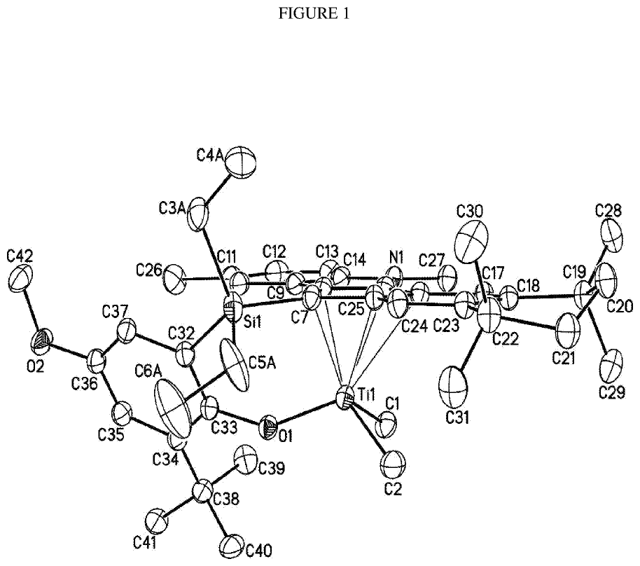

Yield: 0.34 g, 61%. Recrystallization from a toluene/heptane mixture gave dark red crystals suitable for single-crystal X-ray diffraction (see FIG. 1 and Table 1). ¹H NMR (400 MHZ, toluene-d₈) δ 8.12 (s, 1H, ArH), 7.88 (s, 1H, ArH), 7.18 (d, 1H, ArH), 7.11 (d, 1H, ArH), 6.95 (d, 1H, ArH), 6.79 (d, 1H, ArH), 6.62 (s, 1H, ArH), 3.67 (s, 3H, NCH₃), 3.63 (s, 3H, ArOCH₃), 2.11 (s, 3H, ArCH₃), 1.80-1.60 (m, 4H, SiEt₂), 1.48 (s, 3H, CCH₃), 1.42-1.31 (m, 2H, CH₂), 1.37 (s, 3H, CCH₃) 1.35 (s, 3H, CCH₃) 1.32 (s, 3H, CCH₃), 1.31-1.28 (m, 2H, CH₂), 1.28 (s, 9H, t-Bu), 1.20-1.09 (m, 6H, SiEt₂+CH₂), 0.11 (s, 3H, TiCH₃), 0.01 (s, 3H, TiCH₃). FIG. 1 shows a side view of the titanium complex Example 28 showing the atom labelling scheme. Only the major (80%) orientation of the disordered diethylsilyl group is shown. Non-hydrogen atoms are represented by Gaussian ellipsoids at the 30% probability level. Hydrogen atoms are not shown.

TABLE 1
Crystallographic Experimental Details for the Pre-Catalyst
Complex Inventive Example 28.
A. Crystal Data

| formula | C₄₂H₅₇NO₂SiTi |
|---|---|
| formula weight | 683.87 |
| crystal colour and habit ^{a} | orange fragment |
| crystal dimensions (mm) | 0.27 × 0.25 × 0.11 |
| crystal system | monoclinic |
| space group | P2₁/c (No. 14) |
| unit cell parameters ^{b} | |
| a (Å) | 10.3476(9) |
| b (Å) | 21.9629(19) |
| c (Å) | 17.2566(15) |
| β (deg) | 99.1692(15) |
| V (Å³) | 3871.6(6) |
| Z | 4 |
| ρcalcd (g cm⁻³) | 1.173 |
| μ (mm⁻¹) | 0.287 |

B. Data Collection and Refinement Conditions

| | |
|---|---|
| diffractometer | Bruker PLATFORM/APEX II CCD^{c} |
| radiation (λ [Å]) | graphite-monochromated Mo Kα |
| | (0.71073) |
| temperature (° C.) | −80 |
| scan type | ω scans (0.3°) (20 s exposures) |
| data collection 2θ limit | 54.42 |
| (deg) | |
| total data collected | 47488 (−13 ≤ h ≤ 13, −28 ≤ k ≤ 28, |
| | −222 ≤ l ≤ 22) |
| independent reflections | 8642 (Rint = 0.0519) |
| number of observed | 6234 [Fₒ² ≥ 2σ(Fₒ²)] |
| reflections (NO) | |
| structure solution method | intrinsic phasing (SHELXT-2014^{d}) |
| refinement method | full-matrix least-squares on F² |
| | (SHELXT-2018 ^{e}) |
| absorption correction | Gaussian integration (face-indexed) |
| method | |
| range of transmission | 1.0000-0.9215 |
| factors | |
| data/restraints/parameters | 8642/30^{f}/454 |
| goodness-of-fit (S) ^{g} | 1.050 |
| [all data] | |
| final R indices ^{h} | |
| R1 [Fₒ² ≥ 2σ(Fₒ²)] | 0.0481 |
| wR₂ [all data] | 0.1390 |
| largest difference peak | 0.465 and −0.532 e Å⁻³ |
| and hole | |

Notes:
^{a}Obtained by recrystallization from a toluene/heptane solution.
^{b} Obtained from least-squares refinement of 7285 reflections with 4.40° < 2θ < 50.18°.
^{c} Programs for diffractometer operation, data collection, data reduction and absorption correction were those supplied by Bruker.
^{d}Sheldrick, G.M. Acta Crystallogr. 2015, A71, 3-8 (SHELXT-2014).
^{e} Sheldrick, G.M. Acta Crystallogr. 2015, A71, 3-8 (SHELXT-2018/3).
^{f}The Si—C distances within the disordered diethylsiyl group were restrained to be approximately equal by use of the SHELXL SADI instruction; C—C distances of the ethyl groups were similarly treated. An anti-bumping restraint was applied to the C3B . . . C5B distance to improve the C3B—Si1—C5B angle. Finally, the rigid-bond restraint (RIGU) was applied to the atoms of the disordered diethylsilyl group.
^{g} S = [Σw(Fₒ² − F_{c}²)²/(n − p)]^{1/2} (n = number of data; p = number of parameters varied; w = [σ²(Fₒ²) + (0.0636P)² + 1.4664P]⁻¹ where P = [Max(Fₒ², 0) + 2F_{c}²]/3).
^{h} R₁ = Σ∥Fₒ| − |F_{c}∥/Σ|Fₒ|; wR₂ = [Σw(Fₒ² − F_{c}²)²/Σw(Fₒ⁴)]^{1/2}.

### Comparative Example 1

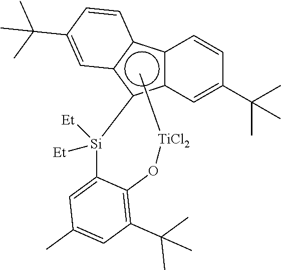

This material was prepared substantially as described by Senda. T., Oda. Y. et al. in Macromolecules 2010. 43. 2299-2306.

### (2-(Allyloxy)-3-(tert-butyl)-5-methylphenyl)(2,7-di-tert-butyl-9H-fluoren-9-yl) diethylsilane

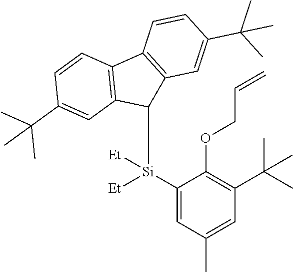 [SMILES: C=CCOc1c(C(C)(C)C)cc(C)cc1[Si](CC)(CC)C1c2cc(C(C)(C)C)ccc2-c2ccc(C(C)(C)C)cc21]

2,7-Di-tert-butylfluorene (1.67 g, 6.0 mmol) was dissolved in THF (40 mL). n-BuLi solution (1.6 M in hexanes, 4.13 mL, 6.6 mmol) was added via syringe resulting in mild effervescence and a bright orange coloration. After stirring for 30 minutes, volatiles were removed under reduced pressure and the residue was redissolved in diethyl ether (10 mL). (2-(Allyloxy)-3-(tert-butyl)-5-methylphenyl) chlorodiethylsilane was added as a solution in diethyl ether (40 mL) resulting in a precipitate. The reaction mixture was stirred overnight and then concentrated under reduced pressure to afford a foam. The residue was extracted into pentane and filtered to remove a white solid from the clear yellow filtrate. The filtrate was concentrated under reduced pressure to afford the desired product as a foam and eventually a sticky oil (3.41 g, 100% yield). ¹H NMR (400 MHZ, toluene-d₈) δ 7.76 (d, 2H, ArH), 7.40-7.30 (m, 6H, ArH), 5.88 (m, 1H, allyl-H), 5.58 (dq, 1H, allyl-H), 5.19 (dq, 1H, allyl-H), 4.55 (s, 1H, fluorene-9H), 4.39 (q, 2H, allyl-H), 2.30 (s, 3H, ArH), 1.52 (s, 9H, t-Bu), 1.34 (s, 18H, t-Bu), 1.05-0.70 (m, 10H, SiEt₂).

### Comparative Example 1

(2-(Allyloxy)-3-(tert-butyl)-5-methylphenyl)(2,7-di-tert-butyl-9H-fluoren-9-yl) diethylsilane (3.41 g. 6.0 mmol) was dissolved in toluene (30 mL) in a 100-mL Schlenk flask. The flask was cooled to −78° C. for 15 minutes and triethylamine (3.76 mL, 2.73 g, 27.0 mmol) and n-BuLi solution (1.6 M in hexanes, 8.44 mL, 13.5 mmol) were added successively. The yellow solution was allowed to warm to ambient temperature over 2 hours and stirred for another 30 minutes before cooling once again to −78° C. Ti(NMe₂)₂Cl₂ (1.49 g. 7.2 mmol) was added as a slurry in toluene resulting in a dark red reaction mixture. The cold bath was replaced with an oil bath and the reaction mixture was heated to 90° C. for 3 hours. Volatiles were removed under reduced pressure to afford a black tar. The residue was extracted with toluene and filtered through Celite to remove dark insoluble material from the dark brown-black filtrate. The filter cake was rinsed with toluene until the filtrate ran pale brown. The combined toluene extracts were concentrated to 50 mL and chlorotrimethylsilane (1.52 mL, 1.30 g, 12.0 mmol) was added. The headspace was briefly evacuated, and the reaction mixture was heated to 80° C. overnight. Volatiles were removed to afford the crude product. Recrystallization from hot heptane afforded the desired product as a brown solid (2.01 g, 52% yield). ¹H NMR (400 MHZ, toluene-d₈) δ 8.00 (d, 2H, ArH), 7.79 (s, 2H, ArH), 7.46 (d, 2H, ArH), 7.39 (s, 1H, ArH), 7.24 (s, 1H, ArH), 2.33 (s, 3H, ArCH₃), 1.37 (s, 9H, t-Bu), 1.23 (s, 18H, t-Bu), 1.17-0.80 (m, 10H, SiEt₂).

### Comparative Example 2

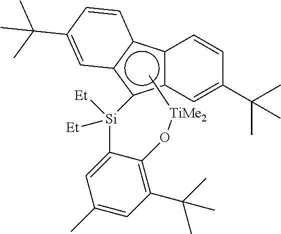

### Comparative Example 2

Comparative Example 1 (2.01 g, 3.12 mmol) was dissolved in toluene (50 mL) in a 100-mL Schlenk flask. MeMgBr solution (2.19 mL, 3.0 M in diethyl ether, 6.56 mmol) was added resulting in a change in color from dark brown to dull green. After stirring for 2 hours the volatiles were removed under reduced pressure. The residue was extracted with heptane and filtered through Celite to afford a clear yellow-green filtrate. The filtrate was concentrated under reduced pressure to yield a foam. Recrystallization from hot heptane afforded the desired product as a yellow green powder (1.36 g, 72% yield). ¹H NMR (400 MHZ, toluene-d₈) δ 8.03 (d, 2H, ArH), 7.51 (s, 2H, ArH), 7.38 (dd, 2H, ArH), 7.35 (d, 1H, ArH), 7.28 (d, 1H, ArH), 2.37 (s, 3H, ArCH₃), 1.55 (s, 9H, t-Bu), 1.40-1.25 (m, 4H, SiEt₂), 1.20 (s, 18H, t-Bu), 1.15 (t, 6H, SiEt₂), 0.16 (s, 6H, TiMe₂).

### Comparative Example 3

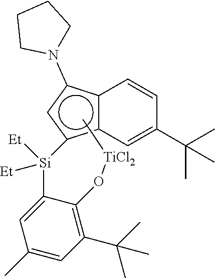

This material was prepared substantially as described for the known Me₂Si-bridged analog in Hanaoka, H. U.S. Pat. No. 7,141,690 B2.

### 1-(1H-inden-3-yl) pyrrolidine

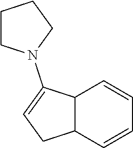 [SMILES: C1=CC2CC=C(N3CCCC3)C2C=C1]

1-Indanone (5.42 g, 41.0 mmol), pyrrolidine (3.70 mL, 45.0 mmol) and toluene (200 mL) were heated to 130° C. under N₂ in a 500-mL round-bottomed flask in a Dean-Stark apparatus for 4 days resulting in a dark-brown reaction mixture. Volatiles were removed under reduced pressure to afford a residue consisting of a black oil with solids. The residue was purified by vacuum distillation to give a clear yellow liquid that was stored under nitrogen (5.25 g, 69% yield). ¹H NMR (400 MHz, toluene-d₈) δ 7.54 (d, 1H, ArH), 7.28 (d, 1H, ArH), 7.20 (t, 1H, ArH), 7.12 (t, 1H, ArH), 4.98 (t, 1H, inden-2-yl CH), 3.23 (d, 2H, inden-1-yl CH₂), 3.18 (m, 4H, NCH₂), 1.58 (m, 4H, NCH₂CH₂).

### 1-(1-((2-(allyloxy)-3-(tert-butyl)-5-methylphenyl) diethylsilyl)-1H-inden-3-yl) pyrrolidine

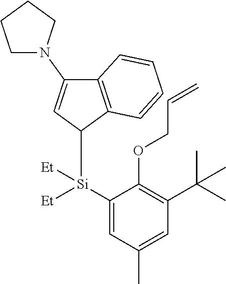 [SMILES: C=CCOc1c(C(C)(C)C)cc(C)cc1[Si](CC)(CC)C1C=C(N2CCCC2)c2ccccc21]

1-(1H-inden-3-yl) pyrrolidine (1.30 g, 7.0 mmol) was diluted with THF (30 mL) to give a pale yellow solution in a 100-mL Schlenk flask. n-BuLi solution (1.6 M in hexanes, 4.81 mL, 7.7 mmol) was added, resulting in effervescence and a dark yellow coloration. After 30 minutes, a THF solution (10 mL) of (2-(allyloxy)-3-(tert-butyl)-5-methylphenyl) chlorodiethylsilane (2.28 g, 7.0 mmol) was added, resulting in a dark green color. After stirring for 1 hour, volatiles were removed under reduced pressure to afford a red-brown syrup. This was triturated with pentane, concentrated under reduced pressure, and extracted with pentane once again before filtering through Celite to remove a beige solid from the red-brown filtrate. Concentrated of the filtrate under reduced pressure afforded the desired product as a thick red-brown oil (3.37 g, 100% yield). ¹H NMR (400 MHZ, toluene-d₈) δ 7.63 (d, 1H, ArH), 7.36 (d, 1H, ArH), 7.26-7.15 (m, 3H, ArH), 7.09 (d, 1H, ArH), 5.85 (m, 1H, allyl-H), 5.56 (dq, 1H, allyl-H), 5.36 (d, 1H, inden-2-yl CH), 5.11 (dq, 1H, allyl-H), 4.36 (m, 2H, allyl-H), 4.00 (d, 1H, inden-1-yl CH), 3.21 (m, 4H, NCH₂), 2.22 (s, 3H, ArCH₃), 1.62 (m, 4H, NCH₂CH₂), 1.47 (s, 9H, t-Bu), 1.01-0.77 (m, 10H, SiEt₂).

### Comparative Example 3

1-(1-((2-(allyloxy)-3-(tert-butyl)-5-methylphenyl) diethylsilyl)-1H-inden-3-yl) pyrrolidine (3.32 g, 7.0 mmol) was dissolved in toluene (30 mL) in a 100-mL Schlenk flask. NEt₃ (4.39 mL, 31.5 mmol) was added to the purple-brown solution. The flask was cooled to −78° C. for 15 min, after which n-BuLi solution (1.6 M in hexanes, 9.84 mL, 15.75 mmol) was added via cannula. The reaction mixture was warmed to ambient temperature over 2 hours and cooled once again to −78° C. for 15 minutes. A solution of Ti(NMe₂)₂Cl₂ (1.74 g, 8.4 mmol) in toluene (20 mL) was added via cannula and the reaction mixture was warmed gradually to 90° C., and held for 3 hours. Volatiles were removed under reduced pressure and the residue was extracted with toluene and filtered through Celite until filtrates ran colorless. The combined toluene extracts were sealed in a flask and the headspace was evacuated.

Chlorotrimethylsilane (2.67 mL, 21.0 mmol) was added and the reaction mixture was heated to 80° C. overnight. The dark brown reaction mixture was concentrated under reduced pressure. The brown-black residue was slurried in hot heptane (40 mL) and stirred for 20 minutes after which the suspension was cooled in the glovebox freezer overnight. Solids were isolated on a frit, rinsed with minimal cold pentane and dried under vacuum to afford a dark green to black solid that is dark red-brown in toluene solution (3.11 g, 81% yield). ¹H NMR (400 MHZ, toluene-d₈) δ 7.73 (m, 1H, ArH), 7.43 (m, 1H, ArH), 7.29 (d, 2H, ArH), 7.06-6.98 (m, 2H, ArH), 5.45 (s, 1H, inden-2-yl CH), 3.52-3.25 (m, 4H, NCH₂), 2.31 (s, 3H, ArCH₃), 1.49 (s, 9H, t-Bu), 1-49-1.45 (m, 4H, NCH₂NCH₂), 1.31-0.95 (m, 10H, SiEt₂).

### Comparative Example 4

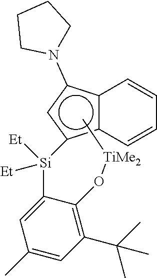

### Comparative Example 4

Comparative Example 3 (1.50 g, 2.72 mmol) was dissolved in toluene (40 mL). MeMgBr solution (3.0 M in diethyl ether, 2.00 mL, 6.00 mmol) was added dropwise to the dull brown-black mixture on vigorous stirring, resulting in a dark red-brown solution. This was stirred overnight and concentrated under reduced pressure to a dark red-brown residue. The residue was extracted with toluene and filtered through Celite, removing a black solid from the dark red-brown filtrate. The filtrate was removed under reduced pressure to a sticky paste. Trituration with pentane afforded a red powder. (1.11 g, 80% yield). ¹H NMR (400 MHZ, toluene-d₈) δ 7.73 (d, 1H, ArH), 7.25 (d, 2H, ArH), 6.91 (d, 1H, ArH), 6.85 (m, 1H, ArH), 6.55 (m, 1H, ArH), 5.60 (s, 1H, inden-2-yl CH), 3.40 (m, 4H, NCH₂), 2.32 (s, 3H, ArCH₃), 1.61 (s, 9H, t-Bu), 1.56 (m, 4H, NCH₂CH₂), 1.17-0.85 (m, 13H, SiEt₂+TiCH₃), 0.24 (TiCH₃).

### Comparative Example 5

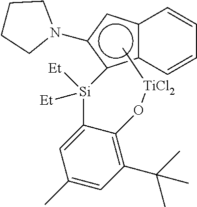

### 1-(1H-Inden-2-yl) pyrrolidine

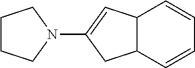 [SMILES: C1=CC2C=C(N3CCCC3)CC2C=C1]

This material was prepared substantially as described by Blomquist, et al. in J. Org. Chem. 1961, 26, 10, 3761-3769. 2-Indanone (3.70 g, 28.0 mmol) was dissolved in toluene (30 mL) in a 100-mL Schlenk flask. Pyrrolidine (2.46 mL, 30 mmol) was added via syringe, and the flask was attached to a Dean-Stark apparatus under a stream of N₂. The mixture was heated to 130° C. which initially resulted in foaming. After 2 hours heating was stopped, the Dean-Stark apparatus was removed, and volatiles were removed under reduced pressure. Trituration of the residue with pentane followed by concentration under reduced pressure afforded the desired product as a beige powder (4.78 g, 92% yield). ¹H NMR (400 MHZ, toluene-d₈) δ 7.26-7.12 (m, 3H, ArH), 6.93 (td, 1H, ArH), 5.21 (s, 1H, inden-3-yl CH), 2.96 (s, 2H, inden-1-yl CH₂), 2.78 (m, 4H, NCH₂), 1.48 (m, 4H, NCH₂CH₂).

### 1-(1-((2-(Allyloxy)-3-(tert-butyl)-5-methylphenyl) diethylsilyl)-1H-inden-2-yl) pyrrolidine

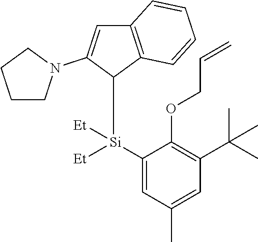 [SMILES: C=CCOc1c(C(C)(C)C)cc(C)cc1[Si](CC)(CC)C1C(N2CCCC2)=Cc2ccccc21]

1-(1H-inden-2-yl) pyrrolidine (2.04 g, 11.0 mmol) was dissolved in THF (100 mL) in a 200-mL Schlenk flask to a dark brown solution. n-BuLi solution (1.6 M in hexanes, 7.56 ml, 12.1 mmol) was added via syringe and the mixture was stirred for 2 hours. After 2 h, the dark brown reaction mixture was cooled to −78° C. for 15 minutes and a solution of (2-(allyloxy)-3-(tert-butyl)-5-methylphenyl) chlorodiethylsilane (3.58 g, 11.0 mmol) in THF (10 mL) was added via cannula. The mixture was allowed to stir and warm to ambient temperature overnight. Volatiles were then removed under reduced pressure to give a brown foam. This residue was triturated with pentane and concentrated under reduced pressure once again to remove residual THF. The residue was extracted with pentane and filtered. The dark brown filtrate was concentrated under reduced pressure to give a beige suspension and then a pale-beige sticky solid on complete removal of volatiles. This material was suspended in pentane (50 mL) and filtered to collect a solid on a sintered glass frit. The solid was isolated and dried under vacuum. Further crops of solid material were obtained by cooling the mother liquor in the glovebox freezer (combined yield: 3.12 g, 60% yield). ¹H NMR (400 MHZ, toluene-d₈) δ 7.24-6.94 (m, 6H, ArH), 6.87 (td, 1H, ArH), 5.87 (m, 1H, allyl-H), 5.56 (dq, 1H, allyl-H), 5.56 (s, 1H, inden-1-yl CH), 5.14 (dq, 1H, allyl-H), 4.32 (qq, 2H, allyl-H), 3.92 (s, 1H, inden-3-yl CH), 2.85 (m, 4H, NCH₂), 2.18 (3H, s, ArCH₃), 1.50 (m, 4H, NCH₂CH₂), 1.44 (s, 9H, t-Bu), 1.09-0.73 (m, 10H, SiEt₂).

### Comparative Example 5

1-(1-((2-(Allyloxy)-3-(tert-butyl)-5-methylphenyl) diethylsilyl)-1H-inden-2-yl) pyrrolidine (1.89 g, 3.98 mmol) was dissolved in toluene (30 mL) in a 100-mL Schlenk flask affording an orange-brown solution. Triethylamine (2.50 mL, 17.93 mmol) was added via syringe. The reaction mixture was cooled to −78° C. for 15 minutes and then n-BuLi solution (1.6 M in hexanes, 5.60 mL, 8.97 mmol) was added via cannula. The reaction mixture was stirred and allowed to warm to ambient temperature over 2 hours resulting in a light brown suspension. This was cooled once again to −78° C. for 15 minutes and then a toluene solution (15 mL) of Ti(NMe₂)₂Cl₂ (989 mg, 4.78 mmol) was added and the mixture was warmed to ambient temperature and heated to 90° C. for 3 hours. The reaction mixture was a dark brown-black solution. Volatiles were removed under reduced pressure and the residue was extracted into toluene and filtered through Celite to remove a dark solid from the dark brown solution. The filtrate was collected in a 100-mL Schlenk flask equipped with a stir bar and the flask was sealed with a septum and the headspace evacuated briefly. Chlorotrimethylsilane (1.00 mL, 7.97 mmol) was injected through the septum via syringe and the reaction mixture was heated to 80° C. for 5 hours. Volatiles were removed under reduced pressure. The residue was recrystallized from hot heptane/toluene (˜50:50) to afford the desired product as a dark red-brown crystalline solid (1.42 g, 65% yield). ¹H NMR (400 MHZ, toluene-d₈) δ 7.53 (d, 1H, ArH), 7.41 (d, 1H, ArH), 7.20 (m, 2H, ArH), 6.91 (t, 1H, ArH), 6.80 (t, 1H, ArH), 6.11 (s, 1H, inden-1-yl CH), 3.05 (m, 4H, NCH₂), 2.27 (s, 3H, ArCH₃), 1.38 (s, 9H, t-Bu), 1.37-0.83 (m, 14H, SiEt₂+NCH₂CH₂).

### Comparative Example 6

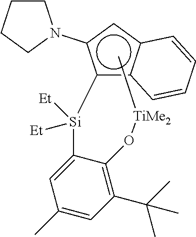

### Comparative Example 6

Comparative Example 5 (800 mg, 1.45 mmol) was dissolved in toluene (50 mL) in a 100-mL Schlenk flask. On stirring MeMgBr solution (3.0 M in diethyl ether. 1.07 mL, 3.20 mmol) was added dropwise via syringe to the red-brown solution resulting in a dark green-brown suspension. This was stirred for 3 hours after which the reaction mixture was concentrated under reduced pressure. The green powdery residue was extracted with pentane (3×50 mL) and filtered through Celite. The clear bright-yellow filtrate was concentrated under reduced pressure to give a solid foam and eventually a yellow powder (490 mg, 66% yield). ¹H NMR (400 MHz, toluene-d₈) δ 7.54 (t, 2H, ArH), 7.27-6.92 (m, 4H, ArH), 5.96 (s, 1H, inden-1-yl CH), 2.78 (m, 4H, NCH₂), 2.26 (s, 3H, ArCH₃), 1.64 (s, 9H, t-Bu), 1.31-0.74 (m, 17H, SiEt₂+NCH₂CH₂+TiCH₃), 0.16 (s, 3H, TiCH₃).

### Solution Phase Polymerization: Semi-Batch Copolymerization Experiments at 140° C.

Semi-batch ethylene/1-octene copolymerization experiments were conducted in an automated array of 1 L reactors supplied by Chemspeed Technologies equipped with pitched blade impellers with gas entrainment through the hollow impeller shaft to maximize gas dispersion in the liquid. Baffles were installed in the reactors to enhance the turbulence and ensure good mixing in the reactor. Heating of the reactors was controlled with a reactor-jacketed electric heater. Reactor cooling was controlled with a silicone oil heat transfer fluid circulated within the reactor jacket. The reactors are each equipped with two catalyst injection vessels fixed to the reactor heads and equipped with solenoid-operated isolation valves. The entire system is housed in an MBraun glovebox under a nitrogen atmosphere to maintain an oxygen- and moisture-deficient environment during the catalyst handling and polymerization processes. The reactor uses a programmable logical control (PLC) system with software as a method of process control.

The reactor was charged with cyclohexane (500 mL) and 1-octene (4 mL) prior to heating the reactor and charging the catalyst injection chambers with catalyst and activator solutions. Depending on the aluminum based co-catalyst (e.g. an organoaluminum compound or an alkylaluminoxane) addition method (as listed in Table 2), the aliquot of aluminum based co-catalyst solution was added to the reactor in different ways: the aliquot was added directly to the reactor prior to heating (‘method a’); 90% of the aliquot was added to the reactor prior to heating and 10% of the aliquot was pre-mixed with the pre-polymerization catalyst solution in the injection vessel prior to injection (‘method b’); or the aliquot was added to the reactor via a high-pressure feed vessel once it had reached the target reactor temperature (‘method c’).

In some examples where the co-catalyst was an alkylaluminoxane, a hindered phenol compound (BHEB) was also used. MMAO-7/BHEB co-catalyst solutions were prepared by adding 2,6-di-tert-butyl-4-ethylphenol (BHEB; 0.28 g, 1.2 mmol) to a cyclohexane solution (10 mL) of MMAO-7 (1.54 g of a 0.4 mmol/mL solution in Isopar-E; AkzoNobel/Nouryon). In examples where the co-catalyst was an organoaluminum compound such as TIBAL, the appropriate aliquot volume and target Al/Ti molar ratio was added of a solution prepared by dilution of TIBAL (25 wt % solution in hexanes; AkzoNobel/Nouryon) with cyclohexane.

The first catalyst injection vessel was charged with a toluene solution (5 mL) of the inventive or comparative pre-polymerization catalyst complex (0.0005 mmol for a target of 1 μM reactor concentration) and the second catalyst injection vessel was charged with a xylene solution (5 mL) of a boron-based catalyst activator, either triphenylcarbenium tetrakis (pentafluorophenyl) borate (“trityl borate” or “TB” in the Tables) or a toluene/1,2-dichloroethane solution (1:1, 5 mL total) of dimethylanilinium tetrakis (pentafluorophenyl) borate (“anilinium borate” or “AnB” in the Tables), in the appropriate molar ratios.

The reactor was pre-pressurized to 2.5 bara with ethylene, allowed to equilibrate for 10 min, and then heated to the target temperature. The reactor pressure was then set to 8.6 bara and the impeller speed was set to 1000 rpm immediately prior to catalyst injection. To initiate the reaction, solutions of the pre-polymerization catalyst and boron-based catalyst activator were simultaneously injected into the reactor using an overpressure of nitrogen in the catalyst injection vessels. The small increase in reactor pressure associated with the catalyst injection rapidly dropped as the reaction proceeded and then the reactor pressure was maintained at the target pressure throughout the reaction by feeding ethylene on demand while also controlling the reactor temperature near the target temperature for the duration of the experiment. Since the reactions were exothermic and often slightly exceed the control temperature, an average temperature was calculated and listed as ‘Temp.—Mean’ in Table 3.

After 108 seconds, the reaction was terminated by addition of an overpressure of CO₂ and then the reactor was cooled. The quenched reactor contents were recovered from the reactor and dried in a Genevac HT-12 centrifugal vacuum oven. The dried polymer was then weighed.

TABLE 2
Semi-batch Ethylene/1-Octene Copolymerization Conditions - 140° C.

| | | Al Co- | | | | | | |
|---|---|---|---|---|---|---|---|---|
| | | Catalyst | | | BHEB/Al | Al/Ti | | Borate/Ti |
| | Catalyst | Addition | [Ti] | Al Co- | (molar | (molar | Borate | (molar |
| Example | Complex | Method | (μM) | Catalyst | ratio) | ratio) | Activator | ratio) |
| B1 | Example 1 | a | 1 | MMAO-7 | 0.3 | 1000 | TB | 1.2 |
| (Inventive) | | | | | | | | |
| B2 | Example 1 | b | 1 | MMAO-7 | 0.3 | 1000 | TB | 1.2 |
| (Inventive) | | | | | | | | |
| B3 | Example 2 | a | 1 | MMAO-7 | 0.3 | 1000 | TB | 1.2 |
| (Inventive) | | | | | | | | |
| B4 | Example 2 | a | 1 | MMAO-7 | 0.3 | 500 | TB | 1.2 |
| (Inventive) | | | | | | | | |
| B5 | Example 4 | a | 1 | MMAO-7 | 0.3 | 1000 | TB | 1.2 |
| (Inventive) | | | | | | | | |
| B6 | Example 10 | a | 1 | MMAO-7 | 0.3 | 1000 | TB | 1.2 |
| (Inventive) | | | | | | | | |
| B7 | Example 2 | a | 1 | MMAO-7 | — | 500 | TB | 1.2 |
| (Comparative) | | | | | | | | |
| B8 | Example 2 | a | 1 | MMAO-7 | — | 500 | none | — |
| (Comparative) | | | | | | | | |
| B9 | Example 2 | a | 1 | TIBAL | — | 500 | AnB | 6 |
| (Comparative) | | | | | | | | |
| B10 | Comp Ex 2 | a | 1 | MMAO-7 | 0.3 | 1000 | TB | 1.2 |
| (Comparative) | | | | | | | | |
| B11 | Comp Ex 2 | c | 1 | MMAO-7 | 0.3 | 1000 | TB | 1.2 |
| (Comparative) | | | | | | | | |
| B12 | Comp Ex 2 | c | 1 | TIBAL | — | 500 | AnB | 6 |
| (Comparative) | | | | | | | | |
| B13 | Comp Ex 4 | a | 1 | MMAO-7 | 0.3 | 1000 | TB | 1.2 |
| (Comparative) | | | | | | | | |

TABLE 3
Semi-batch Ethylene/1-Octene Copolymerization Results - 140° C.

| | | | | Activity - | | | | |
|---|---|---|---|---|---|---|---|---|
| | | Temp. - | Yield - | Mean | | GPC-IR4 | GPC-IR4 | FTIR Branch |
| | Repeats | Mean | Mean | (g PE/(mmol | Activity - % | M_{w} - Mean | M_{w} - % | Freq (SCB/ |
| Example | (n) | (° C.) | (g) | Ti * hr)) | RSD | (Da) | RSD | 1000 C) |
| B1 | 3 | 149 | 8.88 | 533,000 | 7% | 211,333 | 4% | n.d. |
| (Inventive) | | | | | | | | |
| B2 | 1 | 149 | 8.41 | 504,600 | — | 216,000 | — | 20.5 |
| (Inventive) | | | | | | | | |
| B3 | 2 | 151 | 7.39 | 443,100 | 27% | 141,500 | 19% | n.d. |
| (Inventive) | | | | | | | | |
| B4 | 2 | 150 | 9.09 | 545,100 | 8% | 168,000 | 13% | n.d. |
| (Inventive) | | | | | | | | |
| B5 | 2 | 147 | 6.56 | 393,300 | 20% | 197,642 | 7% | 22.3 |
| (Inventive) | | | | | | | | |
| B6 | 3 | 147 | 7.28 | 436,600 | 16% | 185,000 | 10% | n.d. |
| (Inventive) | | | | | | | | |
| B7 | 3 | 150 | 8.04 | 482,200 | 24% | 162,000 | 14% | n.d. |
| (Comparative) | | | | | | | | |
| B8 | 3 | 140 | No | — | — | — | — | — |
| (Comparative) | | | polymer | | | | | |
| | | | formed | | | | | |
| B9 | 3 | 143 | 2.10 | 126,000 | 24% | 120,000 | 1% | n.d. |
| (Comparative) | | | | | | | | |
| B10 | 2 | 145 | 3.86 | 231,300 | 11% | 215,500 | 1% | 23.0 |
| (Comparative) | | | | | | | | |
| B11 | 1 | 144 | 3.65 | 219,000 | — | 204,000 | — | — |
| (Comparative) | | | | | | | | |
| B12 | 1 | 142 | 2.64 | 158,400 | — | 156,000 | — | — |
| (Comparative) | | | | | | | | |
| B13 | 2 | 140 | 0.75 | 44,700 | 9% | 301,500 | 1% | n.d. |
| (Comparative) | | | | | | | | |

Examples B1 to B6 demonstrate that polymerization catalyst systems based on inventive pre-polymerization catalyst complexes (with either dichloride or dimethyl activatable ligands), TB as catalyst activator, and MMAO-7 co-catalyst modified with hindered phenol (e.g., BHEB) have high activity and produce high molecular weight copolymers under these polymerization conditions (see Tables 1 and 2). Similar results were obtained using the complex of Example 1 (dichloride) by adding MMAO-7/BHEB to the reactor prior to heating and injection of the complex and borate, or by pre-mixing a portion (10%) of the MMAO-7/BHEB first with the complex of Example 1 prior to injection and adding the other 90% of the MMAO-7/BHEB to the reactor prior to heating and injection (compare B2 to B1). This suggests that the MMAO-7/BHEB is a robust and compatible co-catalyst for inventive dichloride complexes. The complex of Example 2 (dimethyl) gave similar results to the complex of Example 1 (dichloride), although activity and molecular weight, Mw with the complex of Example 2 were somewhat lower under these conditions (compare B3 to B1). Other inventive titanium complexes, from Examples 4 and 10 also led to high activity catalysts and produced copolymers with high Mw when activated with a boron-based activator (e.g., TB) and MMAO-7/BHEB under these conditions (compare B5 and B6 to B3).

Other combinations of titanium pre-polymerization catalyst, boron-based activator, and aluminum-based co-catalyst but without the hindered phenol compound (e.g., BHEB) led to polymerization catalysts with lower activity under these polymerization conditions. When BHEB was removed and the complex of Example 2 was activated with TB and MMAO-7, the polymerization activity dropped by ˜10% under these polymerization conditions (compare B7 to B4). This result was predictive of a more severe impact to catalyst activity, when removing BHEB during continuous solution polymerization experiments (see below). When the boron-based catalyst activator and BHEB were both removed (i.e., the complex of Example 2 and MMAO-7 only were used), no activity toward polymerization was observed (compare Example B8 to Example B4). This result contrasts with ethylene/1-olefin copolymerization experiments at 140° C. in a batch reactor exemplified in CN 112,876,519 and CN 112,778,376 where related pre-polymerization catalyst complexes were shown to be active when activated with MMAO-7 only.

When AnB and TIBAL were used to activate inventive pre-polymerization catalyst Example 2 and using catalyst/co-catalyst ratios (Al/Ti=500, AnB/Ti=6) like those disclosed for related catalysts in WO 2003/066641, WO 2006/080475, and WO 2006/080479, much lower catalyst activity was obtained compared to the catalyst activated with TB and MMAO-7/BHEB (Al/Ti=500, TB/Ti=1.2) (compare Example B9 to Example B4).

Polymerization catalyst systems derived from inventive titanium pre-polymerization catalysts Examples 2, 4, and 10 were higher performing than those derived from previously disclosed pre-polymerization catalyst complexes Comparative Examples 2 and 4. The pre-polymerization catalyst complex of Comparative Example 2, bearing a 2,7-di-tert-butylfluorenyl group as the cyclopentadienyl component (a ligand disclosed in WO 2006/080479), gave significantly lower activity than the inventive pre-polymerization catalyst complexes when activated in the same way (compare Example B10 with Examples B3, B5, and B6). The activities of catalysts derived from Comparative Example 2 were still lower than inventive catalysts when either MMAO-7/BHEB or TIBAL were added to the reactor at the target temperature and immediately prior to injection of titanium pre-polymerization catalyst and boron-based catalyst activator to ensure that co-catalyst materials were not decomposing during heating of reactor contents (compare Example B11 with Example B10, and Example B12 with Examples B4 and B9). The pre-polymerization catalyst complex of Comparative Example 4, bearing a 3-pyrrolidinyl-indenyl group as the cyclopentadienyl component (a ligand similar to that disclosed in WO 2003/066641, except with a Et Si-bridge instead of a Me₂Si-bridge) gave much lower activity than the pre-polymerization catalyst complex of Example 2 when activated in the same way (compare Example B13 with Example B3). This suggests that the good polymerization performance of polymerization catalyst systems employing the pre-polymerization catalyst complex of inventive Example 2 is strongly influenced by the structure of ligands bearing the indenoindolyl fragment and is not just the result of the presence of nitrogen substitution such as in the 3-pyrrolidinyl-indenyl fragment.

It is instructive to note that the branch frequencies of the copolymers (indicating the extent of incorporation of 1-octene co-monomer into the copolymer) from inventive and comparative examples B2, B5, and B10 are roughly the same and range from 20-23 short-chain branches per 1000 carbons. Hence, a person skilled in the art will appreciate that it is reasonable to compare the copolymer molecular weights directly rather than correcting for 1-octene content. Duplicate or triplicate experiments were conducted in most cases and percent relative standard deviations (% RSD) were calculated for catalyst activity and for copolymer Mw. Catalyst activities had between 7-27% RSD and copolymer Mw had between 1-19% RSD. This data indicates that reproducibility was quite good and that the differences in the polymerization performance discussed above were significantly outside the run-to-run variation in these experiments.

### Solution Phase Polymerization: Continuous Ethylene/1-Octene Copolymerization

Continuous solution phase polymerizations were conducted on a continuous polymerization unit (CPU) using cyclohexane as the solvent and a stirred 71.5 mL reactor operated at 140° C. 160° C. 190° C. 200° C. or 210° C. An upstream mixing reactor having a 20 mL volume was operated at 5° C. lower than the polymerization reactor. The mixing reactor was used to pre-heat the ethylene, octene and make-up solvent streams. Catalyst feeds (ortho-xylene or cyclohexane solutions of the titanium pre-polymerization catalyst complex, boron-based catalyst activator, (Ph₃C)[B(C₆F₅)₄] (TB), aluminum based co-catalyst (MMAO-7 or TIBAL), hindered phenol (e.g., BHEB), and additional cyclohexane solvent flow were added directly to the polymerization reactor in a continuous process or combined as described below. The aluminum co-catalyst solution was either added directly to the polymerization reactor (‘in-reactor’ configuration in Tables 4, 6, and 8) or was combined in-line with the solution of titanium pre-polymerization catalyst complex (‘in-line’ configuration in Tables 4, 6, and 8) prior to injection into the polymerization reactor. In cases where the hindered phenol BHEB was used, solutions of MMAO-7 and BHEB were combined upstream of the reactor (‘in-reactor’ configuration) or upstream of the mixing point with the solution of titanium pre-polymerization catalyst complex (‘in-line’ configuration). The solution of boron-based catalyst activator was either added directly to the reactor (‘in-reactor’ configuration in Tables 4, 6 and 8) or combined with the solution of titanium pre-polymerization catalyst complex immediately before combining with the solution of aluminum co-catalyst (‘in-line’ configuration in Tables 4, 6, and 8). A total continuous flow of 27 mL/min into the polymerization reactor was maintained. The B/Ti molar ratio was 1.2 unless otherwise stated in the table.

Two different strategies for addition of aluminum based co-catalyst were used in the experiments. In the cases of ‘fixed concentration’ (listed as ‘fixed conc.’ in Tables 4, 6, and 8), the flows were adjusted to maintain a fixed concentration 20 μM of aluminum in the reactor for the purpose of scavenging impurities and thus the Al/Ti molar ratio floated based on the flow of titanium pre-polymerization catalyst to the reactor. In the cases of ‘ratio’ control, the Al/Ti was first optimized to achieve the highest Q at the minimal Al/Ti ratio and then that Al/Ti ratio was maintain as the flows of other polymerization catalyst system components were adjusted. The optimal Al/Ti ratios are listed in the tables. When the hindered phenol, BHEB was used, the BHEB/Al molar ratio was maintained at 0.30 during optimization of the Al/Ti ratio. Once the optimal Al/Ti ratio was found, the BHEB/Al ratio was varied to find the ratio that gave the highest activity. The optimal BHEB/Al ratios are listed in the tables.

Ethylene/1-octene copolymers were made at a 1-octene/ethylene weight ratio of 0.30. The ethylene was fed at different rates depending on the reactor temperature: 2.10 g/min at 140° C., 2.70 g/min at 160° C., 3.50 g/min at 190° C., 3.80 g/min at 200° C., or 4.10 g/min at 210° C. The CPU system operated at a pressure of 10.5 MPa. The solvent, monomer, and comonomer streams were all purified by purification trains before being fed to the reactor. The polymerization activity, kₚ (expressed in mM⁻¹·min⁻¹), is defined as:

$${k}_{p} = ( \frac{Q}{100 - Q} ) ( \frac{1}{[ Ti ]} ) ( \frac{1}{HUT} )$$

where Q is ethylene conversion (%) (measured using an online NIR detector), [Ti] is catalyst concentration in the reactor (μM), and HUT is hold-up time in the reactor (2.6 min). Copolymer samples were collected at 90±1% ethylene conversion (Q) unless otherwise stated, dried in a vacuum oven, and then ground and homogenized prior to analysis. Copolymerization conditions are listed in Tables 4, 6, and 8, and copolymerization results and copolymer properties are listed in Tables 5, 7, and 9.

TABLE 4
Continuous Ethylene/1-Octene Copolymerization Conditions - 140° C. Experiments

| | | | | | Complex + | | | |
|---|---|---|---|---|---|---|---|---|
| | | | | | Al Co- | | | |
| Continuous | Titanium | | B/Ti | Borate | Catalyst | Al Co- | | BHEB/Al |
| Polymerization | Pre-Catalyst | Activatable | (molar | Addition | Contact | Catalyst | Al Co- | (molar |
| Run No. | Complex | Ligands | ratio | Method | Method | Strategy | Catalyst | ratio) |
| C1 | Example 1 | dichloride | 1.2 | in-reactor | in-reactor | ratio | MMAO-7 | 0.30 |
| (inventive) | | | | | | | | |
| C2 | Example 1 | dichloride | 1.2 | in-reactor | in-line | ratio | MMAO-7 | 0.30 |
| (inventive) | | | | | | | | |
| C3 | Example 1 | dichloride | 1.2 | in-line | in-line | ratio | MMAO-7 | 0.50 |
| (inventive) | | | | | | | | |
| C4 | Example 2 | dimethyl | 1.2 | in-reactor | in-reactor | fixed | MMAO-7 | 0.30 |
| (inventive) | | | | | | conc. | | |
| C5 | Example 2 | dimethyl | 1.2 | in-reactor | in-line | ratio | MMAO-7 | 0.30 |
| (inventive) | | | | | | | | |
| C6 | Example 2 | dimethyl | 1.2 | in-line | in-line | ratio | MMAO-7 | 0.30 |
| (inventive) | | | | | | | | |
| C7 | Example 4 | dimethyl | 1.2 | in-reactor | in-reactor | fixed | MMAO-7 | 0.30 |
| (inventive) | | | | | | conc. | | |
| C8 | Example 4 | dimethyl | 1.2 | in-line | in-line | ratio | MMAO-7 | 0.30 |
| (inventive) | | | | | | | | |
| C9 | Example 6 | dimethyl | 1.2 | in-line | in-line | ratio | MMAO-7 | 0.45 |
| (inventive) | | | | | | | | |
| C10 | Example 8 | dimethyl | 1.2 | in-line | in-line | ratio | MMAO-7 | 0.45 |
| (inventive) | | | | | | | | |
| C11 | Example 10 | dimethyl | 1.2 | in-line | in-line | ratio | MMAO-7 | 0.45 |
| (inventive) | | | | | | | | |
| C12 | Example 12 | dimethyl | 1.2 | in-line | in-line | ratio | MMAO-7 | 0.45 |
| (inventive) | | | | | | | | |
| C13 | Example 14 | dimethyl | 1.2 | in-line | in-line | ratio | MMAO-7 | 0.60 |
| (inventive) | | | | | | | | |
| C14 | Example 16 | dimethyl | 1.2 | in-line | in-line | ratio | MMAO-7 | 0.45 |
| (inventive) | | | | | | | | |
| C15 | Example 18 | dimethyl | 1.2 | in-line | in-line | ratio | MMAO-7 | 0.30 |
| (inventive) | | | | | | | | |
| C16 | Example 20 | dimethyl | 1.2 | in-line | in-line | ratio | MMAO-7 | 0.30 |
| (inventive) | | | | | | | | |
| C17 | Example 22 | dimethyl | 1.2 | in-line | in-line | ratio | MMAO-7 | 0.30 |
| (inventive) | | | | | | | | |
| C18 | Example 26 | dimethyl | 1.2 | in-line | in-line | ratio | MMAO-7 | 0.30 |
| (inventive) | | | | | | | | |
| C19 | Example 28 | dimethyl | 1.2 | in-line | in-line | ratio | MMAO-7 | 0.30 |
| (inventive) | | | | | | | | |
| C20 | Example 1 | dichloride | 1.2 | in-reactor | in-reactor | ratio | MMAO-7 | no BHEB |
| (comparative) | | | | | | | | |
| C21 | Example 1 | dichloride | 6.0 | in-reactor | in-reactor | ratio | TIBAL | no BHEB |
| (comparative) | | | | | | | | |
| C22 | Example 1 | dichloride | 6.0 | in-reactor | in-reactor | ratio | TIBAL | no BHEB |
| (comparative) | | | | | | | | |
| C23 | Example 1 | dichloride | 6.0 | in-reactor | in-line | ratio | TIBAL | no BHEB |
| (comparative) | | | | | | | | |
| C24 | Example 4 | dimethyl | 1.2 | in-line | in-line | ratio | MMAO-7 | no BHEB |
| (comparative) | | | | | | | | |
| C25 | Example 4 | dimethyl | 1.2 | in-line | in-line | ratio | MMAO-7 | no BHEB |
| (comparative) | | | | | | | | |
| C26 | Example 4 | dimethyl | none | — | in-line | ratio | MMAO-7 | no BHEB |
| (comparative) | | | | | | | | |
| C27 | Example 8 | dimethyl | 1.2 | in-line | in-line | ratio | MMAO-7 | no BHEB |
| (comparative) | | | | | | | | |
| C28 | Example 10 | dimethyl | 1.2 | in-line | in-line | ratio | MMAO-7 | no BHEB |
| (comparative) | | | | | | | | |
| C29 | Example 12 | dimethyl | 1.2 | in-line | in-line | ratio | MMAO-7 | no BHEB |
| (comparative) | | | | | | | | |
| C30 | Example 14 | dimethyl | 1.2 | in-line | in-line | ratio | MMAO-7 | no BHEB |
| (comparative) | | | | | | | | |
| C31 | Comp Ex 1 | dichloride | 1.2 | in-line | in-line | ratio | MMAO-7 | 0.50 |
| (comparative) | | | | | | | | |
| C32 | Comp Ex 2 | dimethyl | 1.2 | in-reactor | in-reactor | fixed | MMAO-7 | 0.30 |
| (comparative) | | | | | | conc. | | |
| C33 | Comp Ex 2 | dimethyl | 1.2 | in-reactor | in-reactor | fixed | MMAO-7 | no BHEB |
| (comparative) | | | | | | conc. | | |
| C34 | Comp Ex 4 | dimethyl | 1.2 | in-line | in-line | ratio | MMAO-7 | 0.30 |
| (comparative) | | | | | | | | |
| C35 | Comp Ex 4 | dimethyl | 1.2 | in-line | in-line | ratio | MMAO-7 | no BHEB |
| (comparative) | | | | | | | | |
| C36 | Comp Ex 6 | dimethyl | 1.2 | in-line | in-line | ratio | MMAO-7 | 0.30 |
| (comparative) | | | | | | | | |
| C37 | Comp Ex 6 | dimethyl | 1.2 | in-line | in-line | ratio | MMAO-7 | no BHEB |
| (comparative) | | | | | | | | |

TABLE 5
Continuous Ethylene/1-Octene Copolymerization Results - 140° C. Experiments

| | | | | | | FTIR | FTIR 1- | | | | |
|---|---|---|---|---|---|---|---|---|---|---|---|
| Continuous | | | Al/Ti | kₚ | Ethylene | BrF | Octene | | | | |
| Polymerization | [Ti] | [Al] | (molar | (mM⁻¹ · | convn. | (SCB/ | Content | GPC | GPC | GPC | GPC |
| Run No. | (μM) | (μM) | ratio) | min⁻¹) | (Q %) | 1000 C) | (wt %) | Mₙ | M_{w} | M_{z} | M_{w}/Mₙ |
| C1 | 0.93 | 129.6 | 140.0 | 3,764 | 90.06 | 19.1 | 13.7 | 93,649 | 218,347 | 457,926 | 2.33 |
| (inventive) | | | | | | | | | | | |
| C2 | 0.67 | 94.4 | 141.7 | 5,439 | 90.41 | 18.7 | 13.5 | 78,496 | 211,329 | 475,207 | 2.69 |
| (inventive) | | | | | | | | | | | |
| C3 | 1.19 | 35.56 | 60.0 | 3,207 | 90.81 | 20.7 | 14.7 | 98,315 | 212,593 | 427,698 | 2.16 |
| (inventive) | | | | | | | | | | | |
| C4 | 0.49 | 20.0 | 40.5 | 7,095 | 90.10 | 19.9 | 14.2 | 26,177 | 176,017 | 402,784 | 6.72 |
| (inventive) | | | | | | | | | | | |
| C5 | 0.59 | 5.9 | 10.0 | 5,451 | 89.36 | 18.9 | 13.6 | 80,993 | 216,015 | 444,896 | 2.67 |
| (inventive) | | | | | | | | | | | |
| C6 | 0.59 | 3.55 | 20.0 | 5,628 | 89.66 | 19.5 | 13.9 | 110,643 | 231,126 | 447,047 | 2.09 |
| (inventive) | | | | | | | | | | | |
| C7 | 1.48 | 20.0 | 13.5 | 2,514 | 90.64 | 17.7 | 12.8 | 62,091 | 191,459 | 464,442 | 3.08 |
| (inventive) | | | | | | | | | | | |
| C8 | 1.48 | 14.8 | 10.0 | 2,146 | 89.21 | 18.6 | 13.4 | 86,618 | 204,982 | 409,157 | 2.37 |
| (inventive) | | | | | | | | | | | |
| C9 | 1.02 | 40.6 | 39.8 | 3,602 | 90.51 | 17.7 | 12.8 | 78,027 | 177,547 | 351,021 | 2.28 |
| (inventive) | | | | | | | | | | | |
| C10 | 1.85 | 37.0 | 20.0 | 1,741 | 89.34 | 18.7 | 13.4 | 107,121 | 189,369 | 309,111 | 1.77 |
| (inventive) | | | | | | | | | | | |
| C11 | 0.83 | 33.3 | 40.0 | 4,186 | 90.07 | 17.7 | 12.8 | 73,602 | 187,189 | 392,053 | 2.54 |
| (inventive) | | | | | | | | | | | |
| C12 | 0.56 | 11.1 | 20.0 | 6,162 | 89.90 | 19.3 | 13.8 | 102,062 | 192,102 | 338,224 | 1.88 |
| (inventive) | | | | | | | | | | | |
| C13 | 1.11 | 22.0 | 19.8 | 3,061 | 89.84 | 19.3 | 13.8 | 81,591 | 149,414 | 255,759 | 1.83 |
| (inventive) | | | | | | | | | | | |
| C14 | 0.49 | 9.80 | 20.2 | 7,894 | 90.89 | 20.5 | 14.6 | 84,984 | 205,505 | 384,056 | 2.42 |
| (inventive) | | | | | | | | | | | |
| C15 | 0.88 | 35.2 | 40.0 | 3,615 | 89.21 | 19.9 | 14.2 | 95,158 | 190,399 | 347,114 | 2.00 |
| (inventive) | | | | | | | | | | | |
| C16 | 0.65 | 25.9 | 40.0 | 5,236 | 89.82 | 18.1 | 13.1 | 119,141 | 232,926 | 421,813 | 1.96 |
| (inventive) | | | | | | | | | | | |
| C17 | 0.98 | 2.5 | 2.5 | 3,845 | 90.72 | 15.2 | 11.2 | 119,681 | 302,509 | 679,396 | 2.53 |
| (inventive) | | | | | | | | | | | |
| C18 | 0.51 | 10.2 | 20.0 | 7,031 | 90.30 | 16.4 | 11.9 | 102,000 | 225,777 | 422,707 | 2.21 |
| (inventive) | | | | | | | | | | | |
| C19 | 0.51 | 1.3 | 2.5 | 7,039 | 90.31 | 16.8 | 12.2 | 116,214 | 235,312 | 447,475 | 2.02 |
| (inventive) | | | | | | | | | | | |
| C20 | 0.93 | 129.6 | 140.0 | 432 | 51.00 | No | — | — | — | — | — |
| (comparative) | | | | | | sample | | | | | |
| C21 | 0.93 | 5.6 | 99.0 | 892 | 68.23 | No | — | — | — | — | — |
| (comparative) | | | | | | sample | | | | | |
| C22 | 5.56 | 1388.9 | 250.0 | 315 | 82.00 | 14.9 | 10.9 | 99,565 | 218,946 | 507,501 | 2.20 |
| (comparative) | | | | | | | | | | | |
| C23 | 0.93 | 5.6 | 99.0 | 820 | 66.38 | No | — | — | — | — | — |
| (comparative) | | | | | | sample | | | | | |
| C24 | 1.48 | 14.8 | 10.0 | 1,283 | 83.17 | No | — | — | — | — | — |
| (comparative) | | | | | | sample | | | | | |
| C25 | 3.63 | 36.3 | 10.0 | 999 | 90.41 | 20.1 | 14.4 | 88,574 | 202,622 | 384,364 | 2.29 |
| (comparative) | | | | | | | | | | | |
| C26 | 1.48 | 148.1 | 100.0 | 28 | 9.87 | No | — | — | — | — | — |
| (comparative) | | | | | | sample | | | | | |
| C27 | 7.41 | 148.1 | 20.0 | 422 | 89.05 | 18.0 | 13.0 | 97,908 | 200,106 | 383,742 | 2.04 |
| (comparative) | | | | | | | | | | | |
| C28 | 5.74 | 230.0 | 40.0 | 576 | 89.59 | 18.7 | 13.5 | 110,674 | 257,509 | 575,353 | 2.33 |
| (comparative) | | | | | | | | | | | |
| C29 | 1.94 | 38.9 | 20.0 | 1,700 | 89.58 | 18.8 | 13.5 | 97,942 | 210,843 | 421,940 | 2.15 |
| (comparative) | | | | | | | | | | | |
| C30 | 3.33 | 66.7 | 20.0 | 998 | 89.64 | 20.9 | 14.8 | 81,746 | 159,715 | 293,888 | 1.95 |
| (comparative) | | | | | | | | | | | |
| C31 | 14.8 | 444.4 | 60.0 | 249 | 90.57 | 19.5 | 14 | 86,509 | 222,937 | 483,991 | 2.58 |
| (comparative) | | | | | | | | | | | |
| C32 | 7.41 | 20.0 | 2.7 | 521 | 90.93 | 18.8 | 13.5 | 31,155 | 145,531 | 357,930 | 4.67 |
| (comparative) | | | | | | | | | | | |
| C33 | 6.67 | 20.0 | 3.0 | 566 | 90.75 | 18.1 | 13.1 | 62,529 | 161,932 | 358,721 | 2.59 |
| (comparative) | | | | | | | | | | | |
| C34 | 4.17 | 83.3 | 20.0 | 879 | 90.50 | 14.4 | 10.6 | 74,999 | 193,690 | 396,139 | 2.58 |
| (comparative) | | | | | | | | | | | |
| C35 | 14.7 | 294.4 | 20.0 | 129 | 83.20 | No | — | — | — | — | — |
| (comparative) | | | | | | sample | | | | | |
| C36 | 4.83 | 290.0 | 60.0 | 713 | 89.96 | 15.4 | 11.3 | 58,109 | 128,820 | 266,754 | 2.22 |
| (comparative) | | | | | | | | | | | |
| C37 | 4.83 | 290.0 | 60.0 | 187 | 70.14 | No | — | — | — | — | — |
| (comparative) | | | | | | sample | | | | | |

In continuous copolymerization experiments conducted at 140° C. inventive catalyst compositions from titanium pre-polymerization catalyst complexes (dichloride or dimethyl activatable ligands) activated with boron-based catalyst activator (TB), and with MMAO-7 as co-catalyst, and using hindered phenol (BHEB) as modifier all showed high activities at 90% ethylene conversion (Q) and produced high molecular weight copolymers with high 1-octene content (See polymerization runs C1 to C19 in Tables 4 and 5). High activities and high molecular weights were obtained no matter how the polymerization catalyst system components were combined (in-reactor, or in-line) (compare polymerization runs C1, C2, and C3; and compare polymerization runs C4, C5, and C6).

The combination of the inventive Ti pre-polymerization catalyst complexes with a boron-based activator, an alkylaluminoxane and a hindered phenol was required for high catalyst activity in a high temperature continuous solution phase process. When BHEB was removed from the catalyst system composition derived from the complex of Example 1 (a dichloride precursor), Q dropped from 90% to 51% while keeping other catalyst flows constant (compare polymerization run C20 to C1). When BHEB was removed from a catalyst system derived from the complex of Example 4 (a dimethyl precursor) and where catalyst components were combined in-line prior to the reactor, the Q dropped by 6% (compare polymerization run C24 to C8) and the catalyst flows needed to be increased by nearly three times to achieve 90% Q and resulted in a much lower kₚ (compare polymerization run C25 to C8). Similar effects were observed in removal of BHEB from catalyst system compositions derived from inventive pre-polymerization catalyst dimethyl precursors Examples 8, 10, 12, and 14 (compare polymerization runs C27, C28, C29, and C30, to polymerization runs C10, C11, C12, and C13, respectively). In all cases the resultant catalyst complex loading levels required to achieve 90% Q without BHEB were high and the activities represented by the kₚ were much lower than when the hindered phenol compound was present in the catalyst system composition. When both BHEB and TB were removed from the catalyst system composition derived from the pre-polymerization catalyst of Example 4 (i.e., activation with MMAO-7 only), ethylene conversion dropped to <10% (compare polymerization run C26 to C8). Again, this result contrasts with ethylene/1-olefin copolymerization experiments exemplified in CN 112,876,519 and CN 112,778,376 where related pre-polymerization catalyst complexes were shown to be active when activated only with MMAO-7 in batch reactor experiments.

Alternate catalyst activation using TB and TIBAL, as disclosed for related catalyst systems in WO 2006/080479, resulted in much lower catalyst activities than systems activated with TB and MMAO-7/BHEB and an inability to achieve the target ethylene conversion of 90% Q. In WO 2006/080479, borate activators TB and AnB were shown to result in similar catalyst activities when combined with TIBAL in batch-reactor experiments at 130° C., but TB has higher solubility and is thus more practical to use in a continuous solution process. A catalyst system composition derived from complex Example 1 combined with TB and TIBAL components with all components combined in the reactor gave much lower activity than the TB and MMAO-7/BHEB activated system with the same catalyst flows (compare polymerization run C21 to C1). Increasing catalyst flows and the Al/Ti ratio in the Example 1/TB/TIBAL system did not result in an active enough polymerization catalyst system to achieve 90% Q (compare polymerization run C22 to C21 and C1). Repeating the experiment but with pre-contact of complex Example 1 with TIBAL in-line prior to the reactor did not improve the polymerization activity (compare polymerization run C23 to C21).

Polymerization catalyst systems derived from inventive titanium pre-polymerization catalysts (such as Examples 1, 2, 4, 6, 8, 10, 12, 14, 16, 18, 20, 22, 24, and 26) were much higher performing in a high temperature continuous polymerization process than those derived from previously disclosed pre-polymerization catalyst complexes Comparative Examples 1, 2 and 4 and related Comparative Example 6. Catalyst systems employing pre-polymerization catalyst complexes Comparative Example 1 (dichloride) and Comparative Example 2 (dimethyl), bearing a 2,7-di-tert-butylfluorenyl group as the cyclopentadienyl component (a ligand disclosed in WO 2006/080479), had significantly lower activities and required much higher catalyst concentrations to achieve 90% Q than the inventive catalyst systems when activated in the same way (compare polymerization run C31 with C3, and compare polymerization run C32 with C4 and C7). Repeat of polymerization run C32 using Comparative Example 2 but with no BHEB did not significantly change the activity, which remained low. A catalyst system derived from Comparative Example 4, bearing a 3-pyrrolidinyl-indenyl group as the cyclopentadienyl component, gave much lower activity than a catalyst system derived from Example 2, which bears an indeno[1,2-b]indolyl fragment having N-substitution in the same relative position to the silyl-bridge (compare polymerization run C34 with C6). Removing BHEB from the catalyst system composition resulted in a significantly lower activity and 90% Q could not be achieved (compare polymerization run C35 with C34). Similar results were obtained using Comparative Example 6, bearing a 2-pyrrolidinyl-indenyl group, and comparing to inventive Example 4, which has an indeno[2,1-b]indolyl fragment having the N-substitution in the same relative position (compare polymerization run C36 and C37 to polymerization run C8). These results suggest that the good polymerization performance of polymerization catalyst systems derived from the inventive pre-polymerization catalyst complexes is strongly influenced by the indenoindolyl fragments and is not just the result of an all carbon containing cyclopentadienyl-like fragment or a cyclopentadienyl-like fragment with nitrogen substitution in a particular position.

Those skilled in the art will notice that all the examples listed in Tables 4 and 5 produced high molecular weight copolymers with high incorporation of 1-octene co-monomer, but only the inventive examples produced these types of copolymers with high, commercially relevant catalyst activities.

TABLE 6
Continuous Ethylene/1-Octene Copolymerization Conditions - 160° C. Experiments

| | | | | Complex + Al | | | |
|---|---|---|---|---|---|---|---|
| Continuous | Titanium | | Borate | Co-Catalyst | Al Co- | | BHEB/Al |
| Polymerization | Pre-Catalyst | Complex | Addition | Contact | Catalyst | Al Co- | (molar |
| Run No. | Complex | Type | Method | Method | Strategy | Catalyst | ratio) |
| C38 | Example 1 | dichloride | in-reactor | in-line | ratio | MMAO-7 | 0.50 |
| (inventive) | | | | | | | |
| C39 | Example 1 | dichloride | in-line | in-line | ratio | MMAO-7 | 0.50 |
| (inventive) | | | | | | | |
| C40 | Example 2 | dimethyl | in-reactor | in-reactor | fixed conc. | MMAO-7 | 0.30 |
| (inventive) | | | | | | | |
| C41 | Example 2 | dimethyl | in-reactor | in-line | ratio | MMAO-7 | 0.30 |
| (inventive) | | | | | | | |
| C42 | Example 2 | dimethyl | in-line | in-line | ratio | MMAO-7 | 0.30 |
| (inventive) | | | | | | | |
| C43 | Example 4 | dimethyl | in-reactor | in-reactor | fixed conc. | MMAO-7 | 0.30 |
| (inventive) | | | | | | | |
| C44 | Example 4 | dimethyl | in-line | in-line | ratio | MMAO-7 | 0.30 |
| (inventive) | | | | | | | |
| C45 | Example 6 | dimethyl | in-line | in-line | ratio | MMAO-7 | 0.45 |
| (inventive) | | | | | | | |
| C46 | Example 8 | dimethyl | in-line | in-line | ratio | MMAO-7 | 0.45 |
| (inventive) | | | | | | | |
| C47 | Example 10 | dimethyl | in-line | in-line | ratio | MMAO-7 | 0.45 |
| (inventive) | | | | | | | |
| C48 | Example 12 | dimethyl | in-line | in-line | ratio | MMAO-7 | 0.45 |
| (inventive) | | | | | | | |
| C49 | Example 14 | dimethyl | in-line | in-line | ratio | MMAO-7 | 0.60 |
| (inventive) | | | | | | | |
| C50 | Example 16 | dimethyl | in-line | in-line | ratio | MMAO-7 | 0.45 |
| (inventive) | | | | | | | |
| C51 | Example 18 | dimethyl | in-line | in-line | ratio | MMAO-7 | 0.30 |
| (inventive) | | | | | | | |
| C52 | Example 20 | dimethyl | in-line | in-line | ratio | MMAO-7 | 0.30 |
| (inventive) | | | | | | | |
| C53 | Example 22 | dimethyl | in-line | in-line | ratio | MMAO-7 | 0.30 |
| (inventive) | | | | | | | |
| C54 | Example 26 | dimethyl | in-line | in-line | ratio | MMAO-7 | 0.30 |
| (inventive) | | | | | | | |
| C55 | Example 28 | dimethyl | in-line | in-line | ratio | MMAO-7 | 0.30 |
| (inventive) | | | | | | | |
| C56 | Comp Ex 1 | dichloride | in-line | in-line | ratio | MMAO-7 | 0.50 |
| (comparative) | | | | | | | |
| C57 | Comp Ex 2 | dimethyl | in-reactor | in-reactor | fixed conc. | MMAO-7 | 0.30 |
| (comparative) | | | | | | | |
| C58 | Comp Ex 6 | dimethyl | in-line | in-line | ratio | MMAO-7 | 0.30 |
| (comparative) | | | | | | | |

TABLE 7
Continuous Ethylene/1-Octene Copolymerization Results - 160° C. Experiments

| | | | | | | FTIR | FTIR 1- | | | | |
|---|---|---|---|---|---|---|---|---|---|---|---|
| Continuous | | | Al/Ti | kₚ | C2 | BrF | Octene | | | | |
| Polymerization | [Ti] | [Al] | (molar | (mM⁻¹ · | Convn. | (SCB/ | Content | GPC | GPC | GPC | GPC |
| Run No. | (μM) | (μM) | ratio) | min⁻¹) | (Q %) | 1000 C) | (wt %) | Mₙ | M_{w} | M_{z} | M_{w}/Mₙ |
| C38 | 2.04 | 81.5 | 40.0 | 1,754 | 90.28 | 19.7 | 14.1 | 69,843 | 139,896 | 271,119 | 2.00 |
| (inventive) | | | | | | | | | | | |
| C39 | 1.63 | 48.9 | 60.0 | 1,974 | 89.32 | 19.2 | 13.8 | 76,587 | 157,863 | 301,789 | 2.06 |
| (inventive) | | | | | | | | | | | |
| C40 | 0.93 | 20.0 | 21.6 | 3,854 | 90.27 | 19.5 | 13.9 | 64,450 | 135,000 | 235,338 | 2.09 |
| (inventive) | | | | | | | | | | | |
| C41 | 1.11 | 11.1 | 10.0 | 3,208 | 90.26 | 18.3 | 13.2 | 85,698 | 150,323 | 255,728 | 1.75 |
| (inventive) | | | | | | | | | | | |
| C42 | 1.00 | 6.0 | 20.0 | 3,275 | 89.49 | 17.9 | 13 | 66,636 | 146,816 | 260,113 | 2.20 |
| (inventive) | | | | | | | | | | | |
| C43 | 2.78 | 20.0 | 7.2 | 1,190 | 89.58 | 16.9 | 12.3 | 51,905 | 142,776 | 285,799 | 2.75 |
| (inventive) | | | | | | | | | | | |
| C44 | 2.78 | 31.1 | 10.0 | 1,106 | 89.95 | 17.9 | 12.9 | 53,649 | 133,599 | 255,917 | 2.49 |
| (inventive) | | | | | | | | | | | |
| C45 | 1.67 | 66.7 | 40.0 | 2,036 | 89.82 | 16.8 | 12.2 | 61,126 | 135,481 | 245,965 | 2.22 |
| (inventive) | | | | | | | | | | | |
| C46 | 5.56 | 111.1 | 20.0 | 575 | 89.26 | 16.5 | 12.0 | 73,172 | 137,268 | 234,311 | 1.88 |
| (inventive) | | | | | | | | | | | |
| C47 | 1.17 | 46.7 | 40.0 | 2,667 | 89.00 | 15.3 | 11.2 | 46,888 | 131,207 | 269,976 | 2.8 |
| (inventive) | | | | | | | | | | | |
| C48 | 1.00 | 20.0 | 20.0 | 3,268 | 89.47 | 18.6 | 13.4 | 71,224 | 131,544 | 215,973 | 1.85 |
| (inventive) | | | | | | | | | | | |
| C49 | 2.00 | 40.0 | 20.0 | 1,593 | 89.23 | 18.3 | 13.2 | 56,967 | 112,320 | 204,473 | 1.97 |
| (inventive) | | | | | | | | | | | |
| C50 | 0.83 | 16.7 | 20.0 | 3,901 | 89.43 | 19.3 | 13.8 | 70,647 | 154,414 | 288,583 | 2.19 |
| (inventive) | | | | | | | | | | | |
| C51 | 1.85 | 74.1 | 40.0 | 1,859 | 89.95 | — | | | | | |
| (inventive) | | | | | | | | | | | |
| C52 | 1.30 | 51.8 | 40.0 | 2,425 | 89.10 | — | | | | | |
| (inventive) | | | | | | | | | | | |
| C53 | 1.15 | 2.9 | 2.5 | 3,246 | 90.65 | — | | | | | |
| (inventive) | | | | | | | | | | | |
| C54 | 0.79 | 15.7 | 20.0 | 4,270 | 89.73 | — | | | | | |
| (inventive) | | | | | | | | | | | |
| C55 | 0.83 | 2.1 | 2.5 | 4,248 | 90.20 | — | | | | | |
| (inventive) | | | | | | | | | | | |
| C56 | 29.6 | 888.9 | 60.0 | 122 | 90.35 | 19.0 | 13.6 | 70,930 | 160,139 | 340,938 | 2.26 |
| (comparative) | | | | | | | | | | | |
| C57 | 11.6 | 20.0 | 1.7 | 271 | 89.07 | 16.1 | 11.7 | 33,383 | 121,444 | 270,444 | 3.64 |
| (comparative) | | | | | | | | | | | |
| C58 | 9.78 | 586.7 | 60.0 | 360 | 90.15 | — | | | | | |
| (comparative) | | | | | | | | | | | |

In continuous copolymerization experiments conducted at 160° C., polymerization catalyst systems comprising an inventive titanium pre-polymerization catalyst (with dichloride or dimethyl activatable ligands), a boron-based catalyst activator (TB), an alkylaluminoxane (MMAO-7), and a hindered phenol compound (BHEB) all showed high activities at 90% ethylene conversion (Q) and produced high molecular weight copolymers with high 1-octene content (see polymerization runs C38-C55 in Tables 6 and 7). High activities and high molecular weights were obtained no matter how the polymerization catalyst system components were combined (in-reactor, or in-line).

Polymerization catalysts systems derived from comparative titanium pre-polymerization catalysts (Comparative Examples 1, 2, and 6) were able to achieve 90% Q, but the activities were much lower than for the inventive examples, for example: compare polymerization run C56 to C38 and C39 (dichloride complexes); polymerization run C57 to C40 and C43 (dimethyl complexes with fixed Al concentration); and polymerization run C58 to C44 (dimethyl complexes). A polymerization catalyst system derived from inventive complex Example 8, which has a diphenylsilyl (Ph₂Si) bridging group while other inventive complexes have a dialkylsilyl (Et₂Si or n-Pr₂Si) bridging group, had a lower kₚ than other inventive catalyst systems, but still had higher activity than catalyst systems employing comparative pre-polymerization catalysts (compare inventive polymerization run C46 to comparative polymerization runs C56, C57, and C58).

TABLE 8
Continuous Ethylene/1-Octene Copolymerization Conditions - 190° C., 200° C., and 210° C. Experiments

| | | | | | Complex + | | | | |
|---|---|---|---|---|---|---|---|---|---|
| | | | | | Al Co- | | | | |
| Continuous | Titanium | | B/Ti | Borate | Catalyst | Al Co- | | BHEB/Al | Reactor |
| Polymerization | Pre-Catalyst | Complex | (molar | Addition | Contact | Catalyst | Al Co- | (molar | Temp. |
| Run No. | Complex | Type | ratio) | Method | Method | Strategy | Catalyst | ratio) | (° C.) |
| C59 | Example 1 | dichloride | 1.2 | in-reactor | in-line | ratio | MMAO-7 | 0.50 | 190 |
| (inventive) | | | | | | | | | |
| C60 | Example 1 | dichloride | 1.2 | in-line | in-line | ratio | MMAO-7 | 0.50 | 190 |
| (inventive) | | | | | | | | | |
| C61 | Example 2 | dimethyl | 1.2 | in-reactor | in-reactor | fixed | MMAO-7 | 0.30 | 190 |
| (inventive) | | | | | | conc. | | | |
| C62 | Example 2 | dimethyl | 1.2 | in-reactor | in-line | ratio | MMAO-7 | 0.30 | 190 |
| (inventive) | | | | | | | | | |
| C63 | Example 2 | dimethyl | 1.2 | in-line | in-line | ratio | MMAO-7 | 0.30 | 190 |
| (inventive) | | | | | | | | | |
| C64 | Example 2 | dimethyl | 1.2 | in-line | in-line | ratio | MMAO-7 | 0.30 | 200 |
| (inventive) | | | | | | | | | |
| C65 | Example 2 | dimethyl | 1.2 | in-line | in-line | ratio | MMAO-7 | 0.30 | 210 |
| (inventive) | | | | | | | | | |
| C66 | Example 4 | dimethyl | 1.2 | in-line | in-line | ratio | MMAO-7 | 0.30 | 190 |
| (inventive) | | | | | | | | | |
| C67 | Example 6 | dimethyl | 1.2 | in-line | in-line | ratio | MMAO-7 | 0.45 | 190 |
| (inventive) | | | | | | | | | |
| C68 | Example 8 | dimethyl | 1.2 | in-line | in-line | ratio | MMAO-7 | 0.45 | 190 |
| (inventive) | | | | | | | | | |
| C69 | Example 10 | dimethyl | 1.2 | in-line | in-line | ratio | MMAO-7 | 0.45 | 190 |
| (inventive) | | | | | | | | | |
| C70 | Example 12 | dimethyl | 1.2 | in-line | in-line | ratio | MMAO-7 | 0.45 | 190 |
| (inventive) | | | | | | | | | |
| C71 | Example 14 | dimethyl | 1.2 | in-line | in-line | ratio | MMAO-7 | 0.60 | 190 |
| (inventive) | | | | | | | | | |
| C72 | Example 16 | dimethyl | 1.2 | in-line | in-line | ratio | MMAO-7 | 0.45 | 190 |
| (inventive) | | | | | | | | | |
| C73 | Example 18 | dimethyl | 1.2 | in-line | in-line | ratio | MMAO-7 | 0.30 | 190 |
| (inventive) | | | | | | | | | |
| C74 | Example 20 | dimethyl | 1.2 | in-line | in-line | ratio | MMAO-7 | 0.30 | 190 |
| (inventive) | | | | | | | | | |
| C75 | Example 22 | dimethyl | 1.2 | in-line | in-line | ratio | MMAO-7 | 0.30 | 190 |
| (inventive) | | | | | | | | | |
| C76 | Example 26 | dimethyl | 1.2 | in-line | in-line | ratio | MMAO-7 | 0.30 | 190 |
| (inventive) | | | | | | | | | |
| C77 | Example 26 | dimethyl | 1.6 | in-line | in-line | ratio | MMAO-7 | 0.30 | 190 |
| (inventive) | | | | | | | | | |
| C78 | Example 28 | dimethyl | 1.2 | in-line | in-line | ratio | MMAO-7 | 0.30 | 190 |
| (inventive) | | | | | | | | | |
| C79 | Example 2 | dimethyl | 1.2 | in-reactor | in-line | ratio | MMAO-7 | no | 190 |
| (comparative) | | | | | | | | BHEB | |
| C80 | Example 4 | dimethyl | 1.2 | in-line | in-line | ratio | MMAO-7 | no | 190 |
| (comparative) | | | | | | | | BHEB | |
| C81 | Example 10 | dimethyl | 1.2 | in-line | in-line | ratio | MMAO-7 | no | 190 |
| (comparative) | | | | | | | | BHEB | |
| C82 | Example 12 | dimethyl | 1.2 | in-line | in-line | ratio | MMAO-7 | no | 190 |
| (comparative) | | | | | | | | BHEB | |
| C83 | Example 14 | dimethyl | 1.2 | in-line | in-line | ratio | MMAO-7 | no | 190 |
| (comparative) | | | | | | | | BHEB | |
| C84 | Example 16 | dimethyl | 1.2 | in-line | in-line | ratio | MMAO-7 | no | 190 |
| (comparative) | | | | | | | | BHEB | |
| C85 | Example 18 | dimethyl | 1.2 | in-line | in-line | ratio | MMAO-7 | no | 190 |
| (comparative) | | | | | | | | BHEB | |
| C86 | Example 20 | dimethyl | 1.2 | in-line | in-line | ratio | MMAO-7 | no | 190 |
| (comparative) | | | | | | | | BHEB | |
| C87 | Comp Ex 1 | dichloride | 1.2 | in-line | in-line | ratio | MMAO-7 | 0.50 | 190 |
| (comparative) | | | | | | | | | |
| C88 | Comp Ex 1 | dichloride | 1.2 | in-line | in-line | ratio | MMAO-7 | 0.50 | 190 |
| (comparative) | | | | | | | | | |
| C89 | Comp Ex 2 | dimethyl | 1.2 | in-reactor | in-reactor | fixed | MMAO-7 | 0.30 | 190 |
| (comparative) | | | | | | conc. | | | |
| C90 | Comp Ex 4 | dimethyl | 1.2 | in-line | in-line | ratio | MMAO-7 | 0.30 | 190 |
| (comparative) | | | | | | | | | |
| C91 | Comp Ex 6 | dimethyl | 1.2 | in-line | in-line | ratio | MMAO-7 | 0.30 | 190 |
| (comparative) | | | | | | | | | |

TABLE 9
Continuous Ethylene/1-Octene Copolymerization Results - 190° C., 200° C., and 210° C. Experiments

| | | | | | | FTIR | FTIR 1- | | | | | |
|---|---|---|---|---|---|---|---|---|---|---|---|---|
| Continuous | | | Al/Ti | kₚ | C2 | BrF | Octene | | | | | MI (I₂) |
| Polymerization | [Ti] | [Al] | (molar | (mM⁻¹ · | Convn. | (SCB/ | Content | GPC | GPC | GPC | GPC | (g/10 |
| Run No. | (μM) | (μM) | ratio) | min⁻¹) | (Q %) | 1000 C) | (wt %) | Mₙ | M_{w} | M_{z} | M_{w}/Mₙ | min) |
| C59 | 5.19 | 207.4 | 40.0 | 659 | 89.88 | 18.9 | 13.6 | 41,716 | 91,493 | 164,115 | 2.19 | n.d. |
| (inventive) | | | | | | | | | | | | |
| C60 | 4.44 | 133.3 | 60.0 | 801 | 90.25 | 18.7 | 13.5 | 46,560 | 92,741 | 157,459 | 1.99 | 0.25 |
| (inventive) | | | | | | | | | | | | |
| C61 | 2.74 | 20.0 | 7.3 | 1,163 | 89.23 | 17.9 | 12.9 | 45,760 | 87,367 | 150,203 | 1.91 | 0.28 |
| (inventive) | | | | | | | | | | | | |
| C62 | 2.96 | 29.6 | 10.0 | 1,164 | 89.97 | 18.9 | 13.6 | 44,998 | 85,978 | 142,908 | 1.91 | 0.47 |
| (inventive) | | | | | | | | | | | | |
| C63 | 3.15 | 18.9 | 20.0 | 1,183 | 90.64 | 18.6 | 13.4 | 40,326 | 84,187 | 147,560 | 2.09 | 0.35 |
| (inventive) | | | | | | | | | | | | |
| C64 | 6.59 | 66.7 | 10.1 | 556 | 90.51 | 18.1 | 13.1 | 34,759 | 69,853 | 131,082 | 2.01 | 1.48 |
| (inventive) | | | | | | | | | | | | |
| C65 | 10.4 | 103.7 | 10.0 | 330 | 89.90 | 17.8 | 12.9 | 34,278 | 62,320 | 100,824 | 1.82 | 2.68 |
| (inventive) | | | | | | | | | | | | |
| C66 | 7.41 | 74.1 | 10.0 | 446 | 89.58 | 17.4 | 12.6 | 32,538 | 72,876 | 128,751 | 2.24 | 0.53 |
| (inventive) | | | | | | | | | | | | |
| C67 | 6.48 | 260.0 | 40.1 | 575 | 90.65 | 18.7 | 13.5 | 36,657 | 70,693 | 113,895 | 1.93 | 1.15 |
| (inventive) | | | | | | | | | | | | |
| C68 | 30.6 | 610.0 | 20.0 | 104 | 89.17 | 16.2 | 11.8 | 54,893 | 101,719 | 172,366 | 1.85 | 0.07 |
| (inventive) | | | | | | | | | | | | |
| C69 | 3.89 | 156.7 | 40.3 | 822 | 89.26 | 17.4 | 12.6 | 41,200 | 80,488 | 134,784 | 1.95 | 0.40 |
| (inventive) | | | | | | | | | | | | |
| C70 | 3.61 | 73.3 | 20.3 | 1,024 | 90.58 | 19.2 | 13.8 | 31,905 | 71,896 | 138,404 | 2.25 | 1.05 |
| (inventive) | | | | | | | | | | | | |
| C71 | 5.56 | 110.0 | 19.8 | 594 | 89.56 | 19.9 | 14.2 | 30,078 | 54,231 | 84,467 | 1.80 | 3.94 |
| (inventive) | | | | | | | | | | | | |
| C72 | 2.78 | 55.8 | 20.1 | 1,277 | 90.22 | 19.1 | 13.7 | 38,819 | 83,781 | 145,429 | 2.16 | 0.48 |
| (inventive) | | | | | | | | | | | | |
| C73 | 7.22 | 290.0 | 40.2 | 514 | 90.61 | 19.7 | 14.1 | 38,029 | 82,629 | 158,670 | 2.17 | 0.44 |
| (inventive) | | | | | | | | | | | | |
| C74 | 2.59 | 103.3 | 40.0 | 1,289 | 89.68 | 16.9 | 12.3 | 52,413 | 104,834 | 209,945 | 2.00 | 0.24 |
| (inventive) | | | | | | | | | | | | |
| C75 | 2.59 | 6.5 | 2.5 | 1,349 | 90.09 | 13.6 | 10.1 | 50,853 | 116,972 | 230,084 | 2.30 | 0.12 |
| (inventive) | | | | | | | | | | | | |
| C76 | 1.63 | 32.6 | 20.0 | 2,062 | 89.73 | 14.8 | 10.9 | 51,358 | 106,508 | 199,570 | 2.07 | 0.18 |
| (inventive) | | | | | | | | | | | | |
| C77 | 1.37 | 27.4 | 20.0 | 2,313 | 89.18 | 14.5 | 10.7 | 57,047 | 106,687 | 183,125 | 1.87 | 0.17 |
| (inventive) | | | | | | | | | | | | |
| C78 | 1.85 | 4.6 | 2.5 | 2,016 | 90.66 | 16.0 | 11.7 | 43,780 | 87,128 | 162,206 | 1.99 | 0.48 |
| (inventive) | | | | | | | | | | | | |
| C79 | 4.26 | 42.6 | 10.0 | 757 | 89.34 | 18.1 | 13.1 | 38,779 | 91,108 | 170,723 | 2.35 | n.d. |
| (comparative) | | | | | | | | | | | | |
| C80 | 25.2 | 251.9 | 10.0 | 142 | 90.32 | 17.3 | 12.6 | 40,194 | 90,177 | 163,938 | 2.24 | n.d. |
| (comparative) | | | | | | | | | | | | |
| C81 | 3.89 | 156.7 | 40.3 | 115 | 53.67 | No | — | | | | | |
| (comparative) | | | | | | sample | | | | | | |
| C82 | 3.61 | 73.3 | 20.3 | 325 | 75.32 | No | — | | | | | |
| (comparative) | | | | | | sample | | | | | | |
| C83 | 5.56 | 110.0 | 19.8 | 223 | 76.30 | No | — | | | | | |
| (comparative) | | | | | | sample | | | | | | |
| C84 | 2.78 | 55.8 | 20.1 | 457 | 76.76 | No | — | | | | | |
| (comparative) | | | | | | sample | | | | | | |
| C85 | 7.22 | 290.0 | 40.2 | 62 | 53.71 | No | — | | | | | |
| (comparative) | | | | | | sample | | | | | | |
| C86 | 2.59 | 103.3 | 40.0 | 399 | 72.91 | No | — | | | | | |
| (comparative) | | | | | | sample | | | | | | |
| C87 | 37.0 | 1114.1 | 60.0 | 50 | 82.67 | No | — | | | | | |
| (comparative) | | | | | | sample | | | | | | |
| C88 | 51.8 | 1564.4 | 60.0 | 48 | 86.59 | No | — | | | | | |
| (comparative) | | | | | | sample | | | | | | |
| C89 | 48.2 | 20.0 | 0.4 | 65 | 89.00 | 14.2 | 10.5 | 18,751 | 84,863 | 188,316 | 4.53 | 0.26 |
| (comparative) | | | | | | | | | | | | |
| C90 | 18.1 | 1083.3 | 60.0 | 146 | 87.23 | No | — | | | | | |
| (comparative) | | | | | | sample | | | | | | |
| C91 | 18.6 | 1116.7 | 60.0 | 165 | 88.89 | No | — | | | | | |
| (comparative) | | | | | | sample | | | | | | |

In continuous solution phase copolymerization experiments conducted under the more demanding conditions of 190° C., and 90% Q, optimal catalyst activities for each inventive polymerization catalyst system were achieved when the polymerization catalyst system comprised: a titanium pre-polymerization catalyst, a boron-based catalyst activator (e.g., TB), an alkylaluminoxane co-catalyst (e.g., MMAO-7), and a hindered phenol compound (e.g., BHEB) (see Tables 8 and 9). All inventive polymerization catalyst systems were able to achieve 90±1% Q with kₚ greater than 100 mM⁻¹·min⁻¹ (see polymerization runs C59-C63, and C66-C78). The polymerization catalyst system derived from the inventive titanium pre-polymerization catalyst of Example 2 also maintained significant polymerization activity and molecular weight at 200° C., and 210° C. (see polymerization runs C64 and C65).

The hindered phenol compound (e.g., BHEB) is required for high activity at 190° C., and 90% Q. In all examples using catalysts derived from inventive titanium pre-polymerization complexes (Examples 2, 4, 10, 12, 14, 16, 18, and 20), removal of BHEB from the catalyst compositions resulted in significantly lower activities (compare polymerization run C79 to C62; run C80 to C66; run C81 to C69; run C82 to C70; run C83 to C71; run C84 to C72; run C85 to C73; and run C86 to C74).

Polymerization catalyst systems derived from comparable related titanium complexes (Comparative Examples 1, 2, 4, and 6) and using the combination of TB as a boron-based activator, MMAO-7 as co-catalyst, and a hindered phenol compound (e.g., BHEB) had low activity and were either not able to achieve 90±1% Q and/or had kₚ<100 mM⁻¹·min⁻¹ (compare polymerization runs C87-C91 to runs with inventive catalysts).

Those skilled in the art will notice that all the examples listed in Table 9 produced high molecular weight copolymers with high incorporation of 1-octene co-monomer, but only the inventive examples produced these types of copolymers with commercially relevant catalyst activities.

Non-limiting embodiments of the present disclosure include the following: Embodiment A. A polymerization process comprising polymerizing ethylene optionally with one or more than one C₃-C₁₂ alpha-olefin in the presence of an olefin polymerization catalyst system comprising:
i) a pre-polymerization catalyst having structure I or II:

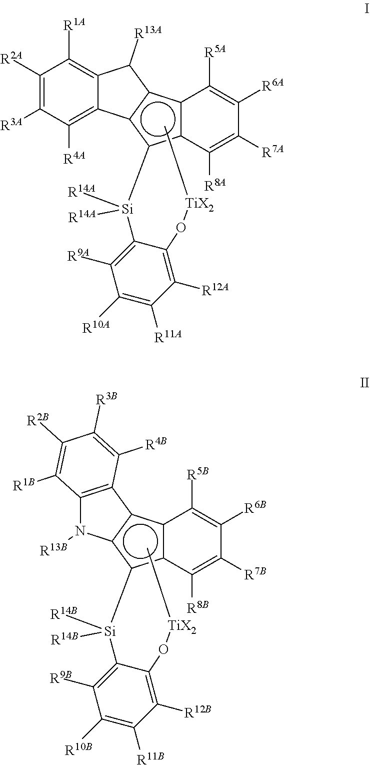

wherein
R^{1A}, R^{2A}, R^{3A}, R^{4A}, R^{5A}, R^{6A}, R^{7A}, R^{8A}, R^{9A}, R^{10A}, R^{11A}, and R^{12A} are each independently a hydrocarbyl group, a heteroatom containing hydrocarbyl group, a halogen, or hydrogen; and adjacent groups within the group consisting of R^{1A}, R^{2A}, R^{3A}, and R^{4A}, or the group consisting of R^{5A}, R^{6A}, R^{7A}, and R^{8A}, or the group consisting of R^{9A}, R^{10A}, R^{11A}, and R^{12A}, may optionally form a cyclic hydrocarbyl group or cyclic heteroatom containing hydrocarbyl group;
R^{1B}, R^{2B}, R^{3B}, R^{4B}, R^{5B}, R^{6B}, R^{7B}, R^{8B}, R^{9B}, R^{10B}, R^{11B}, and R^{12B} are each independently a hydrocarbyl group, a heteroatom containing hydrocarbyl group, a halogen, or hydrogen; and adjacent groups within the group consisting of R^{1B}, R^{2B}, R^{3B}, and R^{4B}, or the group consisting of R^{5B}, R^{6B}, R^{7B}, and R^{8B}, or the group consisting of R^{9B}, R^{10B}, R^{11B}, and R^{12B}, may optionally form a cyclic hydrocarbyl group or cyclic heteroatom containing hydrocarbyl group;
R^{13A} is a hydrocarbyl group, or a heteroatom containing hydrocarbyl group;
R^{13B} is a hydrocarbyl group, or a heteroatom containing hydrocarbyl group;
each R^{14A} is independently a hydrocarbyl group, a heteroatom containing hydrocarbyl group, or hydrogen; and two R^{14A} groups may optionally be bonded to form a ring;
each R^{14B} is independently a hydrocarbyl group, a heteroatom containing hydrocarbyl group, or hydrogen; and two R^{14B} groups may optionally be bonded to form a ring; and
each X is an activatable ligand;
ii) a boron-based catalyst activator;
iii) an alkylaluminoxane co-catalyst; and
iv) a hindered phenol compound.

Embodiment B. The polymerization process of Embodiment A, wherein the polymerization process comprises polymerizing ethylene with an alpha-olefin selected from the group consisting of 1-butene, 1-hexene, 1-octene and mixtures thereof.

Embodiment C. The polymerization process of Embodiment A, wherein the polymerization process comprises polymerizing ethylene with 1-octene.

Embodiment D. The polymerization process of Embodiment A, B, or C, wherein the polymerization process is a solution phase polymerization process carried out in a solvent.

Embodiment E. The polymerization process of Embodiment A, B, C, wherein the polymerization process is a continuous solution phase polymerization process carried out in a solvent.

Embodiment F. The polymerization process of Embodiment E, wherein the continuous solution phase polymerization process is carried out in at least one continuously stirred tank reactor.

Embodiment G. The polymerization process of Embodiment E, or F, wherein the continuous solution phase polymerization process is carried out at a temperature of at least 160° C.

Embodiment H. The polymerization process of Embodiment A, B, C, D, E, F, or G, wherein R^{1A}, R^{2A}, R^{4A}, R^{5A}, R^{6A}, R^{7A}, R^{8A}, R^{9A}, R^{11A}, R^{1B}, R^{2B}, R^{4B}, R^{5B}, R^{6B}, R^{7B}, R^{8B}, R^{9B}, and R^{11B} are hydrogen.

Embodiment I. The polymerization process of Embodiment A, B, C, D, E, F, G, or H, wherein R^{3A} and R^{3B} are hydrocarbyl groups.

Embodiment J. The polymerization process of Embodiment A, B, C, D, E, F, G, or H, wherein R^{3A} and R^{3B} are alkyl groups.

Embodiment K. The polymerization process of Embodiment A, B, C, D, E, F, G, or H, wherein R^{3A} and R^{3B} are methyl groups.

Embodiment L. The polymerization process of Embodiment A, B, C, D, E, F, G, H, I, J, or K, wherein R^{10A} and R^{10B} are hydrocarbyl groups.

Embodiment M. The polymerization process of Embodiment A, B, C, D, E, F, G, H, I, J, or K, wherein R^{10A} and R^{10B} are alkyl groups.

Embodiment N. The polymerization process of Embodiment A, B, C, D, E, F, G, H, I, J, or K, wherein R^{10A} and R^{10B} are methyl groups.

Embodiment O. The polymerization process of Embodiment A, B, C, D, E, F, G, H, I, J, or K, wherein R^{10A} and R^{10B} are heteroatom containing hydrocarbyl groups.

Embodiment P. The polymerization process of Embodiment A, B, C, D, E, F, G, H, I, J, or K, wherein R^{10A} and R^{10B} are alkoxy groups.

Embodiment Q. The polymerization process of Embodiment A, B, C, D, E, F, G, H, I, J, or K, wherein R^{10A} and R^{10B} are methoxy groups.

Embodiment R. The polymerization process of Embodiment A, B, C, D, E, F, G, H, I, J, K, L, M, N, O, P, or Q, wherein R^{12A} and R^{12B} are hydrocarbyl groups.

Embodiment S. The polymerization process of Embodiment A, B, C, D, E, F, G, H, I, J, K, L, M, N, O, P, or Q, wherein R^{12A} and R^{12B} are alkyl groups.

Embodiment T. The polymerization process of Embodiment A, B, C, D, E, F, G, H, I, J, K, L, M, N, O, P. or Q, wherein R^{12A} and R^{12B} are tert-butyl groups.

Embodiment U. The polymerization process of Embodiment A, B, C, D, E, F, G, H, I, J, K, L, M, N, O, P, or Q, wherein R^{12A} and R^{12B} are 1-adamantyl groups.

Embodiment V. The polymerization process of Embodiment A, B, C, D, E, F, G, H, I, J, K, L, M, N, O, P, Q, R, S, T, or U, wherein R^{13A} and R^{13B} are hydrocarbyl groups.

Embodiment W. The polymerization process of Embodiment A, B, C, D, E, F, G, H, I, J, K, L, M, N, O, P, Q, R, S, T, or U, wherein R^{13A} and R^{13B} are alkyl groups.

Embodiment X. The polymerization process of Embodiment A, B, C, D, E, F, G, H, I, J, K, L, M, N, O, P, Q, R, S, T, or U, wherein R^{13A} and R^{13B} are methyl groups.

Embodiment Y. The polymerization process of Embodiment A, B, C, D, E, F, G, H, I, J, K, L, M, N, O, P, Q, R, S, T, or U, wherein R^{13A} and R^{13B} are n-pentyl groups.

Embodiment Z. The polymerization process of Embodiment A, B, C, D, E, F, G, H, I, J, K, L, M, N, O, P, Q, R, S, T, or U, wherein R^{13A} and R^{13B} are arylalkyl groups.

Embodiment AA. The polymerization process of Embodiment A, B, C, D, E, F, G, H, I, J, K, L, M, N, O, P, Q, R, S, T, or U, wherein R^{13A} and R^{13B} are 3,5-di-tert-butylphenyl groups.

Embodiment BB. The polymerization process of Embodiment A, B, C, D, E, F, G, H, I, J, K, L, M, N, O, P, Q, R, S, T, U, V, W, X, Y, Z, or AA, wherein each R^{14A} and each R^{14B} is a hydrocarbyl group.

Embodiment CC. The polymerization process of Embodiment A, B, C, D, E, F, G, H, I, J, K, L, M, N, O, P, Q, R, S, T, U, V, W, X, Y, Z, or AA, wherein each R^{14A} and each R^{14B} is an alkyl group.

Embodiment DD. The polymerization process of Embodiment A, B, C, D, E, F, G, H, I, J, K, L, M, N, O, P, Q, R, S, T, U, V, W, X, Y, Z, or AA, wherein each R^{14A} and each R^{14B} is an ethyl group.

Embodiment EE. The polymerization process of Embodiment A, B, C, D, E, F, G, H, I, J, K, L, M, N, O, P, Q, R, S, T, U, V, W, X, Y, Z, or AA, wherein each R^{14A} and each R^{14B} is an aryl group.

Embodiment FF. The polymerization process of Embodiment A, B, C, D, E, F, G, H, I, J, K, L, M, N, O, P, Q, R, S, T, U, V, W, X, Y, Z, or AA, wherein each R^{14A} and each R^{14B} is a phenyl group or a substituted phenyl group.

Embodiment GG. The polymerization process of Embodiment A, B, C, D, E, F, G, H, I, J, K, L, M, N, O, P, Q, R, S, T, U, V, W, X, Y, Z, AA, BB, CC, DD, EE, or FF, wherein each X is methyl or chloride.

Embodiment HH. The polymerization process of Embodiment A, B, C, D, E, F, G, H, I, J, K, L, M, N, O, P, Q, R, S, T, U, V, W, X, Y, Z, AA, BB, CC, DD, EE, FF, or GG, wherein the boron-based catalyst activator is selected from the group consisting of N,N-dimethylaniliniumtetrakispentafluorophenyl borate (“[Me₂NHPh][B(C₆F₅)₄]”), and triphenylmethylium tetrakispentafluorophenyl borate (“[Ph₃C][B(C₆F₅)₄]”).

Embodiment II. The polymerization process of Embodiment A, B, C, D, E, F, G, H, I, J, K, L, M, N, O, P, Q, R, S, T, U, V, W, X, Y, Z, AA, BB, CC. DD, EE, FF, or GG, wherein the hindered phenol compound is 2,6-di-tertiarybutyl-4-ethylphenol.

Embodiment JJ. An olefin polymerization catalyst system comprising:
i) a pre-polymerization catalyst having structure I or II:

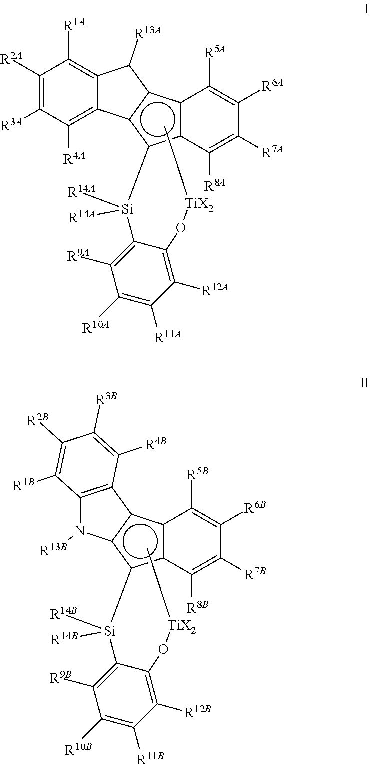

wherein
R^{1A}, R^{2A}, R^{3A}, R^{4A}, R^{5A}, R^{6A}, R^{7A}, R^{8A}, R^{9A}, R^{10A}, R^{11A}, and R^{12A} are each independently a hydrocarbyl group, a heteroatom containing hydrocarbyl group, a halogen, or hydrogen; and adjacent groups within the group consisting of R^{1A}, R^{2A}, R^{3A}, and R^{4A}, or the group consisting of R^{5A}, R^{6A}, R^{7A}, and R^{8A}, or the group consisting of R^{9A}, R^{10A}, R^{11A}, and R^{12A}, may optionally form a cyclic hydrocarbyl group or cyclic heteroatom containing hydrocarbyl group;
R^{1B}, R^{2B}, R^{3B}, R^{4B}, R^{5B}, R^{6B}, R^{7B}, R^{8B}, R^{9B}, R^{10B}, R^{11B}, and R^{12B} are each independently a hydrocarbyl group, a heteroatom containing hydrocarbyl group, a halogen, or hydrogen; and adjacent groups within the group consisting of R^{1B}, R^{2B}, R^{3B}, and R^{4B}, or the group consisting of R^{5B}, R^{6B}, R^{7B}, and R^{8B}, or the group consisting of R^{9B}, R^{10B}, R^{11B}, and R^{12B}, may optionally form a cyclic hydrocarbyl group or cyclic heteroatom containing hydrocarbyl group;
R^{13A} is a hydrocarbyl group, or a heteroatom containing hydrocarbyl group;
R^{13B} is a hydrocarbyl group, or a heteroatom containing hydrocarbyl group;
each R^{14A} is independently a hydrocarbyl group, a heteroatom containing hydrocarbyl group, or hydrogen; and two R^{14A} groups may optionally be bonded to form a ring;
each R^{14B} is independently a hydrocarbyl group, a heteroatom containing hydrocarbyl group, or hydrogen; and two R^{14B} groups may optionally be bonded to form a ring; and
each X is an activatable ligand;
ii) a boron-based catalyst activator
iii) an alkylaluminoxane co-catalyst; and
iv) a hindered phenol compound.

Embodiment KK. The polymerization process of Embodiment JJ, wherein R^{1A}, R^{2A}, R^{4A}, R^{5A}, R^{9A}, R^{7A}, R^{8A}, R^{9A}, R^{11A}, R^{1B}, R^{2B}, R^{4B}, R^{5B}, R^{6B}, R^{7B}, R^{8B}, R^{9B}, and R^{11B} are hydrogen.

Embodiment LL. The polymerization process of Embodiment JJ, or KK, wherein R^{3A} and R^{3B} are hydrocarbyl groups.

Embodiment MM. The polymerization process of Embodiment JJ, or KK, wherein R^{3A} and R^{3B} are alkyl groups.

Embodiment NN. The polymerization process of Embodiment JJ, or KK, wherein R^{3A} and R^{3B} are methyl groups.

Embodiment OO. The polymerization process of Embodiment JJ, or KK, LL, MM, or NN, wherein R^{10A} 3 are hydrocarbyl groups.

Embodiment PP. The polymerization process of Embodiment JJ, or KK, LL, MM, or NN, wherein R^{10A} and R^{10B} are alkyl groups.

Embodiment QQ. The polymerization process of Embodiment JJ, or KK, LL, MM, or NN, wherein R^{10A} and R^{10B} are methyl groups.

Embodiment RR. The polymerization process of Embodiment JJ, or KK, LL, MM, or NN, wherein R^{10A} and R^{10B} are heteroatom containing hydrocarbyl groups.

Embodiment SS. The polymerization process of Embodiment JJ, or KK, LL, MM, or NN, wherein R^{10A} and R^{10B} are alkoxy groups.

Embodiment TT. The polymerization process of Embodiment JJ, or KK, LL, MM, or NN, wherein R^{10A} and R^{10B} are methoxy groups.

Embodiment UU. The polymerization process of Embodiment JJ, or KK, LL, MM, NN, OO, PP, QQ, RR, SS, or TT, wherein R^{12A} and R^{12B} are hydrocarbyl groups.

Embodiment VV. The polymerization process of Embodiment JJ, or KK, LL, MM, NN, OO, PP, QQ, RR, SS, or TT, wherein R^{12A} and R^{12B} are alkyl groups.

Embodiment WW. The polymerization process of Embodiment JJ, or KK, LL, MM, NN, OO, PP. QQ, RR, SS, or TT, wherein R^{12A} and R^{12B} are tert-butyl groups.

Embodiment XX. The polymerization process of Embodiment JJ, or KK, LL, MM, NN, OO, PP, QQ, RR, SS, or TT, wherein R^{12A} and R^{12B} are 1-adamantyl groups.

Embodiment YY. The polymerization process of Embodiment JJ, or KK, LL, MM, NN, OO, PP, QQ, RR, SS, TT, UU, VV, WW, or XX, wherein R^{13A} and R^{13B} are hydrocarbyl groups.

Embodiment ZZ. The polymerization process of Embodiment JJ, or KK, LL, MM, NN, OO, PP, QQ, RR, SS, TT, UU, VV, WW, or XX, wherein R^{13A} and R^{13B} are alkyl groups.

Embodiment AAA. The polymerization process of Embodiment JJ, or KK, LL, MM, NN, OO, PP, QQ, RR, SS, TT, UU, VV, WW, or XX, wherein R^{13A} and R^{13B} are methyl groups.

Embodiment BBB. The polymerization process of Embodiment JJ, or KK, LL, MM, NN, OO, PP, QQ, RR, SS, TT, UU, VV, WW, or XX, wherein R^{13A} and R^{13B} are n-pentyl groups.

Embodiment CCC. The polymerization process of Embodiment JJ, or KK, LL, MM, NN, OO, PP, QQ, RR, SS, TT, UU, VV, WW, or XX, wherein R^{13A} and R^{13B} are arylalkyl groups.

Embodiment DDD. The polymerization process of Embodiment JJ, or KK, LL, MM, NN, OO, PP, QQ, RR, SS, TT, UU, VV, WW, or XX, wherein R^{13A} and R^{13B} are 3,5-di-tert-butyl-phenyl groups.

Embodiment EEE. The polymerization process of Embodiment JJ, or KK, LL, MM, NN, OO, PP, QQ, RR, SS, TT, UU, VV, WW, XX, YY, ZZ, AAA, BBB, CCC, or DDD, wherein each R^{14A} and each R^{14B} is a hydrocarbyl group.

Embodiment FFF. The polymerization process of Embodiment JJ, or KK, LL, MM, NN, OO, PP, QQ, RR, SS, TT, UU, VV, WW, XX, YY, ZZ, AAA, BBB, CCC, or DDD, wherein each R^{14A} and each R^{14B} is an alkyl group.

Embodiment GGG. The polymerization process of Embodiment JJ, or KK, LL, MM, NN, OO, PP, QQ, RR, SS, TT, UU, VV, WW, XX, YY, ZZ, AAA, BBB, CCC, or DDD, wherein each R^{14A} and each R^{14B} is an ethyl group.

Embodiment HHH. The polymerization process of Embodiment JJ, or KK, LL, MM, NN, OO, PP, QQ, RR, SS, TT, UU, VV, WW, XX, YY, ZZ, AAA, BBB, CCC, or DDD, wherein each R^{14A} and each R^{14B} is an aryl group.

Embodiment III. The polymerization process of Embodiment JJ, or KK, LL, MM, NN, OO, PP, QQ, RR, SS, TT, UU, VV, WW, XX, YY, ZZ, AAA, BBB, CCC, or DDD, wherein each R^{14A} and each R^{14B} is a phenyl group or a substituted phenyl group.

Embodiment JJJ. The polymerization process of Embodiment JJ, or KK, LL, MM, NN, OO, PP, QQ, RR, SS, TT, UU, VV, WW, XX, YY, ZZ, AAA, BBB, CCC, DDD, EEE, FFF, GGG, HHH, or III, wherein each X is methyl or chloride.

Embodiment KKK. The polymerization process of Embodiment JJ, or KK, LL, MM, NN, OO, PP, QQ, RR, SS, TT, UU, VV, WW, XX, YY, ZZ, AAA, BBB, CCC, DDD, EEE, FFF, GGG, HHH, III, or JJJ, wherein the boron-based catalyst activator is selected from the group consisting of N,N-dimethylaniliniumtetrakispentafluorophenyl borate (“[Me₂NHPh][B(C₆F₅)₄]”), and triphenylmethylium tetrakispentafluorophenyl borate (“[Ph₃C][B(C₆F₅)₄]”).

Embodiment LLL. The polymerization process of Embodiment JJ, or KK, LL, MM, NN, OO, PP, QQ, RR, SS, TT, UU, VV, WW, XX, YY, ZZ, AAA, BBB, CCC, DDD, EEE, FFF, GGG, HHH, III, JJJ, or KKK, wherein the hindered phenol compound is 2,6-di-tertiarybutyl-4-ethylphenol.

Embodiment MMM. A process to make an organometallic complex having the

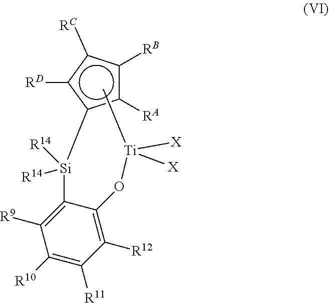

wherein the process comprises carrying out the following reactions sequentially in a single reaction vessel:
(i) combining a cyclopentadienyl-containing compound having the formula V:

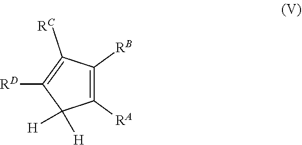

or double bond isomers of the cyclopentadienyl-containing compound having the formula V; with a base, followed by addition of a compound represented by formula VII:

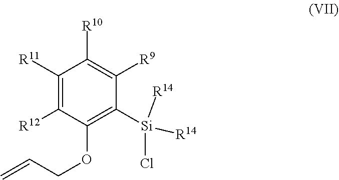

(ii) addition of at least two molar equivalents of an alkyllithium reagent, (R^{E})Li, optionally in the presence of an excess of a trialkylamine compound, (R^{F})₃N;
(iii) addition of a group IV transition metal compound having the formula TiCl₂(X^{€})₂(D)ₙ;
(iv) optionally adding a silane compound having the formula ClₓSi(R^{€})₄₋ₓ wherein each R^{€} group is independently a C₁₋₂₀ alkyl group;
(v) optionally adding an alkylating agent having the formula (R^{G})M, (R^{G})(R^{H})Mg, or (R^{G})₂Zn;
(vi) optionally switching the reaction solvent between any of the previous steps;
wherein R^{A}, R^{B}, R^{C}, and R^{D} are each independently a hydrocarbyl group, a heteroatom containing hydrocarbyl group, a halogen, or hydrogen; and adjacent groups within the group consisting of R^{A}, R^{B}, R^{C}, and R^{D} may optionally form a cyclic hydrocarbyl group or a cyclic heteroatom containing hydrocarbyl group;
wherein R⁹, R¹⁰, R¹¹, and R¹² are each independently a hydrocarbyl group, a heteroatom containing hydrocarbyl group, a halogen, or hydrogen; and adjacent groups within the group consisting of R⁹, R¹⁰, R¹¹, and R¹² may optionally form a cyclic hydrocarbyl group or a cyclic heteroatom containing hydrocarbyl group;
wherein each R¹⁴ is independently a hydrocarbyl group, a heteroatom containing hydrocarbyl group, or hydrogen; and two R¹⁴ groups may optionally be bonded to form a ring (for example, two R^{14A} groups may optionally form a cyclic hydrocarbyl group or a cyclic heteroatom containing hydrocarbyl group);
each X is an activatable ligand;
X^{€} is a halide, a C₁₋₂₀ alkoxy group, or an amido group having the formula —NR′₂, wherein the R′ groups are independently a C₁₋₃₀ alkyl group or a C₆₋₁₀ aryl group;
R^{E} is a C₁₋₂₀ hydrocarbyl group;
R^{F} is a C₁₋₁₀ alkyl group;
R^{G} is a C₁₋₂₀ hydrocarbyl group;
R^{H} is a C₁₋₂₀ hydrocarbyl group, a halide, or C₁₋₂₀ alkoxy group;
M is Li, Na, or K;
D is an electron donor compound; and
n=1 or 2.

### INDUSTRIAL APPLICABILITY

Provided is an olefin polymerization catalyst system which polymerizes ethylene with an alpha-olefin to produce ethylene copolymers having high molecular weight and high degrees of short chain branching. The olefin polymerization catalyst system may be used in a continuous solution phase polymerization process at elevated temperatures.

1. A polymerization process comprising polymerizing ethylene optionally with one or more than one C₃-C₁₂ alpha-olefin in the presence of an olefin polymerization catalyst system comprising:
i) a pre-polymerization catalyst having structure I or II: 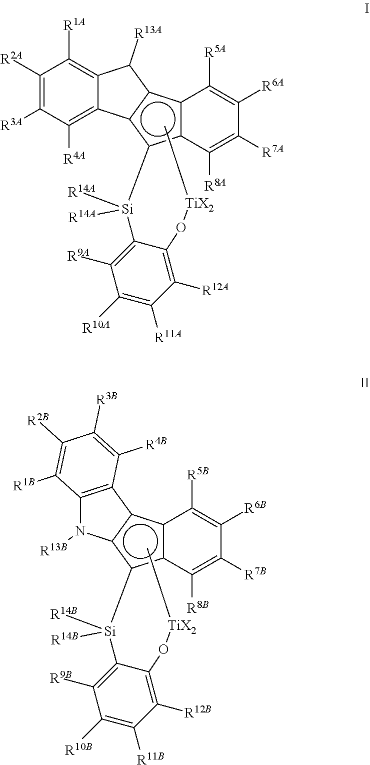
wherein
R^{1A}, R^{2A}, R^{3A}, R^{4A}, R^{5A}, R^{6A}, R^{7A}, R^{8A}, R^{9A}, R^{10A}, R^{1A}, and R^{12A} are each independently a hydrocarbyl group, a heteroatom containing hydrocarbyl group, a halogen, or hydrogen; and adjacent groups within the group consisting of R^{1A}, R^{2A}, R^{3A}, and R^{4A}, or the group consisting of R^{5A}, R^{6A}, R^{7A}, and R^{8A}, or the group consisting of R^{9A}, R^{10A}, R^{11A}, and R^{12A}, may optionally form a cyclic hydrocarbyl group or cyclic heteroatom containing hydrocarbyl group;
R^{1B}, R^{2B}, R^{3B}, R^{4B}, R^{5B}, R^{6B}, R^{7B}, R^{8B}, R^{9B}, R^{10B}, R′IB, and R^{12B} are each independently a hydrocarbyl group, a heteroatom containing hydrocarbyl group, a halogen, or hydrogen; and adjacent groups within the group consisting of R^{1B}, R^{2B}, R^{3B}, and R^{4B}, or the group consisting of R^{5B}, R^{6B}, R^{7B}, and R^{8B}, or the group consisting of R^{9B}, R^{10B}, R^{11B}, and R^{12B}, may optionally form a cyclic hydrocarbyl group or cyclic heteroatom containing hydrocarbyl group;
R^{13A} is a hydrocarbyl group, or a heteroatom containing hydrocarbyl group;
R^{13B} is a hydrocarbyl group, or a heteroatom containing hydrocarbyl group;
each R^{14A} is independently a hydrocarbyl group, a heteroatom containing hydrocarbyl group, or hydrogen; and two R^{14A} groups may optionally be bonded to form a ring;
each R^{14B} is independently a hydrocarbyl group, a heteroatom containing hydrocarbyl group, or hydrogen; and two R^{14B} groups may optionally be bonded to form a ring; and
each X is an activatable ligand;
ii) a boron-based catalyst activator;
iii) an alkylaluminoxane co-catalyst; and
iv) a hindered phenol compound.

2. The polymerization process of claim 1, wherein the polymerization process comprises polymerizing ethylene with an alpha-olefin selected from the group consisting of 1-butene, 1-hexene, 1-octene and mixtures thereof.

3. The polymerization process of claim 1, wherein the polymerization process comprises polymerizing ethylene with 1-octene.

4. The polymerization process of claim 1, wherein the polymerization process is a solution phase polymerization process carried out in a solvent.

5. The polymerization process of claim 1, wherein the polymerization process is a continuous solution phase polymerization process carried out in a solvent.

6. The polymerization process of claim 5, wherein the continuous solution phase polymerization process is carried out in at least one continuously stirred tank reactor.

7. The polymerization process of claim 5, wherein the continuous solution phase polymerization process is carried out at a temperature of at least 160° C.

8. The polymerization process of claim 1, wherein R^{1A}, R^{2A}, R^{4A}, R^{5A}, R^{6A}, R^{7A}, R^{8A}, R^{9A}, R^{11A}, R^{1B}, R^{2B}, R^{4B}, R^{5B}, R^{6B}, R^{7B}, R^{8B}, R^{9B}, and R^{11B} are hydrogen.

9. The polymerization process of claim 1, wherein R^{3A} and R^{3B} are hydrocarbyl groups.

10. The polymerization process of claim 1, wherein R^{3A} and R^{3B} are alkyl groups.

11. The polymerization process of claim 1, wherein R^{3A} and R^{3B} are methyl groups.

12. The polymerization process of claim 1, wherein R^{10A} and R^{10B} are hydrocarbyl groups.

13. The polymerization process of claim 1, wherein R^{10A} and R^{10B} are alkyl groups.

14. The polymerization process of claim 1, wherein R^{10A} and R^{10B} are methyl groups.

15. The polymerization process of claim 1, wherein R^{10A} and R^{10B} are heteroatom containing hydrocarbyl groups.

16. The polymerization process of claim 1, wherein R^{10A} and R^{10B} are alkoxy groups.

17. The polymerization process of claim 1, wherein R^{10A} and R^{10B} are methoxy groups.

18. The polymerization process of claim 1, wherein R^{12A} and R^{12B} are hydrocarbyl groups.

19. The polymerization process of claim 1, wherein R^{12A} and R^{12B} are alkyl groups.

20. The polymerization process of claim 1, wherein R^{12A} and R^{12B} are tert-butyl groups.

21. The polymerization process of claim 1, wherein R^{12A} and R^{12B} are 1-adamantyl groups.

22. The polymerization process of claim 1, wherein R^{13A} and R^{13B} are hydrocarbyl groups.

23. The polymerization process of claim 1, wherein R^{13A} and R^{13B} are alkyl groups.

24. The polymerization process of claim 1, wherein R^{13A} and R^{13B} are methyl groups.

25. The polymerization process of claim 1, wherein R^{13A} and R^{13B} are n-pentyl groups.

26. The polymerization process of claim 1, wherein R^{13A} and R^{13B} are arylalkyl groups.

27. The polymerization process of claim 1, wherein R^{13A} and R^{13B} are 3,5-di-tert-butylphenyl groups.

28. The polymerization process of claim 1, wherein each R^{14A} and each R^{14B} is a hydrocarbyl group.

29. The polymerization process of claim 1, wherein each R^{14A} and each R^{14B} is an alkyl group.

30. The polymerization process of claim 1, wherein each R^{14A} and each R^{14B} is an ethyl group.

31. The polymerization process of claim 1, wherein each R^{14A} and each R^{14B} is an aryl group.

32. The polymerization process of claim 1, wherein each R^{14A} and each R^{14B} is a phenyl group or a substituted phenyl group.

33. The polymerization process of claim 1, wherein each X is methyl or chloride.

34. The polymerization process of claim 1, wherein the boron-based catalyst activator is selected from the group consisting of N,N-dimethylaniliniumtetrakispentafluorophenyl borate (“[Me₂NHPh][B(C₆F₅)₄]”), and triphenylmethylium tetrakispentafluorophenyl borate (“[Ph₃C][B(C₆F₅)₄]”).

35. The polymerization process of claim 1, wherein the hindered phenol compound is 2,6-di-tertiarybutyl-4-ethylphenol.

36-65. (canceled)
